(19) United States
(12) Patent Application Publication
(10) Pub. No.: US 2003/0116748 A1
(43) Pub. Date: Jun. 26, 2003

(54) Environmentally friendly compositions having anti-icing, deicing or graffiti prevention properties

(76) Inventor: Leonard Arthur Haslim, Hayward, CA (US)

Correspondence Address: Gregory Smith & Associates, Suite 317, 3900 Newpark Mall Road, Newark, CA, 94560, US

(21) Appl. No.: 10/305,035

(22) Filed: Nov. 25, 2002

Related U.S. Application Data
(63) Continuation-in-part of application No. 10/217,975, filed on Aug. 12, 2002.
Application No. 10/217,975 is a continuation of application No. 09/719,923, filed on Dec. 15, 2000, now abandoned.
Application No. 09/719,923 is a continuation-in-part of application No. 09/106,803, filed on Jun. 29, 1998, now abandoned.
Application No. 09/106,803 is a continuation-in-part of application No. 08/605,295, filed on Jan. 24, 1996, now Pat. No. 5,772,912.
Application No. 08/605,295 is a continuation-in-part of application No. 08/380,913, filed on Jan. 25, 1995, now abandoned.

(51) Int. Cl. C09K 3/18

(52) U.S. Cl. 252/70; 106/13

(57) ABSTRACT

An environmentally benign anti-icing or deicing fluid providing long term protection for use on aircraft and runways, roads, bridges; and nautical, rail and automotive components. The composition is non-electrolytic, homogeneous single-phase, biodegradable comprising: water, non-toxic monohydric or polyhydric freezing point depressant alcohols having from 2 to 12 carbon atoms, present in an amount between 13 and 60 weight percent; a non-toxic exocellular polysaccharide thickener, present in an amount between 0.01 and 10 weight percent; and optionally a monohydric primary aliphatic unbranched alcohol as a means of forming a thin hydrophobic layer on the external surface of the composition to prevent moisture dilution. Compositions of the invention containing hygroscopic glycerin have exceptionally long duration icing protection and also anti-graffiti protection for applications on vertical surfaces where frictional loss is not critical. This invention also provides distinct functional improvements and cost advantages.

### RELATED APPLICATIONS

This application is a continuation-in-part of U.S. patent application Ser. No. 10/217,975, filed Aug. 12, 2002, now pending, which is a continuation of U.S. patent application Ser. No. 09/1719,923, filed Dec. 15, 2000, now abandoned, which is a continuation-in-part of U.S. patent application Ser. No. 09/106,803, filed Jun. 29, 1998, now abandoned, which is a continuation-in-part of U.S. patent application Ser. No. 08/605,295, filed Jan. 24, 1996, now abandoned, which is a continuation-in-part of U.S. patent application Ser. No. 08/380,913, filed Jun. 25, 1995, now abandoned, which are incorporated herein by reference in their entirety.

### BACKGROUND OF THE INVENTION

1. Origin of the Invention

The invention described herein may be manufactured and used by or for the United States Government and used for government purposes without payment of any royalties thereon or therefore. Governmental funding in support of the research and development leading to the invention was also provided by the U.S. Air Force (WDL), Dayton, Ohio.

2. Field of the Invention

The present provides a non-toxic anti-icing or deicing fluid for use on surfaces. This invention typically relates to an aqueous, non-electrolytic, non-toxic G.R.A.S. (see definition section), easily biodegradable, benign, continuous single phase, environmentally friendly, anti-icing and/or deicing fluid (or composition) for use in the removal of ice and/or for protection against further icing-up by acting as a barrier to the formation of or the adhesion of ice by liquid coating on substrate surfaces. Also, certain versions of the fluid compositions of the invention by additionally incorporating glycerin for improved longevity are contrived to impart therein the additional beneficial properties of forming, when applied by conventional methods (spray, brush, roller or wipe-on) a durable transparent coating that acts as an anti-graffiti barrier on the substrate surfaces that persists beyond the period needed for ice protection, and facilitates the removal of any applied graffiti. The fluid typically has a composition of water, non-toxic freezing point depressant(s), at least one non-toxic thickener, e.g., a sugar, and optional non-toxic additives, such as corrosion inhibitors, and optional other surface modifiers. A monohydric primary aliphatic alcohol is optionally present as a surface modifier as a means for forming a hydrophobic this layer on the exterior surface of the fluid structure. Preferably the said alcohol is 1-dodecanol, which unexpectedly performs its intended functions when present in small amounts.

More specifically, the thickener sugar is a heteropolysaccharides, preferably a xanthan. Surprisingly, the composition of water, freezing point depressant, and sugar, e.g., a xanthan, when placed on the surface of an object has unexpectedly high static viscosity (higher than that of the prior art and deemed a desirable property), a pseudoplastic viscosity-lowering-shear response and also rapid recovery of high static viscosity for improved durability. The high static viscosity, achieved by a small amount of incorporated xanthan is thus an unanticipated and advantageous result, and produces a fluid protective barrier to ice accretion that is very durable and long lasting for anti-icing or deicing purposes. The steep viscosity drop induced by increase in shear rate plus the rapid viscosity recovery, are both valued features that enable ease of fluid application and uniformity of distribution. The fluid is typically non-toxic and is biodegradable under normal atmospheric temperature, soil, and aquatic conditions.

### DESCRIPTION OF THE PROBLEM AND RELATED ART

The present invention addresses, by means of anti-icing (anticipatory, prophylactic) or deicing (removal), the major problems caused by snow, sleet, ice, frost and the like as they exist on or as they form on the surfaces of objects. For purposes of this application, and unless indicated otherwise, when reference is made to ice it is to be understood that the term encompasses all forms of frozen water by whatever names they are known. The following icing problems in the art are presented.

Streets etc.—For streets, roads, bridges, sidewalks, entrances and the like; airport runways, taxiways and roadways the accumulation of snow and ice is a nuisance, a potential hazard, causes serious loss of traction, or generates major problems. Currently, the removal is accomplished by shoveling, scraping and/or the use of salts or liquids which depress the freezing point. These salts alone are responsible for major and costly corrosion and degradation problems to metals, concrete or asphalt used in bridges, streets and sidewalks. Solid deicer salts work by dissolving to create a brine, which melts the ice by greatly lowering the freezing point. Anti-icers work to keep water from freezing or refreezing. The solid chemicals used typically are urea or various chlorides of sodium, potassium, magnesium or calcium, with calcium chloride being the most effective and most frequently used. However, because they are corrosive and destructive to aircraft aluminum, chloride salts are prohibited for use on airport runways where their reactive affects pose a safety-of-flight hazard. Thus, for runways, taxiways, and airport roadways, only glycols are currently used either alone or in combination with calcium magnesium acetate, sodium acetate, sodium formate, and urea. Present liquid freezing point depressant blends of the current art may be toxic, corrosive or not rapidly biodegradable, and thus cause problems in the environment, such as those fluids which are ethylene glycol based. This is especially true for those containing urea, acetates, nitrites, thiocyanates and organic amines. There is particular concern over the toxicity of urea, and also the blended additives, particularly tolyltriazoles that act as corrosion inhibitors or flame retardants. The freezing point depressant (FPD), ethylene glycol is colorless with a sweet taste that belies its acute toxicity to mammals. Ingested, ethylene glycol can be fatal to humans even in small amounts by depressing the nervous system.

Automobiles—For automobiles, trucks, i.e. all motor vehicles etc, the accumulation of ice, snow, sleet, etc., on the windshield causes severe visibility problems and is usually removed by physical scrapping (time consuming and arduous), use of warm liquids or liquids based on methyl alcohol (toxic) and/or ethylene glycol (toxic), or the automobiles defroster (which requires time to be effective). Also, most automotive windshield icing products only deice (correct the problem temporarily), but not anti-ice as well (prevent the loss of visibility problem). Because of the high amount of salts used on the streets to remove ice, the corrosion problem to metal surfaces and particularly to automobiles is enormous. These problems require extensive undercoating, frequent washing, and eventually, in some cases, complete replacement of the vehicles.

Nautical—Nautical vessels are endangered from ice formed in two different ways. Under sub-freezing temperatures with rough seas and/or windy conditions, the water spray freezes on the vessel surfaces increasing the weight of the vessel. A second more serious threat is “ice fog”. This condition is serious at sea, since it is unpredictable. When a vessel encounters “ice fog”, the entire vessel is rapidly coated with ice. Vessels have capsized and been lost because of the weight of the ice. The vessel is no longer buoyant, or topples over due to ice build-up above the vessel's metacenter. This situation is also a hazard when a maneuver such as a turn is performed or the state of the sea is such that the vessel is listing. Recently, 38 commercial fishing vessels were lost off the coast of Alaska when they suddenly encountered “ice fog” conditions. Currently, the removal practice is to chip the ice off with baseball bats and mallets. Complications occur due to the freezing (often jamming shut) of external passage-way doors and the slipperiness on the walkway surfaces. The ice breaking is strenuous and fatiguing, and exposes the ice breaking crew to extreme danger of being swept overboard. A practical and effective means of shipboard ice protection has been long sought. Further, the same ice hazard places naval craft at risk. Ice protection fluids of the invention, such as those commonly referred to in the art as Type II/IV compositions, are suitable for application to all naval vessels, including their weather decks and even carrier flight decks.

Aircraft—Icing weather conditions produce especially acute problems to aircraft that are temporarily parked on the ground in between flights where they can accumulate a variety of frozen precipitation, such as snow, sleet hail, frost, hoar frost, slush and particularly ice. These accreted deposits, which form more readily on flat horizontal surfaces such as wings and empennage, can have serious flight safety consequences. For example, the aerodynamic performance characteristics of airfoils (e.g., lift and drag) may be degraded severely by even small accumulations of frozen water, making removal prior to flight important.

Aircraft icing prior to takeoff is a significant problem. According to the National Transportation Safety Board (NTSB), icing has been identified as the cause of 127 fatal accidents in which 496 lives were lost in between 1977 and March 1992. Federal Aviation Administration (FAA) regulations require that all ice and snow accumulated under freezing conditions be removed from the aircraft prior to takeoff. To accomplish this removal, aircraft operated during cold weather (icing) conditions are sprayed with fluids to remove ice (deicing) or to prevent ice and snow accretions (anti-icing) as a safety precaution. The aviation regulatory agencies (e.g., FAA) use standards and procedures developed by the Society of Automotive Engineers (SAE) or the Association of European Airline (AEA) (as shown, for example, in Table 1A and 1B below). The SAE specifications are similar the AEA and are used by the FAA as the guideline in the USA. The disposal of the expended fluids is governed by the Environmental Protection Agency (EPA) and various state environmental agencies.

Table 1A shows to Association of European Airlines (AEA) guide for suggested icing treatment procedures for various ambient air temperatures at the airport.

Table 1B shows the AEA suggested guidelines, correlating holdover times after application of Type II (SAE 1428) certified fluids with current local weather conditions. Type II anti-icing fluids are applied at ambient temperatures.

The fluid concentration ratios shown in Tables 1A and 1B are volume ratios.

TABLE 1A
SUGGESTED AEA TYPE II FLUID APPLICATION
DEICING-ANTI-ICING PROCEDURES

| | CONCENTRATION ANTI-ICING FLUID/WATER | | |
|---|---|---|---|
| Ambient | One-Step | Two-Step | |
| Temp. | Deicing | Deicing | Anti-Icing* |
| ° C. | Fluid 90-95° C. | Fluid 90-95° C. | Fluid Ambient |
| 0° | 50/50 | 0/100 | 50/50 |
| | Includes | + | or |
| | Anti-icing | Anti-Icing | 75/75 |
| | in regard | | or |
| | to weather | | 100/0 |
| | conditions | | In regard to |
| −7° | | | weather conditions |
| −8° | 75/25 | 50/50 | 75/25 |
| | Includes | + | or |
| | Anti-icing in regard | Anti-Icing | 100/0 |
| | to weather | | In regard to |
| −14° | conditions | | weather conditions |
| −17° | | 75/25 | 100/0 |
| | | + | |
| −25° | | Anti-Icing | |

*The anti-icing step should be applied within three minutes of the start of the deicing step.

TABLE 1B
Guidelines to Holdover Times

| | Weather Conditions | | | | | | | |
|---|---|---|---|---|---|---|---|---|
| | | | | | Rain on | | | |
| Ambient | | | | | cold | Holdover Times (Hours) | | |
| Temp. | | Freezing | Steady | Freezing | soaked | AEA Type II Fluids | | |
| ° F. | Frost | fog | snow | rain | wing | 100/0 | 75/25 | 50/50 |
| +32° | | | | | | 12 | 6 | 4 |
| and | | | | | | 3 | 2 | 1 1/2 |
| above | | | | | | 1 | 3/4 | 1/2 |
| | | | | | | 20 min. | 10 min. | 5 min. |
| +32 ° | | | | | | 8 | 5 | 3 |
| to | | | | | | 1 1/2 | 1 | 3/4 |
| +19° | | | | | | 3/4 | 1/2 | 15 min. |
| | | | | | | 20 min. | 10 min. | 3 min. |
| +18° | | | | | | 8 | 5 | |
| to | | | | | | 1 1/2 | 1 | |
| +7° | | | | | | 3/4 | 1/2 | |
| +6° | | | | | | 8 | | |
| to | | | | | | 1 1/2 | | |
| −13° | | | | | | 3/4 | | |

CAUTION: The time of protection will be shortened in heavy weather conditions. Jet blast may cause a partial blow-off of the protective film. If these conditions occur, the time of protection can be shortened considerably. Improper application procedures can also affect the time of protection.

Currently, there are two types of anti-icing and/or deicing fluid compositions in use for aircraft (Type I and Type II/IV) which reflect two fundamental approaches to assure safe aircraft takeoff under icing conditions. The first approach (remedial) is to spray at high pressure the surfaces of a plane with “hot” (90-95° C.) freezing point depressant (FPD) fluids (Type I) to melt or remove the ice and snow or sometimes just frost. That sprayed aircraft must then takeoff quickly (5 to 15 minutes) before there is any further ice buildup as per guidelines dependent on meteorological conditions.

When a longer holdover time is desired, beyond that provided by the Type I composition, a two-step process is used: hot fluid deice followed immediately by anti-ice.

This second approach (anticipatory, prophylactic) is to remove all ice and snow with a hot spray of suitable fluid (Type I or water) and then quickly spray (unheated) a modified (thickened) FPD fluid (Type II or subsequently introduced Type IV) onto the aircraft surfaces that becomes a “thickened gel” which, acting as a protective blanket, provides a significantly longer time period of protection in between the deicing step and the aircraft's actual takeoff. The two fluids that match these different approaches are termed Type I (unthickened) fluids and Type II/IV (thickened) fluids, respectively, in accordance with the Association of European Airlines (A.E.A.) standards.

For ice-free aircraft parked outdoors where they would be subjected to incoming icing conditions prior to flight, anticipatory protection by type II/IV fluids spray is deemed prudent by most operators.

The properties of Type I and Type II/IV (S.A.E. 1428 series) fluids represent different compositions of the same family of FPD chemicals. Type II/IV compounds typically (polyacrylate two phase suspensions in the prior art and indestructible dispersions in the case of this invention) contain thickening additives which cause the fluid to “cling” to the aircraft under various weather and pre-takeoff and taxi conditions, and then be shed automatically at a critical velocity (ca. rotational speed) close to (and lower than) the aircraft takeoff speed. This desirable shedding is achieved by the thickener imparting to the fluid the unusual property of having a very high (static) viscosity until the takeoff's airflow (aerodynamic) shear rate dramatically lowers the viscosity to the point of where the fluid flows off rapidly as illustrated, for example, in FIGS. 1A to 1F.

As shown in FIGS. 1A to 1F, the viscosity-shear rate effect can be translated directly to viscosity-airspeed effect, which is a more practical correlation for aeronautical uses. When the Type II/IV fluid's rheological properties have been correctly matched to the particular aircraft's takeoff performance, there are no appreciable amounts of anti-icing or deicing fluid remaining on the critical surfaces of the aircraft just prior to lift off and during climb acceleration.

The known Type I (unthickened) fluids are described as having a rheological flow behavior known as Newtonian flow, that is, the fluid shows a constant slope straight line relationship in between shear stress and shear rate. If shown on a plot, the straight line passes through the origin. Further, at a constant temperature, viscosity also remains constant, i.e. independent of the shear rate (definition of Newton Type fluid) variable, and a plot of viscosity versus shear rate also produces a straight but horizontal line (slope=0) (see e.g., textbook FIG. 2). Note that Type I fluids typically have low viscosity compared to thickened fluids.

On the other hand, Type II/IV (thickened) fluids exhibit non-Newtonian flow characteristics, which are broadly defined as one for which the relationship of shear rate and shear stress is not constant. Thus, as a consequence, as shear rate is varied, the viscosity doesn't vary proportionately (refer, for example, to typical textbook FIG. 3). For the Type II/IV fluid to perform as an ice barrier “blanket” protector, it must have very high static or quasi-static viscosity while there is little aerodynamic shear. Yet the fluid must also display a rapid viscosity decrease with increasing shear rate (as during the takeoff roll) to insure the removal of Type II/IV fluids prior to flight. More specifically, this non-Newtonian behavior of “shearing thinning” is referred to as “pseudoplasticity”. For delineation of the relationships among these flow behavior types, an example of a rheogram plot set is given in typical textbook FIG. 4 for reference. Noting that the classic Newtonian flow is the only linear behavior line passing through the origin, all others are thus described as non-Newtonian flow.

The fluid compositions of this invention are thickened with xanthomona compestris polysaccharide, and display specific non-Newtonian pseudoplastic rheology characteristics, namely that referred to as “Ellis fluid” behavior (see definitions sections below).

The primary initial application for the fluid has been for anti-icing protection of aircraft prior to take-off, known as Type II fluid per ASE Specs AMS 1428. The current Type II Specification requires a minimum 30 minutes holdover time protection measured at the official Certification facility at the University of Quebec at Cheicoutimi. The fluid of this invention set a new Record holdover time of 113 minutes. The fluid also passed the aerodynamic shedding criteria Test (this test simulates an aircraft wing taking off). Critical corrosion resistance tests were also passed at another SAE certified Facility, Scientific Material International Inc. of Miami, Fla.

The currently used toxic deicing fluids of the prior art are based on glycols, primarily ethylene glycol, diethylene glycol, and non-toxic propylene glycol. Significant evidence exists that these fluid formulations have detrimental affects on the environment (for example, see “Biodegradation & Toxicity of Glycols,” ARCO Chemical Company, Newton Square, Pa. 19073, May 1990; and “Toxicity of Aircraft De-Icers and Anti-Icer Solutions to Aquatic Organisms,” S. I. Hartwell et al, Chesapeake Bay Research and Monitoring Division, Maryland Dept. of Natural Resources, Annapolis, Md., 21401, May 1993, CBRM-TX-93-1. Ethylene glycol and diethylene glycol are in themselves toxic, while propylene glycol is not (G.R.A.S.). However, when combined with the various required additives used to make the current commercial ice protection fluids, (see above) the toxicity of these fluids of the prior art is enhanced, making even propylene versions toxic. In addition, Type II/IV fluids which have improved aerodynamic performance, include compounds that are generally non-biodegradable. All of the currently used glycol deicing fluids fail to meet the U.S. Clean Water Act of 1987 environmental and safety requirements. The Environmental Protection Agency is imposing clean water rules which are stringent constraints on discharge at airports of these toxic glycol-based fluids into storm water drains and ground water supplies, and consequently costly.

For example, the Albany County, New York airport deicing fluid run-off contaminated the local drinking water supply and required the construction of a complex catch basin/sewage treatment system which cost of $12,000,000. This new treatment system is still not considered to be fully satisfactory. New airports, such as Denver International at Denver, Colo. must have a complete collection system that is expensive, complex, and of limited efficiency. Many states, for example, are calling for zero discharge limits to the environment regarding aircraft deicing fluid run-off. The required special deicing procedure and site locations tend to adversely impact departures during peak traffic and icing/storm activities. The reclamation and disposal of the expended glycol-type fluids at Denver, for example, will have a significant cost. The economic burden for this disposal service is very high, and currently is almost cost prohibitive.

With funding provided to it by the U.S. Army Cold Regions Research and Engineering Laboratory (C.R.R.E.L.) of Hanover, N.H., the School of Engineering and Applied Science of the University of Pennsylvania conducted environmental tests on the FPD of typical fluids of this invention and related the results to prior art fluids. The salient results are presented in the following abbreviated Tables and Graphs.

PERMISSIBLE CONCENTRATION LIMITS

| | Air (mg/m³) | Water (mg/L) |
|---|---|---|
| Ethylene | 125 (Federal) | 0.14 (U.S. EPA) |
| Glycol | 0.17 | 0.10 (Connecticut) |
| | (Massachusetts) | 0.29 (New Jersey) |
| | 1.00 (Virginia) | 5.50 (Arizona, |
| | 1.25 (North | Massachusetts, |
| | Dakota | Maine) |
| | 2.98 (Nevada) | |
| Propylene | 156 (Federal) | — |
| Glycol | | |
| Glycerin | 10 (OSHA) | — |
| | 0.003 (Virginia) | |
| | 0.2 (Florida, | |
| | New | |
| | York) | |
| | 0.238 (Nevada) | |

Fluid Environmental Impact Evaluation

I. Fluid Characterization

Biochemical Oxygen Demand (BOD)

Chemical Oxygen Demand (COD)

Total Organic Carbon )TOC)

Specific Oxygen Uptake Rate (SOUR)

Toxicity (Micotox^{R} Toxicity)

II. Environmental Fate and Compatibility

Aerobic Biodegradation (Surface Water Environment)

Anoxic Biodegradation (Subsurface Environment)

Anaerobic Biodegradation (Subsurface Environment

Preliminary Results

Material Characterization

| | | ZEREX | Fluid of | |
|---|---|---|---|---|
| | | Antifreeze | Invention | |
| | | (Ethylene | (Propylene | |
| | | Glycol Based) | Glycol Based | Glycerin |
| BOD₅ | (g/L) | 1,140 | 875 | 468 |
| COD | (g/L) | 1,650 | 1,530 | 1,290 |
| TOC | (g/L) | 428 | 425 | 402 |

Note: The tests were performed using the procedures listed in Standard Methods for the Examination of Water and Wastewater, 17^{th} Edition (1989).

Long-Term BOD Data at 20±1° C.

Dilution: 1 part of fluid in 2,500 parts of distilled water.

Apparatus: HACH BOD Trak Apparatus.

Bacterial Cultures: Fully acclimated.

[image]

Anoxic Biodegradation Experiment

Feed TOC (s₀): 32-34 mg/L (1 part of fluid to 15,000 parts of distilled water).

Feed Rate (Q): 0.674-0.682 mL/min.

Reactor Temperature: 20±1° C.

Bacterial Cultures: Fully acclimated.

[image]

Paradoxically, and little known by the general public or the news dispensers (i.e. the “media”), a goodly portion of the thickened Type II/IV anti-icing pseudoplastic fluid that departs the aircraft during its climb out (as much as 50%, or more) rains upon the environs of the flight path well beyond the airport boundaries. Many of these areas are populated or residential in nature, and whose occupants are susceptible to the affects of contacts with any toxic ice protection fluids. Thus, there is a stronger impetus than just the concerns of pollution of ground water or nearby streams to warrant the development of suitable non-toxic ice protection fluid compositions such as those described in this invention.

In recognition of these many problematic environmental impact concerns, the U.S. Air Force has recently issued an order (Brig. Gen. J. E. McCarthy, USAF HQ, CE, Mar. 31, 1992) banning future purchase of ethylene glycol-based deicing fluids, and also ordered that research on replacement deicing fluids commence immediately. Thus, it is now recognized that there is an urgent need to develop cost competitive alternative anti-icers or deicers which are non-toxic and readily biodegradable.

The following patents are presented to describe approaches and partial solutions to the problems of deicing and anti-icing:

F. A. Kormamm, is U.S. Pat. No. 2,101,472, teaches a gel containing gelatin to which is added as an antifreeze substance such as glycerol and/or a glycol.

H. L. West et al. in U.S. Pat. No. 2,373,727, teach a composition such as described by Kormamm, but also including a hydrocarbon, disclose a method and a composition for the prevention of the formation or accretion of ice on an exposed surface. The composition is for application to surfaces exposed to the deposition of ice to prevent the formation or accretion of ice. It comprises a jelly base composed of from about 7 to 17 percent by weight of a gelatinous material and from about 83 to 93 percent by weight of an antifreeze material of the class consisting of glycol, glycerol, polyglycols, polyglycerols and their mixtures, having incorporated therein from about 5 to 20 percent by weight of an organic liquid, which is immiscible with ice and water and which remains liquid at temperatures below plus 10° F.

R. H. Shapiro, in U.S. Pat. No. 2,454,886, discloses a method for the prevention of mist and frost on glass and similar sheet material.

J. M. Fain et al., in U.S. Pat. No. 2,716,067, disclose a composition of ethylene diamine and potassium thiocyanate, and optionally at least one of aqueous morpholine, potassium acetate or monomethyl amine.

J. M. Fain et al., in U.S. Pat. No. 2,716,068, disclose a composition of a glycol, and potassium thiocyanate, and optionally sodium nitrate.

S. Dawtrey et al., in U.S. Pat. No. 3,350,314, teaches a foamable composition of water, an alkylene polyol, and a long chain aliphatic tertiary amine.

H. E. F. Ordeit et al., in U.S. Pat. No. 3,362,910, disclose an automotive radiator-engine anti-freeze composition.

H. R. Schuppner, in U.S. Pat. No. 3,557,016, discloses to a useful combination achieved by adding some xanthan to locust bean gum.

H. F. Scott, Jr. et al., in U.S. Pat. Nos. 3,624,243 and 3,630,913, disclose chemical deicers containing corrosion inhibitors making them specially suited for use on airport runways.

I. König-Lumar et al., in U.S. Pat. No. 4,358,389, disclose a method and a liquid composition for deicing and protecting against icing-up. In particular, the composition operates to free the metal surface of aircraft rapidly and completely from ice, hoar-frost, snow and the like, and to protect the surface against further build-up for a relatively long period. This composition includes (a) glycols, usually toxic ethylene glycol, (b) water, (c) 0.05 to 1.5 percent by weight of a particular cross linked polyacrylate, (d) 0.05 to 1 percent by weight of a mixed-base mineral oil which is insoluble in water, (e) surface-active agents, (f) corrosion inhibitors, and (g) alkaline compounds. These components are present in very specific quantities in each case, the quantity of the components (a) and (b) is at least 94%, relative to the total weight of the agent. Without providing any further support there is mention of an additional ancillary co-thickener component. Xanthan is suggested only as a possible synergistic viscosity enhance to the claimed thickener, and xanthan is always in the presence of one or more of the other thickeners. It is never used as a single thickener alone. In the working examples, the thickeners are always at 1 percent by weight of the total in addition to any xanthan present. Many other specific components are usually present. The pH value of the composition is 7.5 to 10.

Ma, et al., in U.S. Pat. No. 4,954,279, describe the König-Lumar teaching, in part, at column 3, line 6, et sec.

“In addition to the components . . . , the agent . . . can also contain appropriate additives, preferably anti-oxidants and polysaccharides (gums) in effective quantities (gums and additional thickeners). . . It has been found that polysaccharides have an advantageous effect on the rheological properties of cross linked polyacrylates, particularly those having viscosity values in the lower range of the viscosity limits indicated above, that is within the range from about 1000 to 5000 cPs. Preferred polysaccharides are those of the type of high molecular xanthan gum”

K. H. Nimereck, et al., in U.S. Pat. No. 4,439,337, disclose a method and a composition for preventing freezing together of surfaces. Any surface which is to be contacted with another surface, e.g., a particulate material, in the presence of moisture (water) which is subject to freezing, is coated with a composition containing water and substantially water soluble components. The composition included (1) a polyhydroxy compound or monoalkyl ether thereof, (2) an organic non-volatile compound having at least one hydrophilic group, (2) being different than (1), and optionally a salt which functions to increase the viscosity and tackiness of the composition sufficient to retain the composition on non-horizontal surfaces to freeze proof the same.

C. F. Parks, et al., in U.S. Pat. No. 4,501,775, disclose a method and composition to reduce the strength of ice. The composition comprises (a) a water-soluble polyhydroxy compound or monoalkyl ether thereof and (b) a water-soluble organic nonvolatile compound having a hydrophilic group such as amine, carboxyl or carboxylate groups in an amount to provide an effective amount, e.g., on the order of about 0.25 to 5 weight percent, of (a) plus (b) based on the weight of water. This method is especially useful for application to particulate solids, such as coal and mineral ores, which are shipped and stored in masses exposed to freezing temperatures. Any ice that is formed is physically weak and will not deter the unloading of the conditioned particulate solids.

S. H. Bloom, in U.S. Pat. No. 4,585,571, discloses a method and a liquid deicing composition. This patent provides for a deicing composition for use on airplanes, runways, street, and the like. The deicing composition includes (a) an alkylene polyol, (b) an anionic surfactant capable of forming a hydrophobic monolayer on the metal surfaces of the aircraft, (c) a hydrophilic wetting agent which is capable of associating with the hydrophobic monolayer, and (d) a coupling agent, which facilitates the association in between the wetting agent and monolayer.

A. Lieber, et al., in U.S. Pat. No. 4,606,835, disclose a salt composition having smaller sized sodium metasilicate. A dry and free-flowing composition is claimed containing (1) salt, (2) C₂ to C₆ monohydric and/or (3) polyhydric alcohol, (4) diatomaceous earth (or suitable substitute), and (5) sodium metasilicate characterized by a particle size smaller than about 80 mesh. The composition is useful for facilitating the melting and removal of snow and ice.

E. E. McEntire, et al., in U.S. Pat. No. 4,606,837, disclose coolant compositions. The water soluble thickeners are made by alkoxylating monohydric alcohol hydrophobes. The monohydric alcohol has at least 18 carbon atoms to be properly hydrophobic. In addition, a large proportion of ethylene oxide is added, such that the molar ratio of ethylene oxide to monohydric alcohol hydrophobe is at least 40:1. Improved results are obtained when 8-15 moles of propylene oxide are added first as a block to the single mole of hydrophobe. The alkoxylations are necessary to provide the desired viscosities and hydrophilic nature. These thickeners are particularly useful in the glycol-water based fluids.

A. B. Ganncy, in U.S. Pat. No. 4,606,836, discloses a calcium magnesium acetate deicer of a particular pellet size.

R. J. Tye, et al., in U.S. Pat. No. 4,698,172, disclose an aircraft anti-icing fluid. The anti-icing fluid is suitable for ground treatment of aircraft. The anti-icing fluid is a glycol-based solution containing a gel-forming carrageenan, in an amount of less than 5 wt %. The carrageenan is present in the glycol-based solution in an amount sufficient to thicken the fluid to promote its adherence to aircraft surfaces when applied to a stationary aircraft. The use of this thickened deicing fluid does not adversely affect airfoil lift characteristics during takeoff, because the fluid exhibits shear thinning and readily flows off the aircraft surfaces when exposed to wind shear during the aircraft's takeoff run.

D. A. Coffey, et al. in U.S. Pat. No. 5,389,176, disclose an ethylene glycol based deicing/anti-icing composition which contains a thickener comprising a polyacrylic acid.

R. D. Jenkins, et al. in U.S. Pat. No. 5,461,100, disclose an anti-icing fluid suitable for ground treatment of aircraft being a glycol-based solution containing a macromolecular polymer thickener.

There is a general recognition and growing resentment that graffiti “tagging” imposes a heavy burden upon society. This has spurred the development of innovations including certain of the environmentally friendly anti-ice and deicing compositions of this invention that have the dual or additional capability to counter or help ameliorate this costly public nuisance. The following recent patents on the subject, cited by the P.T.O. examiner, are appropriately included here.

C. W. Leys, in U.S. Pat. No. 5,024,780, discloses a cleaner for treating a surface to remove graffiti or unwanted paint from unprotected surfaces, or surfaces pre-protected with an anti-graffiti coating or paint. The water soluble, non-flammable, low toxicity cleaner is comprised mainly of N-methol-2-pyrrolineone and propylene carbonate, both very effective paint solvents, a cellulosic thixotropic thickener, glycolic ethers, optionally also isocetyl alcohol and a surfactant. The disclosed cleaner compositions are said to be particularly suitable for removing graffiti and undesired paint from surfaces typically targeted for tagging.

F. S. Becker, et al, in U.S. Pat. No. 5,631,042, disclose graffiti resistant non-stick-polymer barrier coating compositions, with the provision that the polymer composition may be applied to a substrate as a paint to produce the barrier from which the graffiti is easily removed. The novel barrier paint is comprised of hydrolyzed (>50%) high molecular weight (7,000-120,000) polyvinyl alcohol (which film-forms to a very water soluble coating); sufficient non-stick agent (costly polytetra fluoroethylene and silicones) up to 30% to prevent graffiti adhesion; and a urethane plus urethane/acrylic hybrid (up to 40%) adhesion promoter (i.e. coating film former). The claimed paints were reported to be effective graffiti barriers over a variety of coated substrates. Durability, weather-ability, and the repeatability of the coatings effectiveness after initial graffiti removal were not disclosed therein.

T. Kamijo, et al, in U.S. Pat. No. 6,183,567B1 discloses a novel method for removal of graffiti as an improvement over the conventional technique of simply using a solvent as a cleaner to wipe off the unwanted graffiti; and thereby obviating both the extensive labor and time for the removal, and also the risk that the substrate surface may be damaged. The graffiti removal method of this invention involves three distinct and separate steps. Prior to the first step, select the surface from which graffiti is to be removed. The first step is then to apply onto the selected surface, prior to any graffiti damage, a primer layer onto the base surface both to correct any unwanted unevenness and to enhance the adhesion of the next coating, which is the so-called hydrophobic solvent condensation type silicone resin. Preferably this primer layer is an acrylic silicone resin obtained via several cited reactions such as hydroxcylated silicone resin polymerizing with both acrylic polyol and isocyanate resins. It is suggested that resins, other than acrylic silicones, may also be used provided good intercoating affinity is achieved. The second step in the graffiti removal method of this invention, is to then apply onto the primer layer, a solvent condensation silicone resin coating whose composition has preferable, effective water repellency which is said to enhance the releasability of lacquer sprayed graffiti. This water repellency is obtained by the admixture of certain fluorocompounds known for their hydrophobic-imparting properties. Also, a method of preparation of the solvent condensation silicone resin is mentioned, and its superiority for graffiti release over acrylic urethane resins when using the methods taught by this invention is cited. The third step in removing the unwanted graffiti, according to the teaching of this patent, pertains to the preparation and application of the so-called releasable layer or film. This graffiti removing film requires specific physical properties, which are achieved when the applied over coating forms a film and is eventually fully cured. This film must be flexible, have a tensile strength no less than 100 Kgms/cm², an elongation of no less than 100%, all values at 20° C., and have excellent releasability at all times of the year. In operation, this cured and flexible releasable film is carefully pealed off the special top-coat condensation type resin coating with water repellant fluorocompounds that had undesirable graffiti. It is the function of this pealable release film to form a more tenacious bond to the graffiti, than the graffiti does to the underlying layer, thereby removing the graffiti with the pealed film and leaving the condensation type silicone essentially cleaned of the graffiti disfigurement.

It becomes readily apparent that each subsequent graffiti damage requires a labor intensive reapplication of the flexible release coating followed (after its cure) by pealing it off. Also, there is no data presented to indicate whether the water repellant condensation type silicone retains its easy release property after repeated use or exposure to the elements, nor mention of its suitability as a weather resistant “outer protective paint”. Except for certain critical applications, the cost of simply repainting over the graffiti with economical and durable paint may outweigh the benefits derived by this three step process that employs rather costly materials and is comparatively labor intensive.

Examination of the immediate three patent innovations contrived to ameliorate graffiti problems confirm that none of these cited prior art anticipates any teaching of the instant invention, particularly those portions that relate to anti-graffiti. Further, comparison of all the graffiti treatments claimed in the said three inventions with those in this specification readily shows that the latter's method, being much simpler to affect, have a distinct economic advantage. Also, the three above patents, cited by the examiner, incorporate compositions contrived by combining or mixing prior art/literature materials and techniques to create their useful innovations. The various compositions of this innovation are similarly made, simply batch-blending of “of-the-shelf” readily available and non-costly compounds.

All patent, articles, references, applications, standards and the like cited in this specification are incorporated herein by reference in their entirety.

From the above description, it is apparent that a need exists for environmentally benign (non-toxic and easily biodegradable) compositions of anti-icing fluids and/or deicing fluid compositions that also are intrinsically superior in protection of objects from ice than known compositions.

### SUMMARY OF THE INVENTION

The present invention provides a non-toxic anti-icing fluid or a deicing fluid of water, freezing point depressant and thickener, wherein the fluid is a single phase.

The present invention provides an anti-icing or deicing composition, which composition comprises:

(a) water;

(b) at least one non-toxic, water soluble, freezing point depressant selected from the group consisting of monohydric alcohols having from 2 to 6 carbon atoms, polyhydric alcohols having from 3 to 12 carbon atoms, monomethyl or monomethyl ethers of polyhydric alcohols having from 3 to 12 carbon atoms, or mixtures thereof:

(c) a non-toxic thickener, which when combined with (a) and (b) provides a continuous liquid, wherein the liquid is a homogeneous, continuous single phase, and the liquid when formed has a high near-static initial viscosity when measured using a viscosity measuring device under specified conditions, and the formed liquid after being subjected to at least one external dynamic strain rate of at least 20.0 sec⁻¹ for at least 1.0 min., has a second, lower viscosity as measured using the viscosity measuring device under specified conditions, and upon removal of the external dynamic strain rate, within 5 min., said liquid has a third viscosity of within about 99.5% of the initial viscosity when the third viscosity is measured on the viscosity measuring device at the specified conditions.

The present invention also includes in its teaching certain environmentally friendly ice protection compositions which, in addition provide effective and economical protection for graffiti when applied as a coating on objects or structures (e.g., signs, wall, vehicles, etc.). That is, the novel coating (having glycerin as a functional component) prevents the adherence of the graffiti to a surface and the graffiti-coating is easily and quickly removed—e.g., using water usually under low pressure.

In another embodiment, in the composition:

In component (a) the water is present in between about 40 and 86 percent by weight of the combined water and freezing point depressant weights;

In component (b) the freezing point depressant is present in between about 14 and 60 percent by weight of the combined water and freezing point depressant weights; and

In component (c) the thickener is present in between about 0.01 and 10 percent of the total composition, and the sum of components (a), (b) and (c) are about 90% or higher by weight or greater of the total composition, wherein the specified conditions are in between −20° and +20° C., and preferably wherein the specified conditions are about 20° C. and 760 torr.

The present invention concerns an aqueous, non-electrolytic, essentially non-toxic, easily biodegradable, environmentally benign, continuous phase liquid composition for use as an anti-icing or a deicing agent. The composition includes water, a non-toxic freezing point depressant, a thickener, optional one or more non-toxic environmentally benign corrosion inhibitors or surfactants, optional monohydric aliphatic unbranched alcohol, and optional coloring agent, wherein the thickener produces an aqueous liquid composition having the properties of non-Newtonian pseudoplastic rheological behavior wherein the near-static viscosity exceeds 20,000 cPs at temperature ranges of in between about −30° and 0° C. for icing protection and said viscosity rapidly decreases with moderate increase in shear rate to asymptomatically approach a low viscosity (below 600 cPs), when a film of the composition is exposed to shear rates in excess of 20 reciprocal seconds.

The present invention also relates to an aqueous, non-electrolytic, essentially non-toxic, easily biodegradable, environmentally benign, continuous single-phase, composition for use as an anti-icing agent and/or a deicing agent. These agents are for use on surfaces of an object, where ice accretion and build-up is detrimental, including but not limited to airplanes, airport pavements, roadways, bridges, walkways, entrances, electrical tower structures and their components, canals, locks, vessels, nautical components, railroad switches, automobiles, and motor vehicles. The unexpected static and dynamic icing protection properties of these novel, aqueous, non-toxic and biodegradable fluid compositions are equal to those of the present art and in most cases are superior to those of the art.

The anti-icing/deicing composition comprises:

(a) water in between about 40 and 86 by weight percent (wt %) of the sum of the weights of the freezing point depressant (FPD) and water;

(b) a non-toxic freezing point depressant (FPD) selected from the group consisting of monohydric alcohols having from 2 to 6 carbon atoms, polyhydric alcohols having from 3 to 12 carbon atoms, mono methyl or ethyl ethers of polyhydric alcohols having from 3 to 12 atoms or mixtures thereof, wherein the freezing point depressant is present in between about 10 to 60 percent by weight of the sum of the weights of the freezing point depressants and water;

(c) a thickener for producing resultant pseudoplastic flow behavior, wherein the thickener preferable consists essentially of bacterium produced hydrophilic heteropolysaccaride colloid which is present in between about 0.01 and 10 percent by weight of the total composition; and

(d) optionally, a non-toxic, environmentally benign corrosion inhibitor selected from a group of the types generally considered by industry as suitable for aqueous glycol anti-freeze applications, and which is present in between about 0.01 and 0.1 percent by weight of the total composition wherein said composition is a non-toxic aqueous solution and is environmentally biodegradable.

The anti-icing/deicing compositions can further include:

(e) a monohydric alcohol as means for forming a hydrophobic monolayer on the exterior surface of the fluid composition applied to the structure to be given ice protection, which alcohol is selected from the group consisting of alcohols having in between 8 to 24 carbon atoms. Preferably, the alcohol is a primary aliphatic alcohol with minimal or no sidechains, preferably present in between a trace quantity (i.e., in between about 0.01 wt %), sufficient to form hydrophobic thin layers, e.g., essentially a monolayer on the exterior surface, and 5.0 wt % of the total composition.

The non-toxic freezing point depressant can be selected from the group of alkanols, consisting of ethanol, 1-propanol, 2-propanol, 1-butanol, 1-butanol, 2-methyl-1-propanol, 2-methyl-2-propanol, 1,2-propylene glycol, 1,3-propylene glycol, 1,4-butylene glycol, 1,3-butylene glycol, 2,3-butylene glycol, glycerol, and mixtures thereof. The freezing point depressant is present preferably in between about 14 and 60 percent by weight of the sum of the weights of the freezing point depressant and water; and in component (c), the thickener is a xanthan selected to impart viscosity thickening when dispersed or hydrated in the aqueous media. The xanthan is present in between about 0.01 and 10 percent by weight of the sum of the total composition.

In one embodiment of which the fluid compositions of the present invention, additional optional constituents which may be further incorporated to enhance overall performance include, for example:

(f) environmentally benign, non-toxic surfactants such as those described in the art, in between about 0.001 and 0.1 percent by weight;

(g) oxygenator(s) such as a water-soluble peroxide (i.e. H₂O₂), which is added during application of the fluid to the surface to assist in subsequent biodegradation and is present in between about 0.1 and 5 percent by weight; or

(h) optional degradation agents which are present in amounts effective to facilitate biodegradation of the fluid after its use. Such agents include, but are not limited to enzymes, microbes, bacteria, and the like. Suitable degradation agents are optionally present in between about 0.001 wt % and 2.0 wt %. Optionally, these degradation agents are added just prior to fluid application or after use, to assist in biodegradation (and decomposition) of the runoff fluid composition after its use on the surface of the object; or

(i) environmentally benign non-toxic (i.e. food grade) bacteriostat such as those described in the art, present in between about 0.001 and 0.1 percent by weight.

Another embodiment of the anti-icing or deicing composition further includes a monohydric alcohol as a means for forming a hydrophobic thin layer, essentially a monolayer, on the exterior surface of the composition applied to the structure to be ice protected, which alcohol is selected from the group of monohydric alcohols having in between 8 and 16 carbon atoms, preferably in between 8 and 12 carbon atoms, and more preferably, 1-dodecanol. In one embodiment of the anti-icing or deicing composition, the fluid further includes 1-docecanol which is present in between about 0.01 and 5.0 percent by weight of the total composition.

The present invention also relates to anti-icing or deicing compositions for use on the surfaces of objects such as, airplanes, runways, streets, roads, bridges, sidewalks, entrances, building and tower structures, vessels, nautical components, automobiles, trees, shrubs and the like. The anti-icing/deicing composition comprises:

(a) water in between about 40 and 86 percent by weight;

(b) a non-toxic freezing point depressant selected from the group consisting of monohydric alcohols having from 2 to 6 carbon atoms, polyhydric alcohols having from 3 to 12 carbon atoms, mono methyl or ethyl ethers of polyhydric alcohols which have from 3 to 12 atoms or mixtures thereof, wherein the freezing point depressant is present in between about 14 to 60 percent by weight;

(c) a selected xanthan present in between about 0.01 and 5 percent by weight;

(d) optionally one or more non-toxic, environmentally benign corrosion inhibitors which are present in between about 0.01 and 0.1 percent by weight of the total composition; or

(e) optionally an environmentally benign non-toxic (i.e. food grade) bacteriostat such as those described in the art, e.g., cetylpyridinium chloride, benzylpyridinium chloride in between about 0.001 and 0.1 percent by weight.

In another embodiment, the anti-icing or deicing composition, further includes component (f) a monohydric alcohol as means for forming a hydrophobic thin layer, essentially a monolayer, on the exterior surface of the fluid composition as applied to the structure to be given ice protection which alcohol is selected from the group consisting of alcohols having in between 10 to 20 carbon atoms.

In another embodiment, the anti-icing or deicing composition further includes component (g), an environmentally friendly non-toxic surfactant such as those described in the art, in between about 0.001 and 0.1 percent by weight.

In another embodiment of the anti-icing or deicing composition, the freezing point depressant is selected from the group consisting of ethanol, 1-propanol, 2-propanol, 1,2-propylene glycol, 1,3-propylene glycol, 1,4-butylene glycol, 1,3-butylene glycol, 2,3-butylene glycol, and glycerol, and mixtures thereof. The ratio of freezing point depressant is present in between about 14 and 60 percent by weight of the sum of the weights of freezing point depressant and water; and in component (c), the thickener, xanthan, is present in between about 0.01 and 10 percent by weight.

In another embodiment of the anti-icing/deicing composition, the composition further includes a monohydric alcohol as means for forming a hydrophobic monolayer on the exterior surface of the composition as applied to the structure to be ice protected, which alcohol is selected from the group of monohydric alcohols having in between 10 and 14 carbon atoms, preferably 1-dodecanol.

In another embodiment of the anti-icing/deicing composition, it further includes a liquid aliphatic wax ester as an optional means for forming a hydrophobic monolayer on the exterior surface of the fluid composition as applied to the structure to be ice protected, which liquid was comprises natural occurring esters of cis-monounsaturated omega-9 C₁₆ to C₂₄ linear fatty acids and C₁₈ to C₂₆ linear alcohols, with an overall chain length predominantly C₄₀ to C₄₄, preferably “Jojoba” as derived from the seeds of the Simmondsioa chinensis plant.

For some applications, it may be desirable to use the anti-icing composition on a surface, with small sized (i.e. less than 2.5 mm in diameter) grit, preferable biodegradable, solid particles, to increase friction and/or traction on the surface (e.g., in roads or sidewalks). Typically, for aircraft surfaces or aircraft runways/taxiways, the ice protection shall not include grit.

Most preferably a composition consists essentially of water, a non-toxic freezing point depressant (described above), a xanthan and an optional monohydric aliphatic alcohol, (described above) and optionally a corrosion inhibitor and optionally a bacteriostat.

In another embodiment, the present invention relates to an anti-icing or deicing composition for use on surfaces of objects where ice accretion is detrimental and when protection from ice build-up is desired which anti-icing or deicing composition comprises:

(a) water in between about 40 and 86 percent by weight of the sum of the water and freezing point depressant;

(b) a non-toxic freezing point depressant selected from the group consisting of monohydric alcohols having from 2 to 6 carbon atoms, polyhydric alcohols having from 3 to 12 carbon atoms, monomethyl or monomethyl ethers of polyhydric alcohols having from 3 to 12 atoms or mixtures thereof, wherein the amount of freezing point depressant is in between about 14 to 60 percent by weight;

(c) a thickener for producing resultant pseudoplastic flow behavior of the composition which thickener is present in between about 0.01 and 10 percent by weight;

(d) optionally a non-toxic environmentally benign corrosion inhibitor which is present in between about 0.01 and 0.1 percent by weight of the total composition; or

(e) optionally an environmentally benign, non-toxic (i.e. food grade) bacteriostat such as those described in the art, in between 0.001 and 0.1 percent by weight.

In another embodiment, the present invention relates to an anti-icing or deicing composition wherein:

In component (b), the freezing point depressant is selected from the group consisting of ethanol, 1-propanol, 2-propanol, 1-butanol, 2-butanol, 1-methyl-1-propanol, 2-methyl-2-propanol, 1,2-propylene glycol, 1,3-propylene glycol, 1,4-butylene glycol, 1,3-butylene glycol, 2,3-Butylene glycol, and glycerol, and mixtures thereof,

In component (c), the thickener is xanthan selected to impart viscosity thickening when dispersed or hydrated in the aqueous media, and the xanthan is present in between about 0.01 and 5 percent by weight, and the freezing point depressant is in between about 14 and 60 percent by weight; and the objects are selected from the group consisting of aircraft, airport pavements, roadways, walkways, bridges, entrances, structures, canals, locks, electrical tower structures and their components, vessels, nautical components, railroad switches, automobiles and motor vehicles.

In another embodiment, the present invention relates to an anti-icing or deicing composition for use on the surfaces of objects, which anti-icing or deicing composition comprises:

(a) water in between about 40 and 86 percent by weight or the sum of the weights of the FDP(s) and water;

(b) a non-toxic freezing point depressant selected from the group consisting of monohydric alcohols having from 2 to 6 carbon atoms, polyhydric alcohols having from 3 to 12 carbon atoms, monomethyl or monomethyl ethers of polyhydric alcohols having from 3 to 12 atoms or mixtures thereof, wherein the amount of freezing point depressant is in between about 14 to 60 percent by weight of the sum of the weights of FPD(s) and water;

(c) a thickener, xanthan, which is present in between about 0.01 and 10 percent by weight; and

(d) optionally a corrosion inhibitor which is present in between about 0.01 and 0.1 percent by weight of the total composition.

In another embodiment the present invention relates to an anti-icing or deicing composition wherein:

In component (b), the freezing point depressant is selected from the group consisting of ethanol, 1-propanol, 2-propanol, 1-butanol, 2-butanol, 2-methyl-1-propanol, 2-methyl-2-propanol, 1,2-propylene glycol, 1,3-propylene glycol, 1,4-butyllene glycol, 1,3 butylene glycol, 2,3-butylene glycol, glycerol, and mixtures thereof, and the freezing point depressant is in between about 30 and 60 percent by weight of the sum of the weights of FPD(s) and water; and

In component (c), the xanthan is present in between about 0.1 and 1 percent by weight; and the objects are selected from the group consisting of aircraft, airport pavements, roadways, walkways, bridges, entrances, structures, canals, locks, electrical structures and their components, vessels, nautical components, railroad switches, and motor vehicles.

In another embodiment the present invention relates to an anti-icing or deicing composition for use on the surfaces of objects, which anti-icing or deicing composition consists essentially of:

(a) water in between about 40 and 60 percent by weight of the sum of the weights of FPD(s) and water;

(b) a non-toxic freezing point depressant selected from the group consisting of monohydric alcohols of monohydric alcohols having from 2 to 6 carbon atoms, polyhydric alcohols having from 3 to 12 carbon atoms, monomethyl or monomethyl ethers of polyhydric alcohols having from 3 to 12 carbon atoms or mixtures thereof, wherein the amount of freezing point depressant is in between about 40 to 60 percent by weight of the sum of the weights of FPD(s) and water;

(c) a xanthan which is present in between about 0.01 and 10 percent by weight; and

(d) optionally a corrosion inhibitor which is present in between about 0.01 and 0.1 percent by weight of the total composition.

In another embodiment the present invention relates to an anti-icing or deicing composition which further includes small (i.e. less than 2.5 mm sand like) solid particle means for increasing friction and traction in the composition on the surface to be anti-iced or deiced, wherein said solid particles are present in between about 0.1 and 20 percent by weight of the sum of the solid particle means and the fluid composition.

In another embodiment the present invention relates to an anti-icing or deicing composition for use in motor vehicle surface applications: in subpart (b) the non-toxic freezing point depressant is a mixture of propylene glycol present in about 5 to 15 weight percent, and isopropanol about 40 to 55 weight percent of the sum of the weights of the FPD(s) and water, and optionally further includes 1-dodecanol in between about 0.01 and 5.0 weight percent.

In another embodiment the present invention relates to an anti-icing or deicing composition for aircraft surfaces, said composition having a near-static viscosity at a shear rate of about 0.1 sec⁻¹ of 23,000 to 75,000 cPs and a shear thinned viscosity at a shear rate greater than 20 sec⁻¹, below cPs, at a temperature of in between about 0° and −20° C.

In another embodiment the present invention relates to an anti-icing or deicing composition having a near static viscosity of in between about 20,000 to 120,000 cPs at in between about 0° and −20° C.

The fortuitous and unanticipated discovery that certain of the environmentally friendly ice protection fluid compositions described and claimed here and in the prior versions of applications for this patent which also incorporate glycerin for improved longevity (and where friction loss is not important) also have outstanding and non-obvious anti-graffiti protection properties in addition to their inherent deice/anti-ice properties. The societal benefits imparted by these anti-graffiti properties that compliment the inherent life-saving features of the invention's icing protection fluids is deemed sufficient impetus to warrant incorporation into the specification herein these modified, additional compositions.

In keeping with the requirements of the first paragraph of 35 U.S.C. 112: the following is provided herein to delineate “the manner and process of making” the environmentally friendly compositions of the invention, and serves as an example of the simplistic and “non-capital intensive” method of merely blending together “off-the-shelf” components; and enabling any person skilled . . . to make and use.

### Example of Simplified Instructions for Blending TypicaL Anti-Icing/Deicing Composition Comprising 55.O phr (%) Propylene Glycol (P.G.), 0.5 phr (%) Xanthan, and 45.0 phr (%) Water (55.50 Composition)

1. Aliquot 0.5 phr (%) of Xanthan⁽¹⁾ into suitable container sized to accept major portion of total volume. ⁽¹⁾Xanthan used is Keltrol-T.

2. Wet entire Xanthan powder with P.G., sufficient to expel all air and coat each granule.

3. Slowly add, with thorough stirring, proportionally diluted solvent mix, e.g. increasingly greater proportions of water to glycol.⁽2) ⁽²⁾Into undiluted P.G. to dissolve. Use this to make up fluids for Step #3.

4. When entire 55-45 glycol-water has been added and the blend well mixed (strained if required), examine for homogeneity.

5. Add slowly the dodecanol, pre-warmed to transition it to a liquid phase. (2)

6. Add food coloring as needed. ⁽²⁾Into undiluted P.G. to dissolve. Use this to make up fluids for Step #3.

### Ingredient/Identity Information

Summary: These environmentally friendly fluid compositions of this invention are designed for use as an anti-icing/deicing fluid as well as an anti-graffiti solution. These fluids have not been fully tested as a whole composition, thus the information for the components, as individual ingredients of full concentration, is provided in this document. Additional information is available for the individual components from the respective constituent's source. This document highlights and summarizes the material safety for the components of these similar mixtures.

These similar mixtures are biodegradable. Some of the components, in full concentration and in certain forms may pose some hazard. All ingredients, except for 2-propanol (isopropyl alcohol), are used in food, in accordance with the FDA.

Composition and Ingredient Identification

| Component | CAS RN | RTECS | Some Common Uses |
|---|---|---|---|
| Dihydrogen Oxide, | 7732-18-5 | Not Available | — |
| [Water] | | | |
| 1,2,3-Propanetriol, | 56-81-5 | MA8050000 | Food Additive, Emollient/Skin |
| [Glycerin] | | | Softener, Toothpaste, Body |
| | | | Lotion, |
| 2-Propanol, [Isopropyl | 67-63-0 | NT8050000 | Rubbing Alcohol, Disinfectant, |
| Alcohol] | | | Astringent, Body Lotion, |
| | | | Antifreeze |
| Xanthan Gum, [CP | 11138-66-2 | Not Available | Food Thickener |
| Kelco: Keltrol-T &/or | | | |
| Keltrol-T622] | | | |
| 1-Dodecanol [Lauryl | 112-53-8 | JR5775000 | Food Flavoring, Perfumes/Scent |
| Alcohol] | | | Industry |

Exposure Limits in Air for Individual Ingredients

| Component | CAS RN | OSHA PEL^{1,2} | ACGIH TLV³ | NIOSH⁴ (STEL)⁵ |
|---|---|---|---|---|
| Dihydrogen Oxide, | 7732-18-5 | Not Available | Not Available | Not Available |
| [Water] | | | | |
| 1,2,3-Propanetriol, | 56-81-5 | 15 mg/m³ total dust | 10 mg/m³ | Not Available |
| [Glycerin]* | | 5 mg/m³ respirable | | |
| 2-Propanol, [Isopropyl] | 67-63-0 | 400 ppm (980 mg/m³) | 400 ppm | 400 ppm (500 ppm) |
| Alcohol] | | | | |
| Xantham Gum, [CP | 11138-66-2 | 15 mg/m³ total dust | Not Available | Not Available |
| Kelco: Keltrol-T &/or | | 5 mg/m³ respirable | | |
| Keltrol-T622] | | | | |
| 1-Dodecanol [Lauryl | 112-53-8 | Not Available | Not Available | Not Available |
| Alcohol] | | | | |

¹8 hour time-weighted average
²total dust designation indicates that the REL or PEL listed is for “total particulate” respirable-designation refers to the “respirable fraction” of the airborne particulate
³time-weighted average
⁴10 hour time-weighted average
⁵NIOSH's STEL—Short Term Exposure Limit
*as a mist

Physical and Chemical Characteristics (for the individual component at full concentration)

| | | | Melt. | Boiling | Flash | Vapor | | | | |
|---|---|---|---|---|---|---|---|---|---|---|
| | | | Point | Point | Point | Pressure | Vapor | Evaporation | Refractive | Solubility |
| Component | CAS RN | Density¹ | ° C. | ° C. | ° C. | ° C. | Density | Rate² | index | in Water |
| Dihydrogen | 7732-18-5 | 1 | 0 | 100 | N/A | 3.2 kPa³ | N/A | N/A | 0.8903³ | N/A |
| Oxide [Water] | | | | | | | | | | |
| 1,2,3-Propanetriol | 56-81-5 | 1.261 | 17.8 | 290 | 160 | <0.1 | N/A | N/A | 1.473 | miscible |
| [Glycerin] | | | | | | | | | | |
| 2-Propanol | 67-63-0 | 0.785 | −88.5 | 82.4 | 11.7 | 33 | 2.1 | 2.88 | 1.3772 | miscible |
| [Isopropyl | | | | | | | | | | |
| Alcohol] | | | | | | | | | | |
| Xanthan Gum [CP | 11138-66-2 | ˜50 lbs/ft³ | N/A | N/A | N/A | N/A | N/A | N/A | N/A | Yes |
| Kelco: Keltrol-T | | | | | | | | | | |
| &/or Keltrol- | | | | | | | | | | |
| T622] | | | | | | | | | | |
| 1-Dodecanol | 112-53-8 | 0.833 | 22-26 | 260- | 127 | 0.5 | 3.5 | N/A | 1.4428 | No |
| [Lauryl Alcohol] | | | | 262 | | | | | | |

¹specific gravity, with water at 4° C. (lg/ml)
²relative to butyl acetate (=1)
³at 25° C.

Appearance and Odor

| | |
|---|---|
| 7732-18-5 | Dihydrogen Oxide [Water] is a clear, colorless, odorless liquid |
| 56-81-5 | 1,2,3-Propanetriol [Glycerin] is a clear, colorless, syrupy liquid (solid below 64° F.), odorless, hydroscopic |
| 67-63-0 | 2-Propanol [Isopropyl Alcohol] is a clear, colorless liquid, with the odor of rubbing alcohol |
| 11138-66-2 | Xanthan Gum [Keltrol-T &/or Keltrol-T622] is a white to tan powder, with a slight odor |
| 112-53-8 | 1-Dodecanol [Lauryl Alcohol] is a colorless solid below 22-26° C. above which |
| | it is a colorless liquid with a floral odor |

Fire and Explosion Hazard Data

| | | | | Lower & Upper |
|---|---|---|---|---|
| Component | CAS RN | FlashPoint¹ ° C. | Autoignition Temp. ° C. | Explosion Limits, % Vol. |
| Dihydrogen Oxide | 7732-18-5 | Not Available | Not Available | Not Available |
| [Water] | | | | |
| 1,2,3-Propanetriol | 56-81-5 | 160 | 370 | 3-19 |
| [Glycerin] | | | | |
| 2-Propanol [Isopropyl | 67-63-0 | 11.7 | 399 | 2-12.7 |
| Alcohol] | | | | |
| Xanthan Gum [CP | 11138-66-2 | Not Available | Not Available | Not Available² |
| Kelco: Keltrol-T &/or | | | | |
| Keltrol-T622] | | | | |
| 1-Dodecanol [Lauryl | 112-53-8 | 127 | 275 | Not Available |
| Alcohol] | | | | |

¹Closed Cup
²Fine particulates may cause explosion if distributed into a mixture of air

### BRIEF DESCRIPTION OF THE DRAWINGS

FIGS. 1A, 1B, 1C, 1D, 1E and 1F are each a graphic and pictorial representation of the rheological behavior of conventional Type II FPD fluids, for example, ABC-3 of KILFROST®, (a deicing fluid of Kilfrost Ltd., Northumberland, UK); Octagon FORTY BELOW® (a deicing corporation of Octagon, of New Jersey); UCAR ULTRA® (a deicing fluid of Union Carbide of Danbury, Conn.); and aircraft anti-icing embodiments of this invention, applied to a wing section in various airflow states.

FIG. 1A is a graph of viscosity versus aircraft speed at brake release.

FIG. 1D is a cross-sectional representation of the wing (11) covered on the top with Type II fluid (12) at aircraft brake release.

FIG. 1B is a graph of viscosity versus aircraft speed during takeoff roll.

FIG. 1E is a cross-sectional representation of the wing (11) partially covered on top with Type II fluid (13) during the aircraft takeoff roll.

FIG. 1C is a graph of viscosity versus aircraft speed at rotation.

FIG. 1F is a cross-sectional representation of the wing (12) having most of the Type II fluid(14) removed at the speed of aircraft take-off.

FIG. 2 is a textbook graphic representation of the invariant or constant apparent viscosity of a typical Newtonian behaving fluid when subjected to varying shear rates, at constant temperature.

FIG. 3 is a textbook graphic representation of a non-Newtonian fluid, typical of xanthan thickened FPD fluid representative of the compositions of this invention. It shows both the characteristic pseudoplastic flow behavior and the Ellis type flow behavior yield value.

FIG. 4 is an overall, idealized, textbook graphic representation of the germane flow behavior of generic types of non-Newtonian fluids whose viscosity properties vary with shear rates.

FIG. 5 is a graphic, textbook log-log presentation of the idealized Ellis type, pseudoplastic flow behavior of a typical xanthan thickened FPD fluid of this invention. It highlights the near-zero shear viscosity (η₀) at and about the “yield point” and the infinite shear rate viscosity (η_{∞}), with power law behavior in between these points.

FIG. 6 is a graphic representation typical of the compositions of the prior art presenting the apparent viscosity in centipoises (cPs) versus shear rate (sec⁻¹), as taken from FIG. 1 of Tye, et al, U.S. Pat. No. 4,698,172 (original in semi-log plot), and compared in that patent with measured values for Hoechst 1704® Type II (icing protection fluid of Hoechst AGF, Frankfort, Germany), and intended to show superior properties of that invention's thickener, carrageenan gum.

FIG. 7 is a graphic representation of the present invention's composition of water (44.5 wt %), isopropyl alcohol (55 wt %), and xanthan (0.5 wt %) showing the response of the apparent viscosity in centipoises versus the shear rate at 20° C. Note the similarity of this flow behavior to that of the composition shown in FIG. 9.

FIG. 8 is a graphic representation of apparent viscosity versus shear rate. It compares the commercially available deicing composition KILFROST®^{ABC 3,} (deicing composition of propylene glycol with toxic and environmentally detrimental additives), with a version in accordance with this invention having an approximate composition of water (44.5 wt %), isopropyl alcohol (55 wt %0, and xanthan (0.5 wt %). Note the higher near-static viscosity and rapid shear-thinning of the composition of the invention.

FIG. 9 is a graphic representation of the apparent viscosity versus shear rate for one embodiment of the present invention's composition of water (44.5 wt %) and xanthan thickener (0.5 wt %), at −20° C., 0° C., and +20° C. Note particularly, the higher near static viscosity and rapid shear-thinning of the viscosity of a composition of the present invention.

FIG. 10 is a graphic representation of the magnified, low shear rate portion of the −20° C. shear rate of FIG. 9.

FIG. 11 is a graphic representation, of one embodiment of the present invention, of apparent viscosity and shear rate for water (44.625 wt %), propylene glycol (55 wt %) and xanthan thickener (0.375 wt %) at 0° C. and +20° C.

FIG. 12 is the magnified, low shear rate portion of the shear rate of FIG. 11, and further includes behavior at −20° C.

FIG. 13 is a graphic representation of one embodiment of the present invention showing apparent viscosity and shear rate for water (44.75 wt %), propylene glycol (55 wt %) and xanthan thickener (0.25 wt %) at 20° C.

FIG. 14 is a semi-log plot of embodiments of the present invention at 0.25, 0.375 and 0.5 wt % xanthan thickener. It demonstrates the linear relationship of the near-static viscosity of a 55 wt % FPD fluid with changes in concentration of the xanthan at 20° C.

FIG. 15 is a graphic representation of the apparent near-static viscosity (0.0102 sec⁻¹ shear rate) versus temperature comparing the composition having 0.50 wt % and 0.375 wt % xanthan and 55 wt % propylene glycol in water to a commercial fluid typical of the prior art composition of KILFROST® ABC (KILFROST 1990 Technical Booklet, Albion Works, Northumberland, UK).

FIG. 16 graphically presents a plot of the square root of apparent viscosity (η) plotted against the reciprocals of the square root of shear rate, as discussed in the section relating to the “smart fluid” technology, using data characteristic of an embodiment of this invention, having the composition52.1 wt % isopropanol, 5.2 wt % propylene glycol, 0.4 wt % xanthan, 42.3 wt % water.

FIG. 17 is a graph similar to FIG. 16, but using data characteristic of a different composition of the present invention as shown for 55.0 wt % propylene glycol, 0.5 wt % xanthan, and 44.5 wt % water.

FIG. 18 is a graphic textbook representation of the rheological moduli typical of a classically behaving elastic type liquid, showing that elastic modulus has a stronger contribution to shear stress (τ) than does viscous modulus, as indicated by angle Φ.

FIG. 19 is a graphic textbook representation of the rheological moduli typical of a classically behaving viscous type liquid, showing, as opposed to the type of FIG. 18, that the viscous modulus is dominant, and hence a stronger factor on temperature effects.

FIG. 20 is a graphic textbook representation of the rheological behavior of a Newtonian fluid and a pseudoplastic Type II anti-ice or deicing fluid (ADF), for example, as shown in FIG. 10.

For the following FIGS. (21 through 24), these rheology textbook graphs are typical, as for example as shown in: Foundations of Colloid Science, Vol. II, Oxford University Press, 1989.

FIG. 21A is a textbook graph which shows a characteristic curve for viscosity versus shear strain rate for a pseudoplastic and a Newtonian fluid.

FIG. 21B is a textbook graph which shows a characteristic curve for shear stress versus shear strain rate for a Newtonian and pseudoplastic fluid.

FIG. 22A is a textbook graph of a curve of viscosity versus shear rate for a thixotropic fluid.

FIG. 22B is a textbook graph of a curve of shear stress versus shear rate for a thixotropic fluid.

FIG. 23 is a textbook graph of a curve for apparent viscosity versus time at a constant shear for a thixotropic fluid.

FIG. 24 is a textbook graph of a curve for viscosity versus shear strain rate for a non-recovering, thixotropic viscosity reduction through three shear cycles.

FIG. 25 is a graphic representation of the cold storage stability, characteristic of this invention's fluid composition. The viscosity versus shear rate rheological data presented in the figure represents the results of evaluating small portions, each taken from the fluid stored in a freezer in a closed glass container. These samples were warmed slowly to room temperature (around +20° C.), also in a closed glass container, and then evaluated for shear rate dependency of viscosity using the same laboratory Brookfield viscometer that was used throughout the development work herein. A comparison was made of each sample's characteristic with the original data. No changes were observed throughout the test series, which lasted for over 106 days of cold storage viscosity tests (and continues).

FIG. 26 is a photograph of a 3M “SCOTCHLITE®” coated aged stop sign in colors of red and white and a portion is first coated with the composition and then sprayed with black lacquer.

FIG. 27 is a photograph of the sign of the FIG. 26 after contact with water under mild pressure.

FIG. 28 is a photograph of a new sample of 3M SCOTCHLITE® material, coated with the composition, dried, contacted with black spray lacquer, dried and contacted with water at low pressure.

FIG. 29 is a photograph of a commercial painted road sign first completely covered with composition of Example 13 and dried.

FIG. 30 is a photograph of the sign of FIG. 29 after contact with commercial black spray can lacquer.

FIG. 31 is a photograph of the coated graffitied sign of FIG. 30 showing a stream of water washing away the black lacquer.

FIG. 32 is a photograph of the coated sign of FIG. 31 wherein virtually all the black lacquer if removed.

FIG. 33 is a photograph of a commercial porous concrete stepping block wherein a portion is first contacted with the composition of Example 13, dried in the shape of a capital “Z”, contacted with black spray can lacquer, dried and washed with low pressure water to remove portions of the lacquer.

FIG. 34 is a photograph of FIG. 33 without the added lines to show the prior layer of black spray can lacquer in the form of the letter “Z”.

FIG. 35 is a photograph of the sign of FIG. 29 which is first completely coated with the composition of Example 13. Green spray can enamel is sprayed onto the coated surface.

FIG. 36 is a photograph of the dried enamel of FIG. 35 which is partially removed using low water pressure.

FIG. 37 is a photograph of the sign of FIG. 36 wherein all the dried enamel is completely removed.

FIG. 38 is a photograph of a railroad switch kept ice free by prior application of fluids typical of the composition described in Example 11, and “field tested” during winter conditions to demonstrate the fluid's capability to keep railways free of ice and snow.

The figures included here, present representative rheological characteristics of various compositions typical of some of the embodiments of the invention herein. They graphically demonstrate some improved properties of these new compositions, and in many examples, how these non-toxic compositions which exceed those of the known are, e.g., KILFROST ABC-3®; HOECHST 1704®; UCAR ULTRA®; and OCTAGON FORTY BELOW®.

### DETAILED DESCRIPTION OF THE INVENTION AND PREFERRED EMBODIMENTS

Definitions

As used herein:

“Alginate” refers to any of several derivatives of alginate acid (e.g., calcium, sodium or potassium salts or propylene glycol alginate). They are hydrophilic colloids (hydrocolloids) obtained from seaweed. Sodium alginate is water-soluble but reacts with calcium salts to form insoluble calcium alginate. Alginates are commonly used as food additives.

“Ambient conditions” refers to those pressure, temperature, humidity, etc. conditions of the actual environment. Typically ambient conditions are about 20° C. and 760 torr.

“Anti-graffiti refers to a coating which causes a surface to resist marking by paint, enamel, lacquer, ink and the like.

“Anti-icing” refers to the general term in this art. It usually describes the use of some external force, heating, shock, a liquid (gel) composition; whose function is to slow or to stop the icing process or to render any icing which might occur to be easily removed.

“Biodegradable” refers to the eventual decomposition of the fluid after the use by the action of the environment, e.g., microorganisms resulting in innocuous end products.

“Carrageenan” refers to a sulfated phycocolloid. The aqueous, usually gel-forming, cell-wall polysaccharide mucilage is found in the red marine algae (Chondrus crispus and several other species) and from red seaweed (Rhodophyceae). It is commonly used as an emulsifier in food products, etc.

“Continuous single phase” refers to the property of a fluid such that there is no abrupt discontinuities of physical properties throughout it bulk. The present invention is essentially free of mineral oil or any other water insoluble liquid (e.g., less than about 0.25 wt. Percent).

“Deicing” refers to the general term in this art, which usually describes the use of some external force (e.g., a hot liquid composition, scraping, lowering the freezing point, etc.) to remove ice already formed on a surface.

“Drag affect” refers to the affect that the aerodynamic drag causes on the surface of the applied anti-icing or deicing fluid, which is to impose a dynamic shear stress that results in fluid viscosity thinning; the magnitude of shear thinning is directly proportional to the rate of shear or shear rate. Drag affect is sometimes erroneously referred to as Drag Effect. When the aerodynamic shear stress experienced by the fluid equals or exceeds that fluid's characteristic rheological yield strength, the barrier to flow (see Ellis fluids), pseudoplastic flow occurs with the decrease of viscosity as shear rate increases.

“Effective amount” refers to the amount sufficient to provide the desired properties of anti-ice or deice to meet the particular application requirements, for example, a clear automotive windshield.

“Ellis fluid” (sometimes referred to in the specification herein as “Ellis type” fluids) is defined as a non-Newtonian pseudoplastic fluid with a well defined yield point or yield stress (see textbook FIG. 3, upper left of curve) which must be overcome before flow commences, and that flow then follows the pseudoplastic model. This pseudoplastic behavior of the Ellis fluids, where viscose flow occurs beyond the so-called “Ellis yield stress (τ_{e y})”, follows the “power law” behavior η=τ/\dot{γ}=k|\dot{γ}|ⁿ⁻¹ where k and n are constants for the fluid, and where n is less than one (n<1) for pseudoplastic behavior. The constant k is a measure of the fluids consistency, a higher k denoting a more viscous fluid. The constant n denotes the extent of departure from Newtonian viscosity properties, see definition here for pseudoplastic fluids. Xanthomona campestris thickened fluids of the present invention, being Ellis fluids in behavior, do not exhibit any thixotropic (nor rheopectic) characteristics. Therefore, they do not have time-dependent plasticity in their rheological performance. Fluids thickened with, for example, a xanthan of this invention behave as an Ellis fluid.

“Environmentally benign means that the impact to the environment by the component or composition under normal use conditions is not harmful to plant or animal health.

“Green food coloring” refers to any of the commercially available, so-called kitchen grade food coloring, such as the version used in compositions cited herein, which is commercially designated “Emerald Green”, and comprised by the blending of: (a) F.D.& C. Yellow #5 (acid Yellow #23), which is a monoazo tetrazine, and (b) F.D. & C Blue #1 (acid Blue 49), which is a triarylmethane (Azure Blue A.E.G.).

“Glycerin” refers to 1, 2, 3 propanetriol, commercially the product of saponification or de-esterification of organic triglyceride pats and dies (i.e. palm). Glycerin, although falling into the group of non-toxic water soluble, freezing point depressant polyhydric alcohols having from 3 to 12 carbon atoms of claim 1, et sequa, of this invention, serves the various claimed compositions as do the others comprising said monohydric and polyhydric alcohols, as an intended freezing point suppressant.

Glycerin is incorporated in claim 43, et sequa, of this invention, wherein it imparts to the fluid composition certain specific features not necessarily provided by the other of the freezing point depressant alcohols. These include lubricity, a desired property when the fluid is applied to rail equipment. Another advantageous feature is long term anti-dry-out due to the humectant or hydroscopic property of glycerin, whereby the tendency of glycol-water compositions to dry, especially on large flat surfaces such as vertical signs, or in the case where the fluid would be applied to power transmissions lines, etc., is countered by the ability of glycerin to replenish lost moisture by extraction from the ambient air. It is an unanticipated and non-obvious feature of the incorporation of glycerin, per se, into the said composition, that it imparts to the anti-icing or deicing fluid an additional and uniquely novel property of rendering an anti-graffiti effect. This is of particular value when claimed compositions of the freezing point depressant is applied onto vertical surfaces such as road signs. Subsequent to the icing event, the residual glycerin then imparts its graffiti protection.

For anti-icing and deicing fluid applications where reduction of surface friction would be deemed to be detrimental such as for aircraft, runway, roadway, walkway and nautical usages, incorporation of glycerin into the composition, either singularly or in combination with other polyhydric or with monohydric freezing point depressants would be contra indicated for safety reasons.

“Graffiti” refers to the undesirable marking of a surface with paint, enamel, lacquer, ink, etc. usually resulting in the defacement of the surface.

“Hazardous or toxic materials” refers to those compounds so designated by the Environmental Protection Agency (EPA), 40 CFR 261.33 (1994).

“Holdover time” is the expected aircraft icing protection time of the anti-icing fluid under various weather conditions. The estimated protection time is the time interval in between the beginning of the anti-icing operation and the inability of the fluid to protect water on the wing from freezing. As mentioned earlier in the discussions of Tables 1A and 1B, it is difficult to accurately predict the holdover time or the protection time for the known art compositions.

“Monolayer” refers to a single continuous layer or film that is one cell or molecule in thickness.

“Neutral” when referring to the total composition means a pH of in between about 6.9 and 7.1 preferable about 7.0.

“Non-electrolytic” refers to the inherent non-ionic non-conductivity property of the fluid since it contains no ionic species (i.e. salts) in the composition.

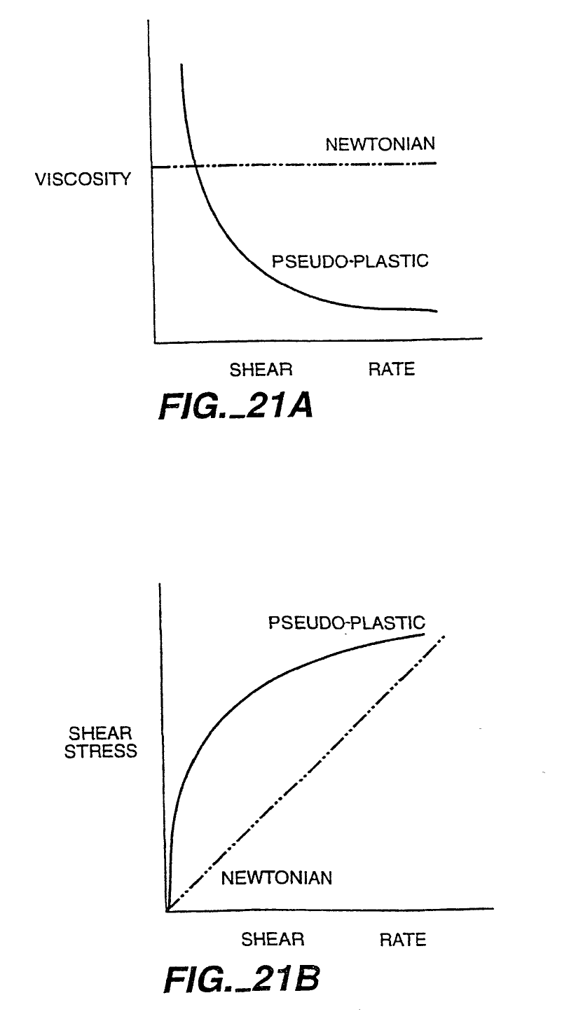

“Non-Newtonian fluids” refer to fluids which exhibit different apparent viscosity values when tested at the same temperature, and with the only parameter variant being that of rate of shear. Non-Newtonian fluids show changing viscosity with changing shear rate. There are five types on non-Newtonian fluids; three which are shear rate dependent (dilatant, pseudoplastic, and Ellis, see textbook FIGS. 21A and 21B) and two which are time dependent (rheopectic and thixotropic). One of the shear rate dependent types is pseudoplastic, in which the apparent viscosity decreases with increasing shear rate until finally leveling out at very high shear rates. Textbook FIG. 21A shows an example of the characteristic viscosity, and FIG. 21B shows an example of the shear stress versus shear rate curves for pseudoplastic non-Newtonian fluids.

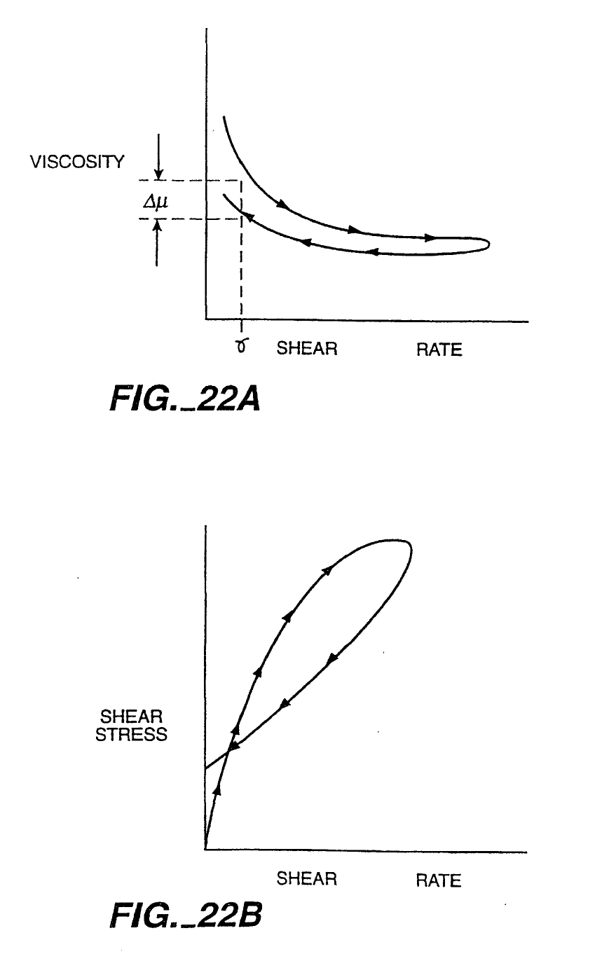

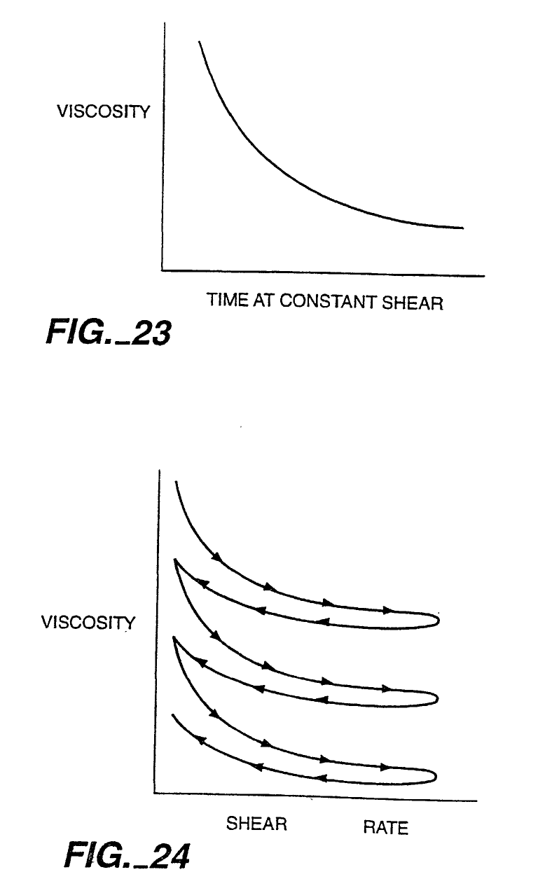

One of the two, more complex time-dependent fluid types is thixotropic, in which viscosity decreases with time under exposure to a constant shear stress such as gravity. Thixotropic fluids are complex because their viscosities are, in reality, dependent both on time and shear rate (textbook FIGS. 22A and 22B). A thixotropic fluid does not follow the same stress and viscosity curves when shear strain is applied and then removed. Further, thixotropic behavior may be either recoverable or non-recoverable. This is, if after being subjected to the shear cycle shown in textbook FIGS. 22A and 22B, a fluid is static, some fluids will recover the viscosity reduction Δμ and start the next shear cycle at the original viscosity level. In addition, an undesired characteristic of thixotropic compositions, for this invention, is the time dependent plasticity or flow under an applied constant stress. FIG. 23 shows this behavior of thixotropic fluids, as responding, for example, to the constant shear force caused by gravitational effect. Other fluids however, do not recover to the original viscosity value, but instead begin each shear cycle at progressively lower viscosities as shown in the textbook FIG. 24.

To further complicate matters, the current A.E.A. type II fluids exhibit both pseudoplastic and thixotropic behavior. The pseudoplastic behavior of the fluid allows it to remain thick and cling to a stationary or taxiing aircraft, but thin out and blow off as shear forces (due to high speed wind during acceleration for takeoff) act upon it. The thixotropic property of the fluid makes it difficult to handle, because of “shear damage”, wherein the original level of high viscosity is never attained again. Thus, it is apparent for purposes of aircraft ice protection, thixotropic rheological behavior is a very undesirable property for these fluids.

“Non-toxic” refers to the benign nature of the interaction of the component or composition with respect to the tolerance by specific plant or animal organisms (i.e. vegetables, animals, humans, and aquatic life), at the concentrations of normal use.

Non-toxic therefore refers to those compounds that are Generally Recognized As Safe (GRAS) for direct addition to human food by the Federal Drug Administration (FDA) standards, or compounds which are practically non-toxic to aquatic life as defined by the U.S. fish and Wildlife Service, U.S. Department of Interior under the conditions for the use of the invention for anti-icing or deicing purposes. Preferably, the LD₅₀ of the composition (for rat) is about 1 g/kg or greater.

Protection time” refers to the useful time provided by the deicing step, there are many variables affecting the protection time: e.g., wind velocity, precipitation rate, outside air temperature (OAT), aircraft skin temperature, solar radiation, types of precipitation or other hydrometeorological deposits (drizzle, rain, freezing drizzle, freezing rain, snow, snow pellets, snow grains, ice pellets, hail, hailstones, ice crystals, dew, frost, hoar frost, rime, glaze, and/or blowing snow), jet blast from other aircraft, sudden changes in temperature or precipitation type or rate, etc. All these can affect the holdover protection time.

“Propylene glycol” refers to 1,2-propanediol (the product of the hydrolysis of propylene oxide). The term may also include the 1,3-propanediol isomer.

“cPs” refers to centipoises, a unit(s) measure of viscosity, and is interchangeable with “mpa”, milli Pascal seconds.

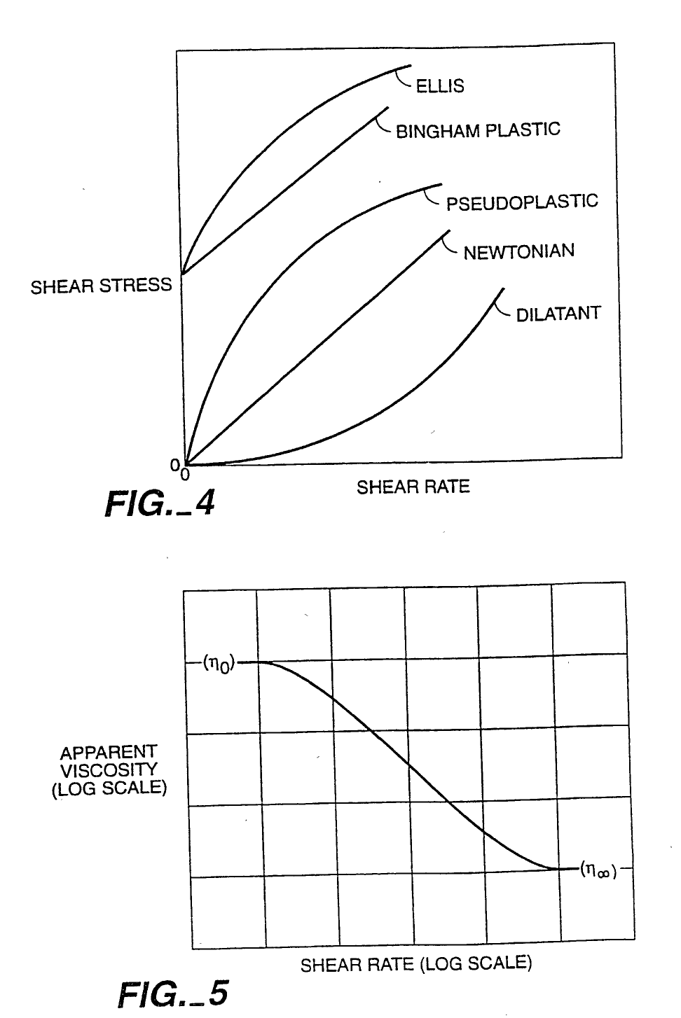

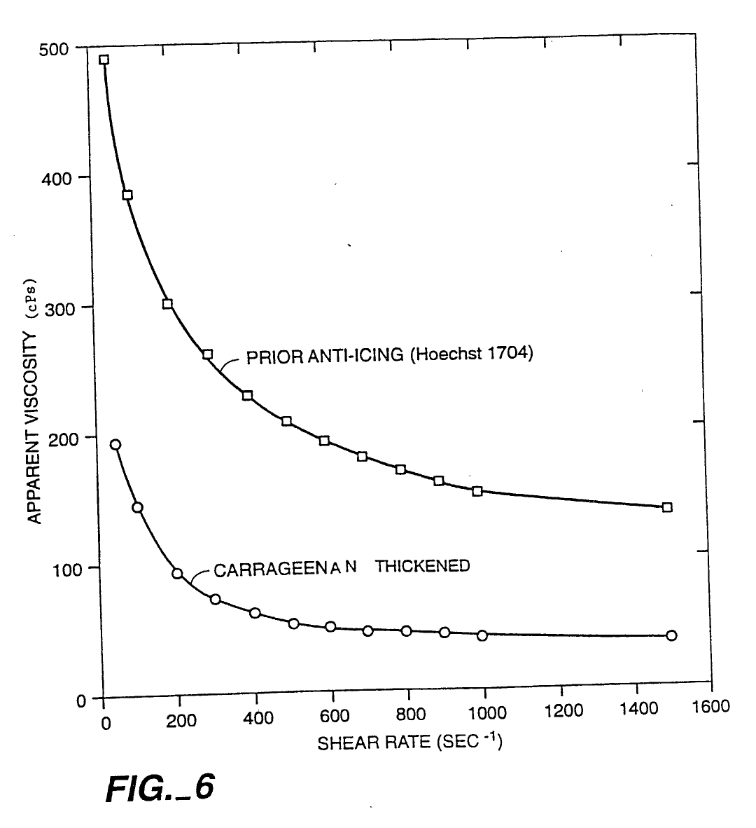

“Pseudo-plastic fluids” refers to non-Newtonian fluids that show no yield stress (as opposed to Ellis type fluids, see below) and whose typical plotted flow curve indicates that the ratio of shear stress (τ) to the rate of shear (\dot{γ}), refer to FIG. 4 which is termed herein as the “apparent viscosity”, decrease progressively with shear rate, and the flow curve becomes linear only at very high rates of shear. This limiting slope of the plotted curve is referred to as the viscosity, at infinite shear rate \dot{γ}_{∞}sec⁻¹) and is designated η_{∞}(Pₐ−S), refer to FIG. 5. This type of fluid behavior can be mathematically described by an empirical functional relation known as the “Power Law”; where the viscosity η(τ/\dot{γ}) is given by η=k|\dot{γ}|ⁿ⁻¹ and where k and n are constants (n<1) for the particular fluid, The constant k is a measure of the “consistency” of the fluid; the higher the k value the more viscose the fluid. The index n is a measure of the departure from Newtonian behavior, the lesser n is from unity the more pronounced would be the non-Newtonian properties of the fluid, and n is typically constant over a range of several decades of shear rate.

Because n<1 for pseudoplastics, the viscosity function since η=τ/\dot{γ} decreases as shear rate increases. This behavior, typical of high molecular weight polymers, their solutions and many suspensions in an over simplified manner, con be envisioned as the linear aligning (in the direction of the applied stress) of the major axis of the large molecules from their intermingled (sic, higher viscosity) state of rest.

“Specified conditions” refers to those conditions required to perform physical property measurements, e.g., viscosity. For viscosity measurements the temperature can be in between about −20° C. and +20° C. and at ambient pressure. More preferably, the temperatures are each about −20° C., −10° C., 0° C., +10C, and +20° C.

“Static viscosity” and “near static viscosity” are terms which refer to the viscosity of the pseudoplastic fluid at the onset of flow resulting from low shear rates (i.e., 0.102 sec⁻¹, or less).

“Thixotropy” refers to a non-Newtonian rheological flow behavior where viscosity depends on the shear history. The viscosity decreases with time at a constant shear rate, has an initial yield point characteristic of a solid, and behaves with time dependent plasticity with a reversible time dependent recovery. That is, the state changes from gel to sol to gel, and behaves the opposite to “rheopectic” materials.

“Viscosity” and “apparent viscosity” are, for purposes herein, used interchangeable, and without being bound by theory. They refer to all measured viscosities presented here (i.e., as measured by the Brookfield Viscometer). They are derived by the device by determining the ratio of the torque (τ) to shear speed(s). Absolute viscosity (Δτ/Δs) is obtained by calculating the ratio of incremental torque (Δτ) to speed increment (Δs).

“Weight Percent” (wt %), refers to the weight of that constituent, per hundred ratio, with respect to total weight of the combined composition, unless otherwise specified.

“Xanthan” generally refers to a variety of synthetic, water-soluble (either hot or cold) hydrophilic exocellular heteropolysaccharide colloid polymers, e.g., one made by in-vitro fermentation of carbohydrates by the bacterium Xanthomonas compestris. The xanthan polysaccharide colloids to be used in accordance with this invention and their preparation are described in U.S. Pat. No. 3,557,016. They are known commercially, available food thickening and suspending agents that are heat-stable, with a tolerance for strongly acidic and basic solutions. The solutions have stability and compatibility with high concentrations of salts (sodium chloride 15% and calcium chloride 25%). The viscosity remains stable over wide temperature ranges (−18° C. to +80° C.) and over wide pH ranges (1 to 11).

In general, high molecular-weight polymeric dispersions exhibit forms as non-Newtonian flow, most often pseudoplastic to some extent, and is characteristic of aqueous solutions of polysaccharides. It is well known in literature describing the art for the use of xanthan gum, that these certain polysaccharides dissolve in water to form solutions; that is, homogeneous single phase aqueous constituents. For example, the KIRK-OTHMER, ENCYCLOPEDIA OF CHEMICAL TECHNOLOGY, Third ed. Vol.12 (1980), John Wiley & Sons, N.Y., which describes on page 62 that, “Xanthan gum is a cream-colored powder that dissolves in either hot or cold water to produce solutions with high viscosity at low concentration. These solutions have unique rheological properties. They exhibit pseudoplasticity, i.e. the viscosity decreases as the shear rate increases.” In aqueous solutions of xanthans, for example, I.T. Norton, et al, in 1984, “Mechanism and Dynamics of Conformational Ordering in Xanthan Polysaccharide.” Journal of Molecular Biology, 175 (3); 371-394, suggest that this behavior is believed to result from the formation of complex molecular aggregates by means of hydrogen bonding and physical entanglements of the long polymer chains.

Xanthan aqueous colloidal solutions of the embodiment compositions of this invention display excellent viscosity versus shear rate characteristics, and have no time-dependent plasticity behavior. The fluid flow behavior, shown in FIG. 5, highlights the zero-shear viscosity (ηₒ) and infinite-shear viscosity (η_{∞}) with power law behavior in between these two limits. Having this initial yield stress characterizes the xanthan thickened fluids of this invention as an Ellis (or non-Bingham plastic) variant of pseudoplasticity, and the Ellis curve in FIG. 4. This thickener has an initial value of infinite shear stress (known as yield stress). That initial resistance, which must be exceeded to initiate flow, can be determined for each set of conditions such as fluid temperature and thickener concentration, leading to the development of a “smart fluid” or ice protection. This fluid and its properties are described in detail in the text below.

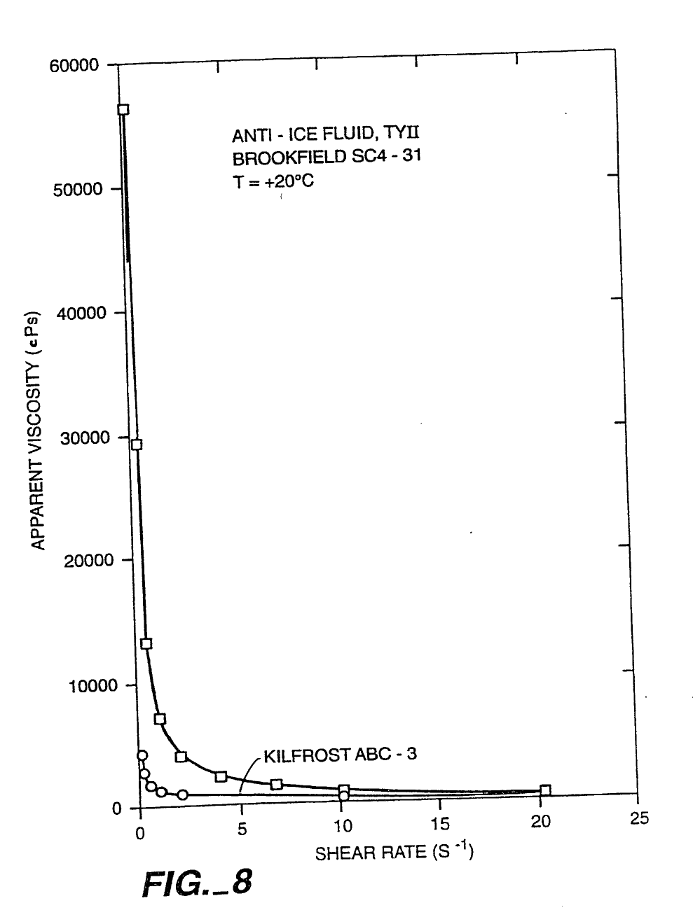

A thickener discovered to possess the unexpectedly desirable features of the present invention is a select xanthan, the hydrophobic polysaccharide colloid described above. Its use imparts surprisingly improved Type II fluid properties, and is compatible with essentially all FPD fluids tested (including mixed glycols). A comparison of a fluid of the present invention with a current commercially used Type II fluid KILFROST ABC-3® is shown in FIG. 8. This figure highlights the rheological performance of a composition typical of the fluid composition of this invention, and compares its dramatic viscosity decline with shear rate to that of the KILFROST ABC-3®. This behavior can be described as, “like going from lime sherbet to limeade during takeoff roll”. The lime alludes to the emerald green shown in the magazine photograph (see article in Aviation Week and Space Technology Magazine, Jan. 11, 1993, page 44, where the emerald green hues were obtained using FD&C food colors yellow #5 and blue #1 (Any FD&C approved food color can be used).

The present invention improves on fluids of the art, and claims compositions different from any presently used, as is described herein below. Further, the present invention results in a new series of compositions of such fluids that are superior to those presently known of the prior art in essentially all significant properties, including, but not limited to, rheological flow behavior; resistance to mechanical (Hysteresis) damage to viscosity; shelf-life (in excess of three years); holdover times (in excess of 36 hrs.); resistance to drizzle dilution; and the ability to be foamed in-situ or be varied in applied composition in-situ (a “smart fluid”) to meet specific requirements.

The present invention is, therefore, an improved compound for protecting against icing-up on the surface of objects, i.e. anti-icing and deicing, particularly for aircraft, which fulfills the demands mentioned initially, and particularly those relating to the important properties, namely, controlled stability against shear, controlled viscosity, rheological behavior (this is, in particular, the controlled viscosity and controlled flow behavior at a low and at a very high shear rate), holdover time, and particularly, low toxicity and facile environmental degradation.

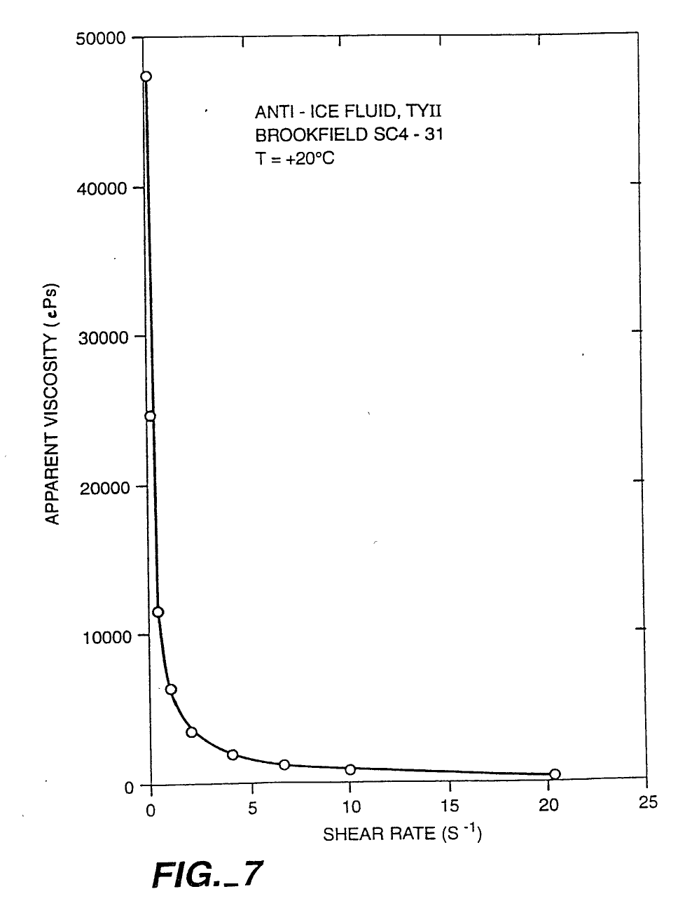

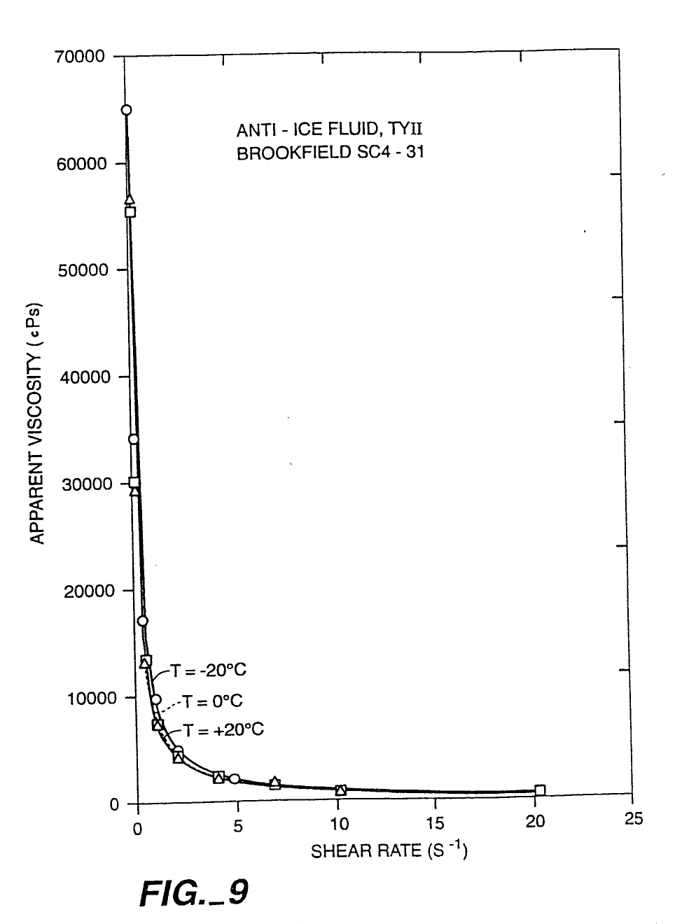

In the present invention, FIGS. 7, 8, 9, 10 and 11, show the rheological behavior of compositions of this invention. FIG. 7 is a graphic representation of the present composition of water (44.5 wt %), isopropyl alcohol (55 wt %), and xanthan (0.5 wt %) showing the response of the apparent viscosity in centipoises versus the shear rate at 20°. Note the similarity if this flow behavior to that of the composition shown in FIG. 9.

These include the viscosity-shear rate effect translated directly to viscosity-airspeed effect, which is a more practical correlation for aeronautical purposes.

FIG. 8 presents a graphic representation of apparent viscosity versus shear rate. It compares the commercially available deicing composition KILFROST® ABC 3 (propylene glycol with toxic and environmentally detrimental additives) with a version in accordance with this invention having an approximate composition of water (44.5 wt %), isopropyl alcohol (55 wt %), and xanthan (0.5 wt %). Note the higher near static viscosity and rapid shear thinning of the composition of the present invention.

FIG. 9 shows a graphic representation of the apparent viscosity versus shear rate for one embodiment of the present invention's composition of water (44.5 wt %), propylene glycol (55 wt %) and xanthan thickener (0.5 wt %), at −20° C., 0° C., and +20° C. Note particularly the higher near-static viscosities and rapid shear thinning of the composition of the present invention.

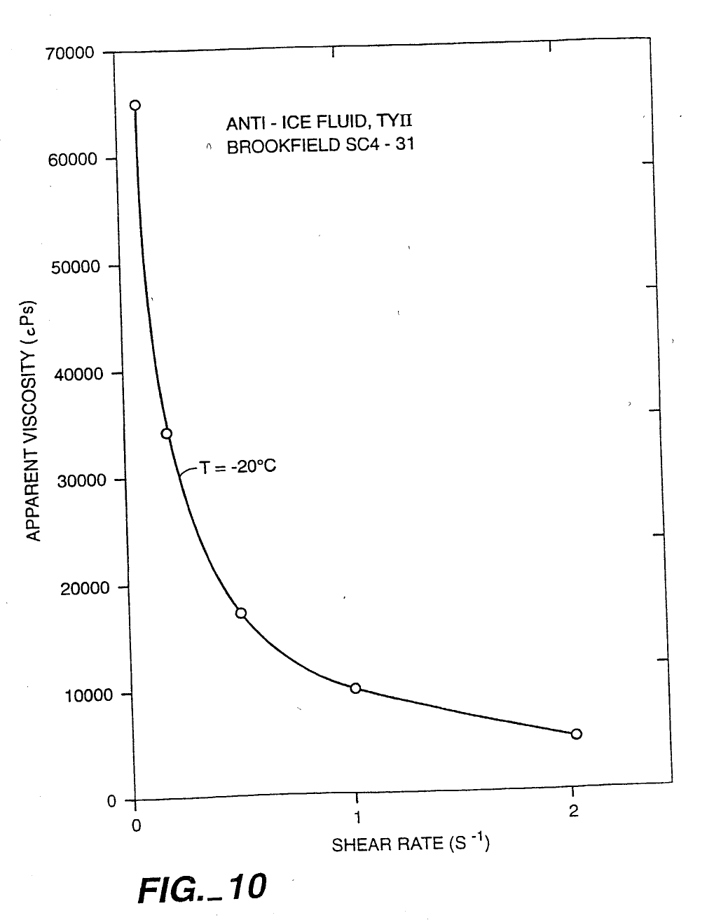

FIG. 10 gives a graphic representation of the magnified, low shear rate portion of The −20° C. shear rate of FIG. 9. It shows the maximum variation emphasized.

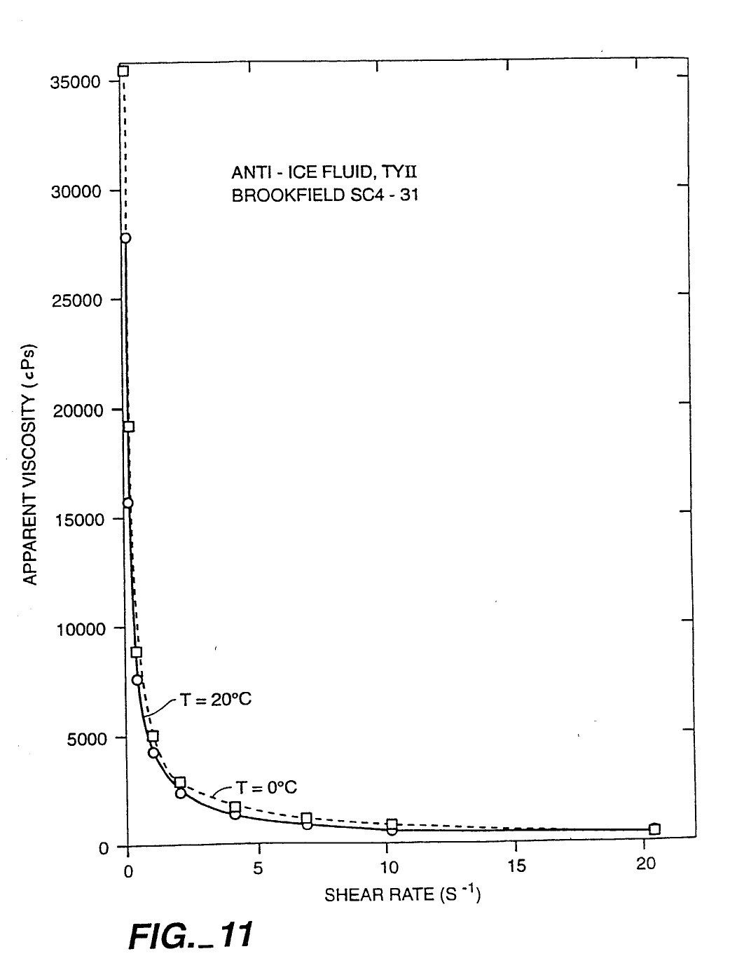

FIG. 11 further presents a graphic representation of one embodiment of the present invention of apparent viscosity and shear rate for water (44.625 wt %), propylene glycol (55 wt %) and xanthan thickener (0.375 wt %) at 0° C. and glycol (55 wt %) and xanthan thickener (0.375 wt %) at 0° C. and +20° C.

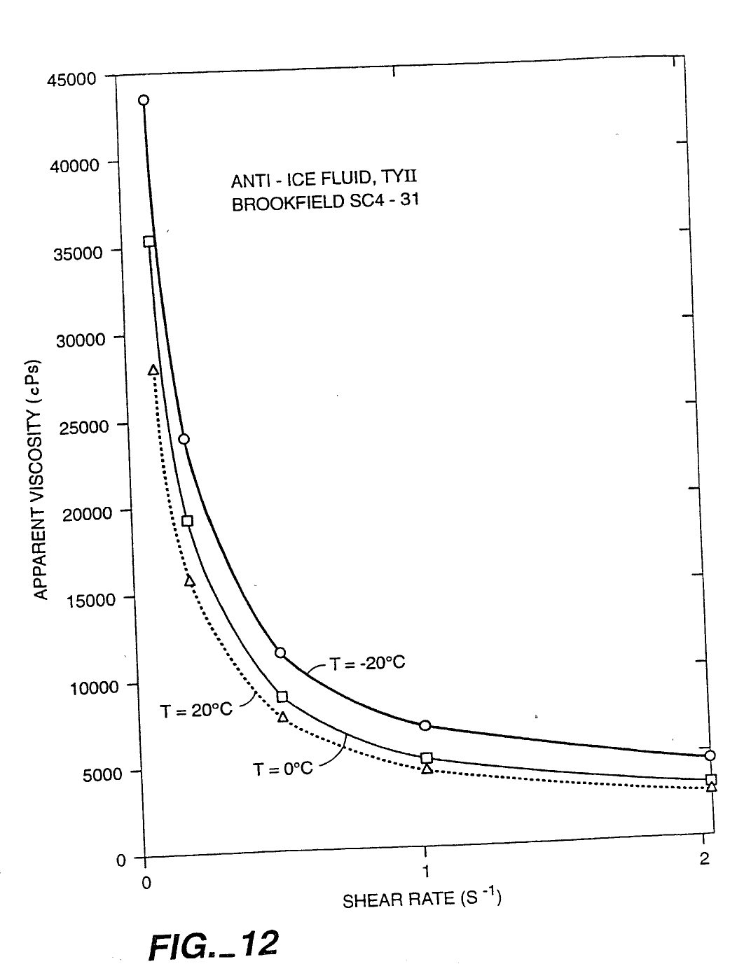

FIG. 12 showing the magnified, low shear rate portion of the shear rate of FIG. 11, and further includes behavior at −20° C. It shows the maximum variations emphasized.

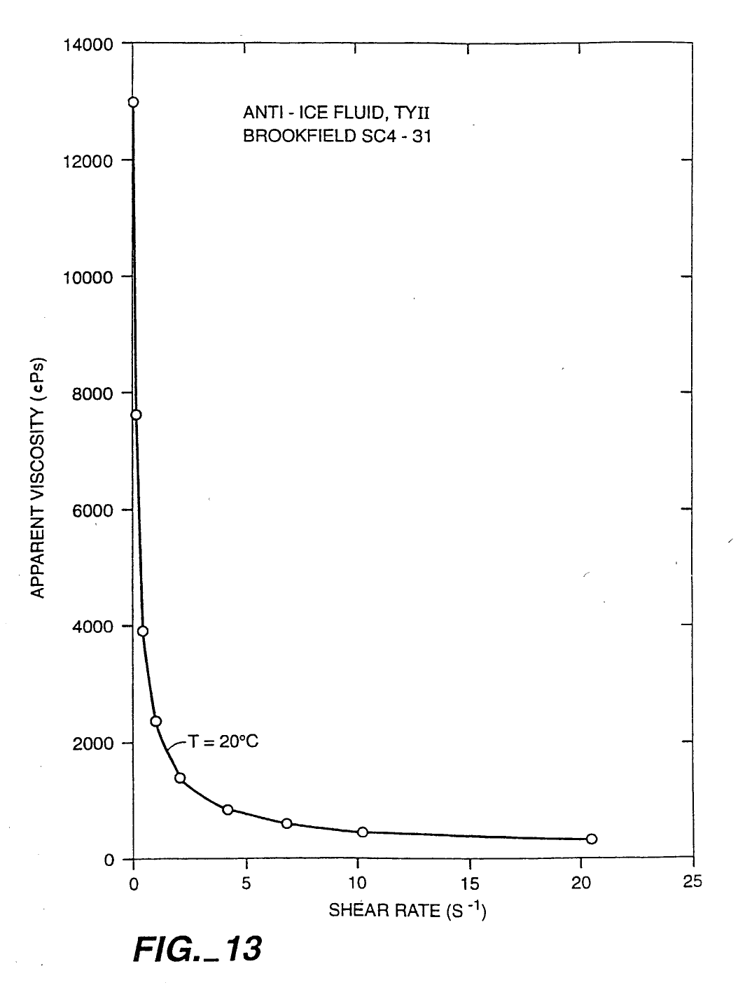

FIG. 13, further, is a graphic representation of one embodiment of the present invention showing apparent viscosity and shear rate for a composition of water (44.75 wt %, propylene glycol (55 wt %) and xanthan thickener (0.25 wt %) at 20° C.

Note the initial at rest (near-static) viscosities of the embodiment compositions of this invention and how their respective viscosities drop rapidly with increasing shear rates (for compositions for aircraft applications, corresponding to increasing airspeed as the aircraft accelerates). In addition, the typical thickener, a food grade xanthan, is non-toxic and economical. Since the viscosity behavior of the new fluid has been shown to be completely reversible with shear rate, the fluid is therefore resistant to physical (i.e. pumping) damage. The fluid is also neutral and is typically non-corrosive. The composition requires no special handling or equipment. Expensive low shear pumps and special handling that current Type II/IV fluids require is not needed; thus elimination a two step process using two different fluid types, one to deice and one to provide anti-ice protection and additional equipment. The fluid of the present invention exhibits no viscosity loss due to pump-shear effects or rough handling; this, its use reduces the uncertainty that the currently used fluids' unknown prior shear damage histories may place on the safety of the aircraft. The compositions of the present invention are also much more shear rate sensitive than currently used Type II/IV fluids. This means the initial static viscosity can be and is significantly higher, resulting in more effective adherence (creating a better ice protection blanket) and less fluid usage. Due to the small quantity of thickener needed, it is very cost effective. Excellent spreadability and higher static viscosity (albeit very low dynamic shear viscosity) translates to longer holdover times with the use of a lower quantity of fluid. For the airport facility, this means less FPD fluid to drain per aircraft. Higher near-static viscosities are beneficial because they provide more durable FPD film protection and thus longer holdover times, as long as the viscosity still drops rapidly with shear rate. The more durable FPD film creates a blanket-like barrier, protecting against the incursion of precipitating ice forms, by being far less susceptible to displacement than are lower viscosity films. In support of this, in KILFROST'S technical literature cited above, there is presented data correlating their improved static viscosity with improved (extended) holdover times. FIG. 8 shows the improved viscosity performance of the compositions of the present invention as compared to the fluids of the prior art. Higher static viscosities typically equate to longer holdover times; a feature deemed desirable for aircraft ice protection.

For aircraft applications, it is important to note that the static viscosity of the present invention's composition (as shown in FIG. 8) is about a factor of at least ten higher than that of the prior art's upper value (ηₒ). The fluid composition of the present invention has higher static viscosity which drops quickly in response to increasing shear rate until it asymptotically fall to the same low value (η_{∞}) of viscosity found in the prior art fluids, and is achieved in the equally brief span from 0 to 20 reciprocal seconds (20 sec⁻¹). The higher static viscosity characteristics of fluid compositions of this invention have a direct correlation with holdover time. That is to say, the higher static viscosity equates to longer holdover times, which is highly desirable. Yet the fluid's behavior of the rapid viscosity drop to the lower value is also a very desirable characteristic because it assures proper shedding from the aircraft's surfaces during takeoff for maximum effectiveness.

FIGS. 9 to 13 also show the typical temperature response of viscosity versus shear rate for the compositions of the present invention. When compared to the prior art in FIG. 8, the compositions of the present invention are superior, e.g., viscosity, non-toxic, neutral, etc. with the same propylene glycol as the FPD.

Xanthan—A selected xanthan polymer, Xanthomonas campestris, has a repeating unit (or mer) which consists of five sugar units: two mannose, two glucose and one glucuronic acid units polymerized into a backbone comprised of 1,4-linked β-glucose, identical in structure to cellulose, and having a polymer molecular weight of approximately two million. The trisaccharide side chains (two mannose, and one glucuronic) on alternating anhydroglucose units is the feature that distinguishes this moiety from cellulose, plus the pyruvate species at most terminal mannose units.

There are thirty species of genus Xanthomonas that are known to produce extra cellular polysaccharides by aerobic fermentation that might be suitable for application as thickeners for the ice protection fluid candidate compositions. Thus, other xanthomonas polysaccharides (e.g., xanthans), in addition to xanthomonas compestris of the preferred embodiments, were examined as potential candidates for use as thickeners for the aqueous freezing point depressant (FPD) embodiments of this invention. Some of these xanthomonas, for example, those described by Schuppner, (supra) are listed in Table 2. Those four listed in Table 2 with an asterisk are deemed most suitable as potential candidates, based on the relatively high viscosities at shear rates of 10.2 sec⁻¹.

TABLE 2
Comparison of Viscosities of Various Types of Xanthomonas
Hydrophilic Colloid Thickeners at 10.2 sec⁻¹ Shear
Rates, at 20° C., in cPs, Brookfield

| Bacterium Progenator, | | | | |
|---|---|---|---|---|
| Aerobic Fermentation | Aqueous Conc. (% by weight) | | | |
| Campestris * | 1.0 | 0.50 | 0.375 | 0.25 |
| | 1800 | 911 | 688 | 451 |
| Incanae * | 1800 | — | — | — |
| Malvacearum * R2 | 1760 | — | — | — |
| Malvacearum XM13 | 1280 | — | — | — |
| Begoniae * S9 | 1560 | — | — | — |
| Begoniae S3 | 500 | — | — | — |
| Carotae XC11 | 1000 | — | — | — |
| Phaseoli | 20 | — | — | — |

The initial criterion for selection was the value of the 20° C. viscosity of a 1.0% by weight aqueous solution, as measured by a Brookfield viscometer at a constant shear rate of 10.2 reciprocal seconds (sec⁻¹). All viscosity measurements were made using a conventional Brookfield viscometer, spindle set SC 4-31, from Brookfield Engineering Laboratories, Inc., 240 Cushing Street, Stoughton, Mass. 02072.

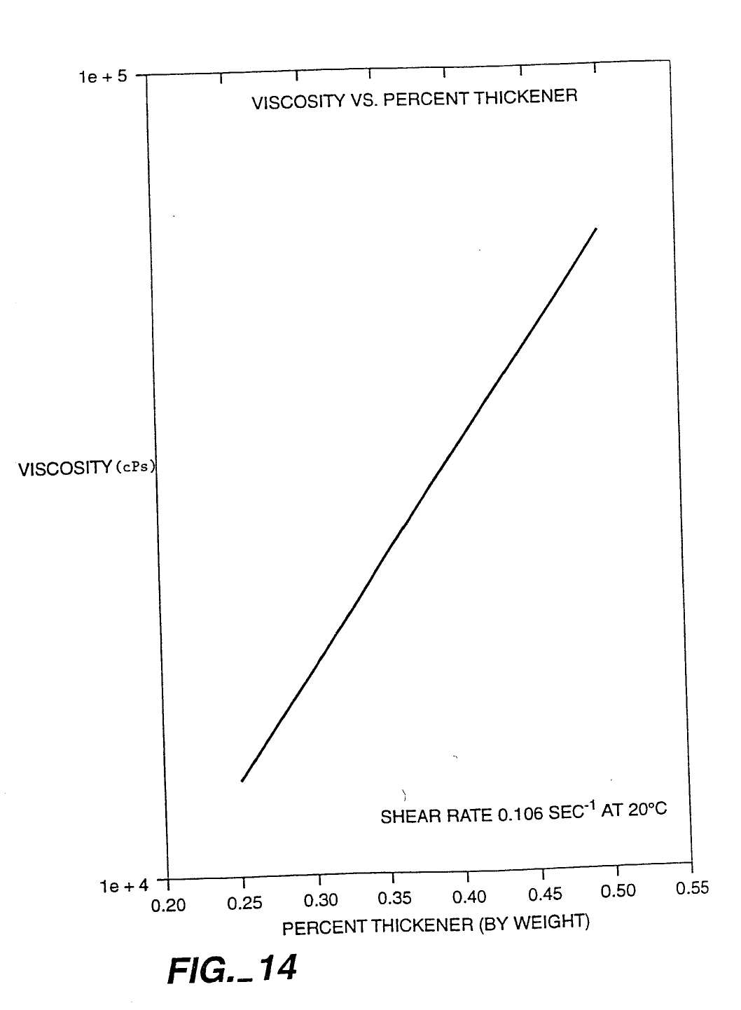

Of the seven additional xanthomonas polysaccharides listed in Table 2, only those which exhibit viscosities above about 1500 cPs are considered suitable for use in anti-icing or deicing compositions of the present invention. The selection is based on experience of the non-Newtonian rheological behavior of the xanthomonas thickened aqueous solutions; on data of the essentially linear behavior of near-static viscosities of this type of thickener with respect to concentration, for example as shown in FIG. 14; and the correlation of the viscosities versus shear rate to the response of the compestris thickener, as shown, for example, in FIG. 13. Thus, the selection of xanthan thickeners (xanthomonas polysaccharide) having improved results in the present invention are those materials having a viscosity of about 1500 cPs or higher: e.g., xanthomonas compestris, xanthomonas Incanae, xanthomonas Malvacearum R2, and xanthomonas Begoniae S.

Aqueous xanthan (xanthomonas hydrophilic colloidal polymer) solutions of preferred embodiments of the present invention have surprising and unexpected rheological properties. Their pseudoplastic flow behavior is characterized by a dramatic decrease from a high value (obtained with only minimal quantity of thickener) as the shear rate is increased to a low value. The viscosity drop is rapid and yet fully reversible (nearly instantaneously) with no hysteresis. As discussed later, the solutions also have rheological yield points (dyne/cm²), indicating a further uniqueness of simultaneously having an Ellis behavior at very low shear rates. This behavior is believed (Norton et al, cited above) to result from the formation of complex molecular aggregates by means of hydrogen bonding and physical entanglements of the long polymer chains. This highly ordered network and high degree of hydrogen-bonding accounts for the unusually high “static” viscosity.

Upon the application of increasing shear rate, there occurs a dramatic disaggregation of this ordered network and laminar-like alignment of the individual chains in submission to the imposed shear and/or stress. As soon as shearing ceases, the original aggregating forces come into play to rapidly reform the high viscosity configuration.

Many inorganic and organic polymer thickeners, and almost all polysaccharide thickeners dispersed in aqueous systems produce shear rate dependent fluid effects, pseudoplastic non-Newtonian flow, which is characterized by a decrease in apparent viscosity in response to increasing shear rate. At the same time, however, most polysaccharides and all polyacrylates have the undesirable behavior (for anti-icing/deicing fluid applications) that their viscosity decreases with time under applied steady shear stress, and are described as being thixotropic. These thixotropic polysaccharides solutions can include carboxy methyl cellulose, starch, alginates and the family of galactomannans derived from seeds which include guar gum, locust bean gum, and cassia gum. Also included is the sulfated polysaccharide gum derived from marine algae, carrageenan.

Surprisingly and fortunately for the purposes of the present invention, xanthan gum is a polysaccharide thickener that retains very high and durable pseudoplastic behavior, but is not thixotropic. It has essentially no time-dependent plasticity. Xanthan thickened systems of the present invention thus do not flow or sag with time under the constant shear stress of gravity or steady wind. This is a desirable requirement for aeronautical applications, and for some nautical, civil (e.g., bridges, roads), and domestic (e.g., sidewalks) applications as well, especially on inclines surfaces.

The selected polysaccharide, a specific type of xanthan, is:

1, An exocellular hydrophilic heteropolysaccharide;

2. A natural occurring polysaccharide formed on terrestrial rutabaga plants solely by the pathogenic action of the bacterium, Xanthomonas campestris;

3. Produced in-vitro by an aerobic fermentation process by the particular bacterium on specific organelles at the cell surface by complex enzymatic process;

4. A polysaccharide colloid-former which is produced commercially by in-vitro aerobic fermentation by the exocellular xanthan progenating bacterium Xanthomonas campestris, submerged in medium containing a carbohydrate, trace elements, and other growth factors; and/or

5. Now commercially available as a powder for food usage at a reasonable price.

Surprising and unexpectedly useful properties are obtained when a particular exocellular hydrophilic polysaccharide polymer, e.g., a specific selected xanthan, is utilized as a water-dispersible thickener for mono- and polyhydric-based aqueous deicing and anti-icing fluids, especially in the resulting rheological behavior it produces. As compared to the rheological properties contributed to fluids of this nature by the known art thickeners, in the use of the composition of xanthan's thickened fluids have a number of attributes, some of which are useful in the present invention, e.g.:

1. Only a small amount of thickener is needed to obtain a fluid having the desired high static viscosity;

2. The shear rate dependency of the fluids of the present invention (e.g., the rate at which viscosity drops from a very high static value, in a steep smooth and predictable manner, to an asymptotic very low value with increasing rate of shear, and is a highly sought after feature), far exceed that of other fluids as described herein; and γ

3. The shear rate dependency characteristic of the fluids of the present invention is not damaged by high shear forces, unlike that of the prior art, and thus it displays no hysteresis of viscosity with shear rate γ.

Therefore, the aqueous freezing point depressant (FPD) anti-icing or deicing fluids thickened by the selected xanthan polymer have inherent high static and low dynamic viscosity values that are less temperature variant than those of the commercially available prior art thickened fluids described herein. The art compositions have characteristics which are less of the elastic liquid type and tend more toward the viscous liquid in behavior.

Additional bacterium progenated heteropolysaccharide hydrophilic colloids, produced in-vitro by controlled aerobic fermentation by select bacteria strains and suitable as thickeners for fluids of the present invention include:

Whelan, from bacterium Alcallgenes strain (ATCC 31555) has rheological properties in aqueous dispersion similar to Xanthomonas campestris but with increased viscosity at low shear rates and even improved thermal stabilities.

Rhamsan, from bacterium Alcallgenes strain (ATCC 31961) has rheological properties in aqueous dispersion similar to Xanthomonas campestris, but also having very high static viscosities at low concentrations.

Beijerinekia Indica, from bacterium Azotobacer Indicus, in aqueous dispersions are viscosity reversible and pseudoplastic, stable over a wide temperature range and exhibit higher static viscosities (at ;low concentrations) than even most xanthanes.

Gellan, from bacterium Pseudomonas Elodea.

The present anti-icing and/or deicing fluid is formulated around a type of hydrophilic colloidal polymers, preferable comprising of heteropolysaccharides that are usually manufactured in-vitro by the action of bacterial aerobic fermentation. That process results in a simple, one-component thickening agent, e.g., a xanthan, that readily combines with a non-toxic, freezing point depressant aqueous fluid to give continuous phase stable solutions having improved Type II anti-icing fluid behavior and having improved holdover times. The aqueous solution provides the desired anti-icing behavior over a practical range of operating temperatures. Further, the entire formulation is comprised of food grade constituents, and thus is essentially non-toxic.

With the use of the essentially mono-layer forming hydrophilic-hydrophobic constituent, e.g., (1-n-dodecanol) constituent, extended holdover times are also achieved, which are in excess of the times characteristic of the current state-of-the-art fluids. The hydrophobic upper layer formed constitutes an effective barrier to penetration by ambient precipitation, e.g., freezing rain or drizzle, thereby minimizing dilution or washing away of the protective barrier coating.

The deicing fluids described by Ma, et al., U.S. Pat. No. 4,954,279 and König-Lumar, et al., U.S. Pat. No. 4,358,389 for gels.

In contrast, the solutions of the present invention typically require no oil-based micro-emulsions for fabrication or for storage stability and do not for gels. The fluids of the present invention have high static viscosities to provide improved durable icing protection coverage prior to aerodynamic air flow, and which then drop to ensure complete coating removal by airflow during the aircraft's takeoff and prior to flight. This viscosity decrease, as the shear rate increases, is substantially instantaneous and is also fully reversible. Further, the fluids of the present invention have excellent thermal stability, and their viscosities are essentially constant over the range of 0° to +80° C. They possess finite rheological yield strengths (Ellis type rheological behavior) that must be overcome prior to any fluid flow, but unlike all conventional Type II fluids, are not thixotropic. Thus, they present no time-dependent plasticity (e.g., gravity sag). Nor do they demonstrate any undesirable permanent shear or hysteresis behavior, a deficiency that, to the best of our present information, characterizes all other currently available pseudoplastic FPD fluids. Although the xanthan thickeners are synthetically produced (in-vitro) food grade heteropolysaccharides, (for example by the genus of bacterium xanthomonas) they do not appear to be susceptible to microbial or fungal attack (nor are the polyacrylate polymers), prior to application. However, after spraying and use, they are consumed by these natural agents present in the local environment (unlike the acrylates) to greatly reduce any environmental impact.

Ma et al. describes using a de-icing composition using ethylene glycol and other alcohols with a xanthan gum as an optional (preferred) thickening agent for anti-icing fluids. A water-insoluble mineral oil in micro-emulsion is added to keep the fluid as a homogenous two-phase blended suspension (lyophobic/lyophilic) system, and to prevent gelling or phase separation caused viscosity decrease (either of which renders the fluid useless) from occurring when the composition is stored at sub-zero temperatures for prolonged periods of time. Ma, et al. disclose at column 5, line 38, et sec.,

“the partially polar compounds comprise at least a portion of the oil and are provided in an amount of about 0.1 to 2.5% by weight based on the total composition. The partially polar compounds will usually comprise a micro-emulsion of micelles. The total oil is an amount up to about 5% by weight based on the total composition and when oils other than partially polar compounds are used, they are preferably present in amounts of at least about 0.01% by weight of the total composition. The amount of such oil present is the micro-emulsion with the continuous phase components of the composition of this invention should be in the range of from 0.01% to 5.0% by weight based on the total weight of the composition.”

In contrast, the present composition does not require the addition of mineral oil as a micro-emulsifier to form tiny micelles since the xanthan gum type that is used goes readily into solution with aqueous anti-icing fluids, using conventional missing procedures. Also, the present composition is cold-storage stable an has been freezer stored for over three months with weekly testing which confirms that there is no change in desired chemical or physical properties. Unlike the fluids of the Ma et al, patent (without the micro-emulsion of water insoluble oils), the fluids of the present invention show the ability to maintain their original flow characteristics, clarity, or storage ability (thus showing no tendency to gel) even after prolonged cold storage

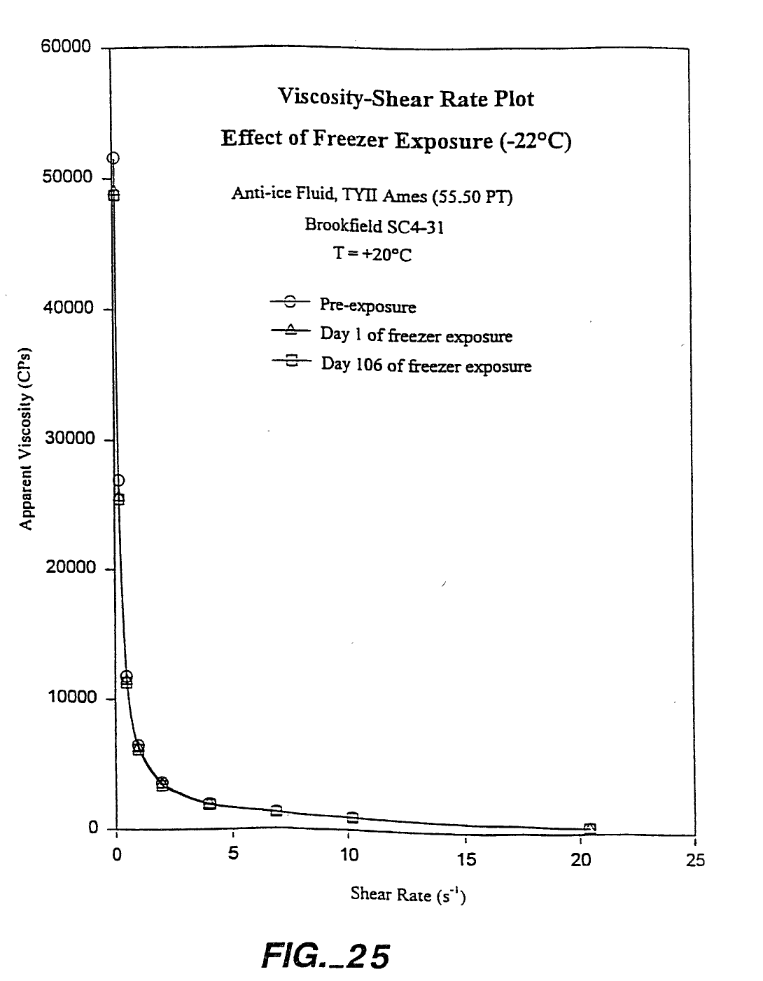

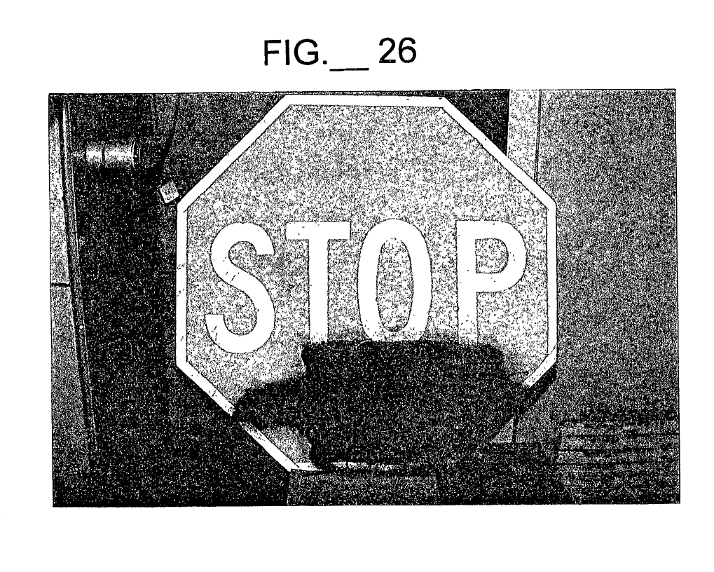

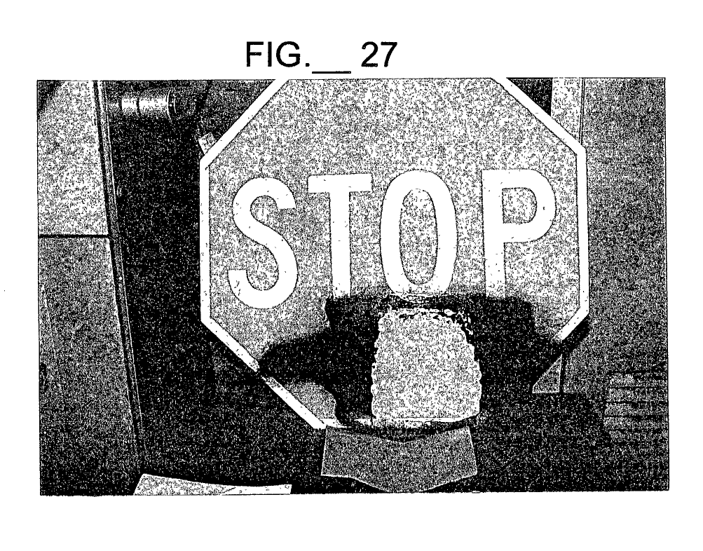

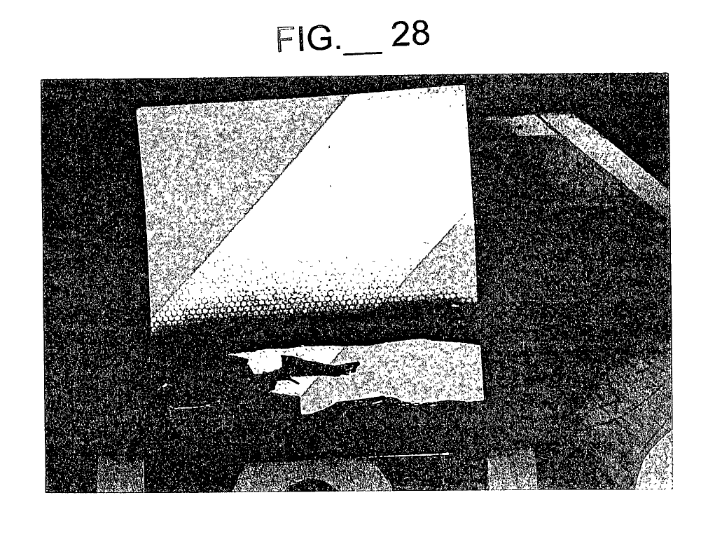

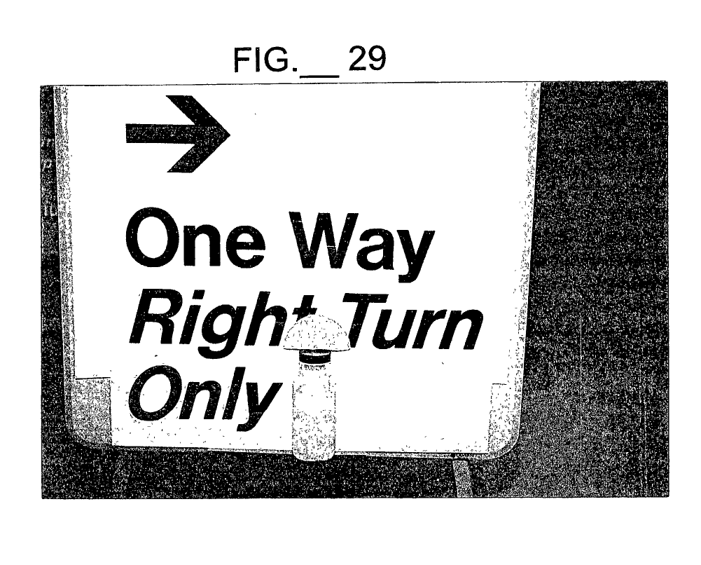

The viscosity versus shear rate rheological data presented in FIG. 25 represents the results of evaluating small portions, each taken from the fluid stored in a freezer in a closed glass container. These samples were warmed slowly to room temperature (around +20° C.), also in a closed glass container, and then evaluated for shear rate dependency of viscosity using the same Laboratory Brookfield Viscometer that was used throughout the development work herein. A comparison was made of each sample's characteristic with the original data. No changes were observed throughout the test serves, which lasted for 106 days of cold storage viscosity tests (and continues). (See FIG. 25.)

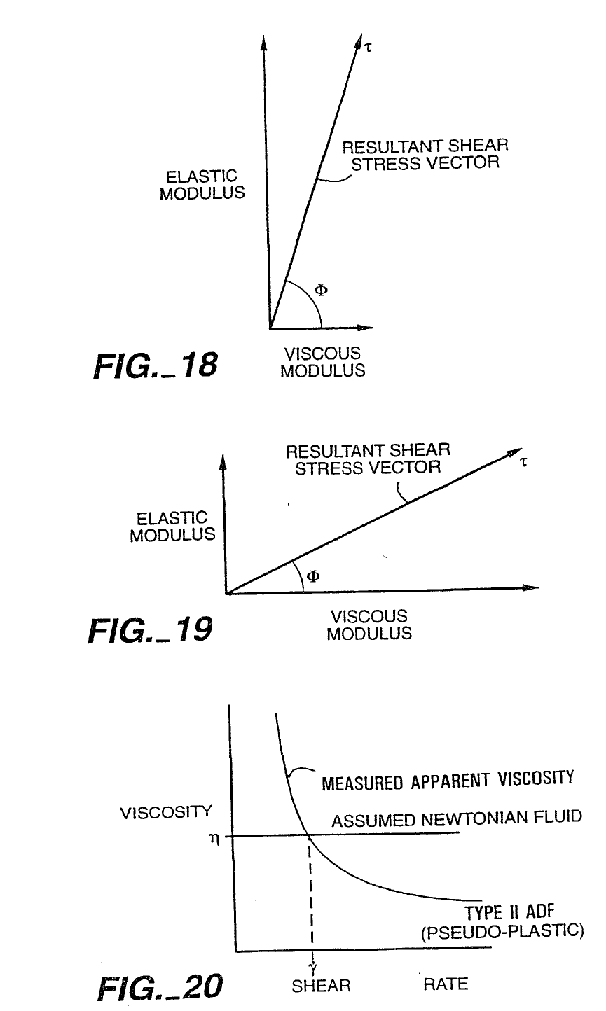

While not wanting to be bound by theory, the following explanation is presented. Viscosity moduli are generally far more temperature dependent than are elastic moduli. Thus, referring to textbook FIGS. 18 and 19, it is seen that a temperature change that would decrease (or increase) the value of the viscous modulus would have a cosine of Φ effect on the resultant (τ), and be far more dramatic on (FIG. 19) the viscous type liquid, than on (FIG. 18) the elastic type liquid, (e.g., xanthan), even though they both have the same measured viscosity. Shear stress (τ) measured at a constant shear rate \dot{γ} gives resultant viscosity η, so this is what is generally measured by a viscometer. Note: τ/\dot{γ}=viscosity. Note: Xanthan behaves as an elastic liquid when in aqueous dispersion. The lower variation of viscosity with temperature is a very valuable feature for Type II/IV (SAE 1428) thickened FPD anti-icing fluids for aircraft reasons, e.g., formulation, storage, shelf-life. Low dependence of viscosity with variation of temperature is a very desirable feature for Type II thickened FPD anti-icing fluids for the following reasons:

Safety—Holdover times and fluid release speeds are less affected by weather-related temperature fluctuations.

Consistency and Predictability—assurance that the desired characteristics hold even if the temperature changes.

Economics—a single given design viscosity can be tailored for a specific use, rather than needing a set of solutions for various encountered temperatures

Hydrophobic Thin Layer—A hydrophobic very thin layer surface, described herein as essentially a monolayer, is formed on the exterior surface (or surfaces) of the fluid composition applied to the structure to be given ice protection, by the incorporation of component (e), the primary unbranched aliphatic alcohol, such as 1-dodecanol. Presumably, the hydrophilicity of the hydroxyl end align that end of the molecule towards the aqueous FPD, while the opposite end of the hydrocarbon chain is repulsed to form a hydrophobic layer.

The 1-dodecanol, as an additional component to the FPD fluid, imparts two very desirable properties. First, it produces a hydrophobic out layer to enhance the ability of the applied ice protection fluid to resist ambient moisture incursion. This feature produces an extended holdover time for aircraft and added weather resistance and durability for other uses. The hydrophobic layer presumably is achieved by the 1-dodecanol's having a polar hydroxyl end group with a strong hydrophilic affinity to the aqueous fluid surface, while the aliphatic chain portion is repelled. This type of structure causes a close-knit parallel alignment of the linear molecules to create a paraffin-like facade or exterior layer that limits moisture attraction and incursion.

1-Dodecanol, while not very soluble in water at room temperature, is readily soluble (to extents suitable for the purposes of this invention) in at least the following: propylene glycol; blends of propylene glycol and water; blends of propylene glycol, xanthan (and other polysaccharide gum thickeners) and water; blends of propylene glycol, xanthan gum, isopropyl alcohol (2-propanol) and water. Incorporation of 1-dodecanol to all the various ice protection compositions of this invention indeed has been shown to impart a hydrophobic outer layer which then is better able to resist drizzle or rain droplet incursions. Both clear water and also water dyed to enhance observability when applied topically in the form of droplets remain beaded without dissolving into the bulk of the coating.

Second, as an unexpected discovery, (in the embodiment compositions of this invention that contain small (or no) amounts of 2-propanol), 1-dodecnol apparently forms a hydrogen-bonded complex of the hydrated xanthan thickener. This property permits the FPD fluid to be foamed to a creamy homogenized fine consistency during application, creating a highly stable and mechanically firm, better clinging (especially to inclined or complex surfaces), durable and a long-lived expanded layer of FPD fluid. This foaming of the 1-dodecanol compositions is readily achieved by conventional mechanical agitation with aeration. The foam is capable of being pumped for conventional nozzle spray application with no loss of rheological of FPD properties. Alternatively, foaming occurs at the nozzle, which is modifies for this purpose. Surprisingly, while the foamed versions of the fluid display significantly higher static viscosity than the same fluid has prior to foaming, the viscosity versus shear rate dependency was found to be identical to that of fluids of FIGS. 11 and 12. This result serves to indicate that the shear thinning behavior appears to have remained unaffected by the foaming action. Resistance to “rain” of the foamed fluids appears to be significantly improved, with the water droplets observed to be beading on the hydrophobic surface. While not wanting to be bound by theory, this beneficial feature may be accounted for as follows: At each interface in between the liquid phase and the gas phase of the tine bubbles in the foam, there is presumed to exist the said monolayers of 1-dodecanol, this large multiplicity of monolayers thus magnifies the hydrophobic affect seen as an ever greater resistance to liquid water incursion (dilution).

Initial observations indicate that many typically used organic surfactants and also boric acid (used to form gels with many polysaccharides), unlike 1-dodecanol, were incapable of producing a suitable foam. It was further observed during the research leading to this invention, that the presence of an optional FPD component, 1-propanol, in any useful amount, effectively inhibited the 1-dodecanol foaming effect. This unanticipated discovery is deemed highly advantageous for the isopropanol-type compositions intended for use as windshield ice protection. The presence of the long chain alcohol is able to provide the desired hydrophobicity to extend the fluid's protective capability, without the possibility of wiper blade motion induced foaming, which obstructs driver vision.

The apparatus to apply the liquid composition to the surfaces of objects for anti-icing/deicing purposes is conventional in the art or can be adapted from existing equipment. For example, for application of the fluid to aircraft, U.S. Pat. No. 5,104,068 describes the known art and also teaches its advance.

Preferred Embodiments—Preferable, the amount of water in the composition according to the present invention is in between about 40.0 and 86.0 weight percent of the sum of weights of water and FPD(s), more preferable in between about 40.0 and 80.0 weight percent, and especially in between about 40.0 and 50.0 weight percent.

Preferably, the freezing point depressant (FPD) is present in the composition in between about 14.0 and 60.0 weight percent of the water and FPD combined weight, more preferably in between about 20.0 and 60.0 weight percent, and especially in between about 50.0 and 60.0 weight percent.

Preferably, the thickener is a food grade xanthan, which is present in the composition in between about 0.01 and 10.0 weight percent, more preferably in between about 0.10 and 5.0 weight percent and especially in between about 0.25 and 10.0 weight percent of the total composition.

Preferably, the optional monohydric alcohol is a C₈ to C₁₈ straight chain aliphatic, primary alcohol, more preferably a C₈ to C₁₆ straight chain primary aliphatic alcohol, especially at C₁₀ to C₁₄ straight chain unbranched primary aliphatic alcohol, and specifically 1-dodecanol. Preferably, the monohydric alcohol is present in between about trace amounts, sufficient to form a thin layer on the exterior surface of the applied compositions, e.g., in between about 0.01 and 5.0 weight percent, more preferably in between about 0.10 and 5.0 weight prevent and especially about 0.75 weight percent.

In a preferred composition for use on aircraft, water is present in the composition in between about 40.0 and 70.0 weight percent of the sum of the water and FPD weights, more preferably in between about 35.0 and 55.0 weight percent, and especially in between about 40.0 and 44.5 weight percent.

The freezing point depressant for aircraft applications is present in between about 40.0 and 60.0 weight percent of the combined FPD and water weight, more preferably in between about 45.0 and 60.0 weight percent, and especially in between about 50.0 and 60.0 weight percent.

The thickener as a heteropolysaccharide is preferably a food grade xanthan which is preferably present in between about 0.2 and 1.0 weight percent, more preferably in between about 0.25 and 0.75 weight percent and especially in between about 0.45 and 0.55 weight percent of the total composition. Optionally, in this composition for all uses, particularly aircraft applications, there is included a monohydric alcohol 1-dodecanol, which is preferable present in between about 0.10 and 5.0 weight percent, more preferably in between about 0.01 and 3.0 weight percent and especially in between about 0.01 and 0.75 weight percent of the total composition. In preferred compositions for use specifically on airport runways and taxiways, (where the fluid would be similar and totally compatible with the compositions of this invention intended for aircraft Type II/IV usage and that would be expected to flow off the aircraft), airport roadways; and also intended for the more ubiquitous applications for ice protecting streets, roads, bridges, sidewalks, entrances and the like, the freezing point depressant (FPD) is 1,2 propylene glycol (PG). This FPD is present in concentrations in between about 45.0 and 65.0 weight percent of the combined FPD and water weight, and more preferable in between about 50.0 and 60.0 weight percent. For these applications, the compositions of the preferred embodiment comprises as the preferred thickener, a heteropolysaccharides (food grade xanthan which is present in concentrations in between about 0.20 and 0.40 weight percent of the total composition. In these embodiment compositions, when loss of contact friction with the surface (e.g., tire to pavement) is deemed detrimental, glycerin and comparable “slippery” FPD's are not present (i.e. proscribed).

In addition to providing the traffic surfaces with non-corrosive, environmentally benign icing protection, the applied fluid composition of this preferred embodiment must not cause an unacceptable loss of coefficient of friction in between the vehicle tires and the paving. In order to evaluate the suitability of the preferred compositions for this intended application, two representative compositions (samples QA and QB) were blended, comprising the following compositions:

| | | | | | Green |
|---|---|---|---|---|---|
| | | | | | Food |
| | PG wt % | H₂O | Xanthan* | 1-Dodecanol* | Coloring |
| Sample QA | 55.0 | 45.0 | 0.31 | 0.30 | ** |
| Sample QB | 55.0 | 45.0 | 0.20 | 0.30 | ** |

Xanthan is KELTROL-T ®.
*Percent is per hundred ratio; percent of combined FPD and water.
**Shilling green sufficient to make fluid pale green.

Large samples, two 55 gal. drums of each composition, were commercially prepared and shipped to the Department of Aviation, Airfield Operations, AMC, O'Hare International Airport, Chicago, Ill. for field tests, and for submittal to Michigan Technological University, Houghton Mich., for laboratory testing. A brief summary of this test work is presented here, as an edited/abridged version of the O'Hare summary:

### Summary

### of Tests for Runway Use

Chicago Department of Aviation (DOA) had expressed an interest in the environmentally friendly anti-icing/deicing fluids of this invention, invented by Len Haslim, because of its favorable properties. With private funding, samples of the formulations of the fluid, (four 55 gal. drums, of two thickened concentrations. 0.31 and 0.20% phr) were batch blended for the inventor by Delta Rocky Mountain Petroleum, Inc. of Henderson, Colo., and provided to Chicago DOA. These samples have been tested in accordance with DOA's laboratory testing protocols.¹ ¹Laboratory Performance Evaluation of Runway Deicing Fluids for Rust Environment and Infrastructure, Chicago, Ill. 60606

The material was tested both for performance, at the Keweenaw Research Center of Michigan Technological University, Houghton, Mich., and environmental impact at the Food Products Laboratory in Portland, Oreg. (a USDA and EPA approved lab). The university of Pennsylvania had previously tested the fluid (see below) for DOB and other sensitive environmental tests such as COD, TOC, and SOUR. Rather than repeat the tests, these results were submitted to Chicago O'Hare's assistant airport manager in the belief that these were representative and would satisfy DOA testing protocols. The material was tested against the current PGU² deicing fluid in use at DOA.

The test results validate the claims made for the fluid. Namely that:

The fluid exhibits high friction coefficients better than or equal to the PGU control sample.

The fluid shows only trace specific conductivity versus the PGU, demonstrating the lack of corrosive tendencies, nor tendency to short out electrical circuits.

Nitrogen is negligible compared with PGU and BOD levels will be similar, since both materials are based on Propylene Glycol (BOD was not tested against a PGU sample but against a variety of other fluids. However, due to all components in the ice protection fluid of this invention being food grade materials, other tests performed show the fluid more environmentally benign.

Ice Melting, Penetration and Undercutting demonstrate the superior anti-icing nature of the fluid.

Corrosion Tests at Michigan Tech were completed. Results show no corrosion of galvanized metal or bare steel.

RECOMMENDATIONS by Chicago DOA

Based on the test results to date, the fluid looks to be a good candidate for use by DOA. In order to fully evaluate the fluid's unique characteristics, it is recommended that DOA move forward to a field trial based on the formulation A (0.20% phr thickener) of this invention.

### Friction Testing, Environmentally Friendly Anti-Icing Fluid

Quote (Keweenaw Research Center, Michigan Technological University):
Friction Testing - Lab
²PGU is 50% Propylene Glycol, 45% Urea, and 5% water

Friction tests separately on simulated concrete coupons and asphalt coupons shall be performed in the cold lab. This testing shall consist of measuring dynamic friction coefficients for each chemical at two specified temperatures as follows: 5 and 25° F. Measurements shall be made on the substrate coupons using a rubber friction block immediately after application of chemicals. The same scenario shall be conducted for dry pavement and water wetted pavement samples (ice coated). The friction blocks are pulled over the test coupons and the frictional force is measured on a load cell and recorded by data acquisition system.

The following budget breakdown covers the cost for testing one (1) chemical plus testing a comparison chemical—Laboratory Friction:

| | |
|---|---|
| Total Cost 1^{st} Chemical | $1600 |
| Cost per additional Chemical | $800 |

Specification:

The Friction Tests shall be performed using an apparatus designed to measure kinetic friction of a rubber block over a substrate (pavement) sample. The substrates shall be typical of taxiway/runway pavement, and comprised of asphalt for one series of tests, and of concrete for the other series of tests. The size of the block is approximately 4″ by 4″ in plan and designed to give results for friction comparable to those given by a SAAB friction tester. Friction shall be measured both on Portland cement concrete and on asphalt cement substrate samples with a 5 pound weight on each substrate.

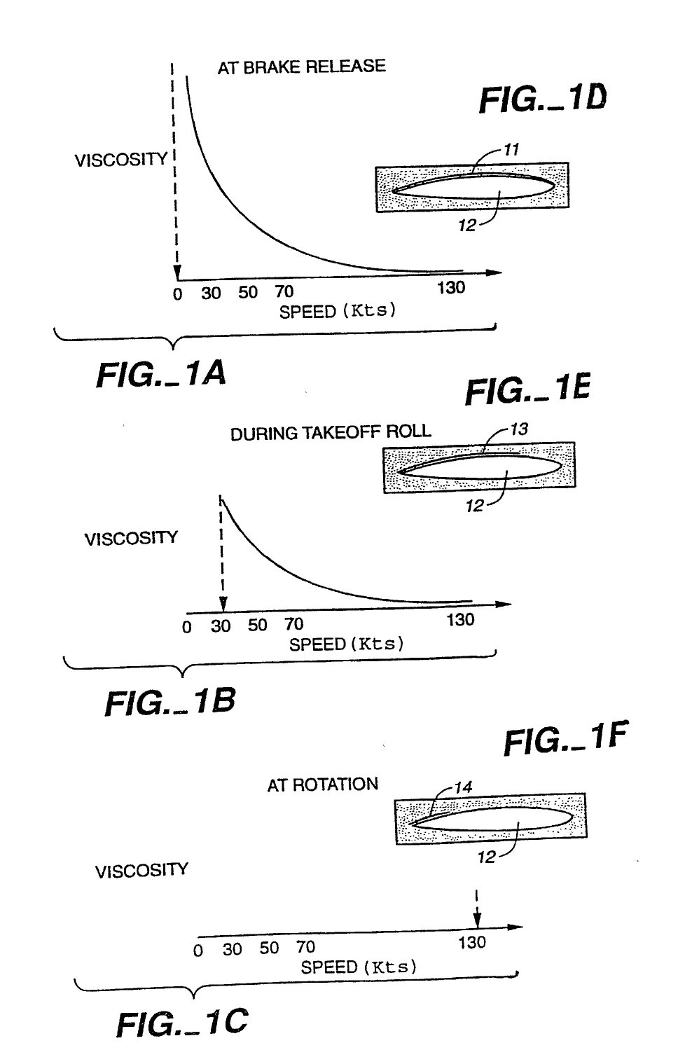

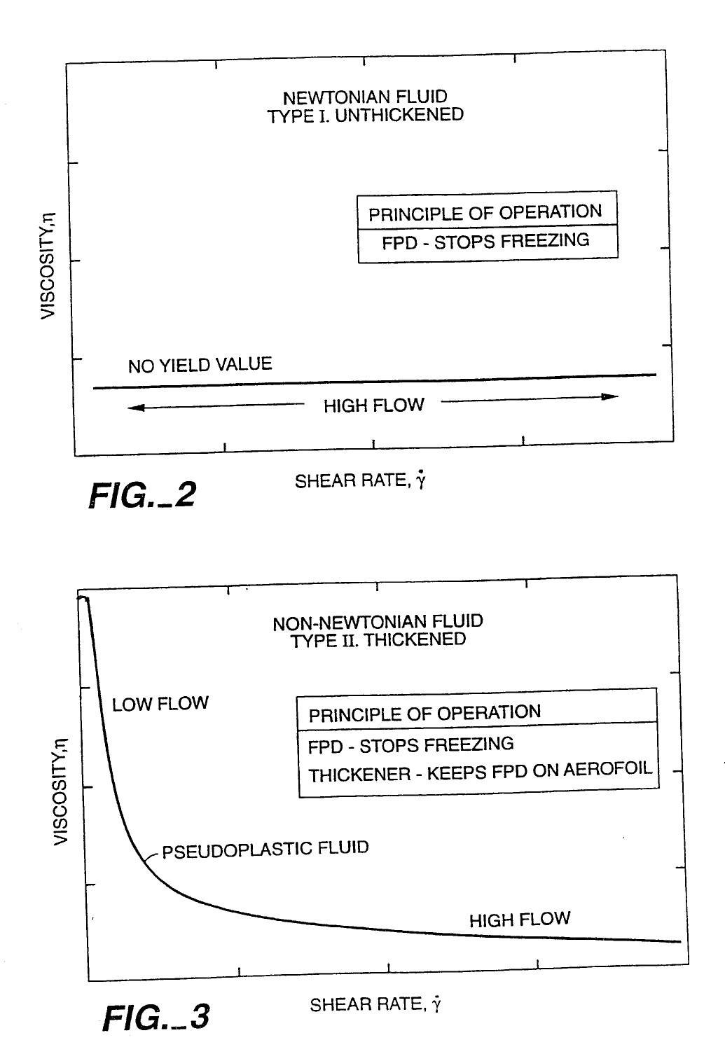

FIG. 1 is a photo of the test setup. For purposes of obtaining coefficients of friction, the measurement is made by pulling the rubber block over a pavement sample at a constant speed and measuring the load and displacement as the test progresses. From these measurements, an average force to move the block can be obtained and the dynamic coefficient of friction calculated. For each test, the friction of the block is measured prior to application of chemical as a baseline and the dry coefficient of friction reported. After this measurement, each test fluid shall be applied uniformly over the surface of a pavement sample to simulate application rates of 0, 1, 6, 12, 24, and 48 gallons per 1000 square feet: (which is comparable in the test apparatus to 0, 1, 10, 20, 40, and 80 ml., respectively) and shall be reported both as the resultant coefficient of friction, and percent change from the initial “dry” data. For purposes of comparison, 12 gallons per 1000 sq.ft. is just enough chemical to slightly wet the surface of the pavement and 48 is a thick film. After each application of chemical, the friction is measured and an indication of “slipperiness” caused by the chemical film is obtained.

The Michigan Tech. Laboratory work performed on the fluid samples sent to them by O'Hare verified the fluid's ice protection efficacy. The laboratory also conducted friction tests in accordance with their test procedure, included here and appended to the O'Hare summary. Their testing showed that the fluid compositions of the invention's preferred embodiment (see results in tabulation and bar graphs below) caused the least decrease in coefficient of friction of all the fluids (including plain water) tested. This latter phenomenon may possibly be attributable to the excessive shear thinning of viscosity the tire contact induces upon the fluid, favoring intimate tire-to-surface contact.

FRICTION TESTS: COEFFICIENTS OF FRICTION
Performed At 5 Degrees F.

| Gallons per | | | | | | | | |
|---|---|---|---|---|---|---|---|---|
| 1000 sq. ft. | QA | % Change | PG/U | % Change | Water | % Change | 30W Oil | % Change |
| 0 | 0.8543 | | 0.8043 | | 0.8541 | | 0.8110 | |
| 1 | 0.7359 | −13.86 | 0.8071 | 40.35 | 0.4971 | −41.80 | 0.4210 | −50.71 |
| 6 | 0.7061 | −17.74 | 0.7090 | −11.85 | 0.4964 | −41.88 | 0.1916 | −77.57 |
| 12¹ | 0.6308 | −26.16 | 0.7324 | −8.94 | 0.46.96 | −45.02 | 0.1767 | −78.21 |
| 24 | 0.7595 | −11.10 | 0.6347 | −21.09 | 0.2530 | −70.38 | 0.1765 | −78.24 |
| 40² | 0.8007 | −6.27 | 0.6671 | −17.06 | 0.1994 | −76.65 | 0.1746 | −78.47 |
| 48³ | 0.8210 | −3.90 | 0.6830 | −15.08 | 0.1730 | −79.74 | 0.1737 | −78.58 |

¹(very light) ²(40-moderate, values interpolated) ³(heavy)

[image] FRICTION TESTS: COEFFICIENTS OF FRICTION
Performed At 25 Degrees F.

| Gallons per | | | | | | |
|---|---|---|---|---|---|---|
| 1000 sq. ft. | QA | % Change | PG/U | % Change | Water | % Change |
| 0 | 0.85 | | 0.95 | | 0.93 | |
| 1 | 0.93 | +9.4 | 0.87 | −8.4 | 0.48 | −48.4 |
| 6 | 0.88 | +3.5 | 0.77 | −18.9 | 0.47 | −49.5 |
| 12¹ | 0.75 | −11.76 | 0.73 | −23.2 | 0.35 | −62.4 |
| 24 | 0.75 | −11.76 | 0.69 | −27.4 | 0.25 | −73.1 |
| 40² | 0.79 | −7.06 | 0.66 | −30.2 | 0.23 | −75.3 |
| 48³ | 0.81 | −4.7 | 0.65 | −31.6 | 0.22 | −76.3 |

¹(very light) ²(40-moderate, values interpolated) ³(heavy)

[image] FRICTION TESTS: COEFFICIENTS OF FRICTION
Performed At 70 Degrees F.

| Gallons per | | % | | % | | |
|---|---|---|---|---|---|---|
| 1000 sq. ft. | QA | Change | PG/U | Change | Water | % Change |
| 0 | 0.8800 | | 0.8800 | | 0.8800 | |
| 1 | 0.8697 | −1.17 | 0.7359 | −16.38 | 0.8551 | −2.83 |
| 6 | 0.7397 | −15.94 | 0.7081 | −19.53 | 0.7659 | −12.97 |
| 12¹ | 0.6972 | −20.77 | 0.7209 | −18.08 | 0.7653 | −13.03 |
| 24 | 0.6627 | −24.69 | 0.7849 | −10.81 | 0.7468 | −15.14 |
| 40² | 0.7484 | −14.95 | 0.7902 | −10.20 | 0.7416 | −15.72 |
| 48³ | 0.7906 | −10.16 | 0.7928 | −9.91 | 0.7391 | −16.01 |

¹(very light) ²(40-moderate, values interpolated) ³(heavy)

[image]

In the embodiment compositions of the present invention, polymers of acrylates, acrylic acid, methacrylates or methacrylic acid are not present.

Isopropanol Additive—The combination of isopropanol as a major portion of the FPD blend with propylene glycol (PG) imparts certain beneficial characteristics. For example: in compositions of 45 wt % isopropanol (IPA) and 10 wt % propylene glycol (PG) and suitable thickened with xanthan, almost identical ice protection and rheological properties (compared to using only PG as the FPD, components using only PG as the FPD, i.e. using 55 wt % PG), are obtained. After application to the surface, the IPA/PG blend has a far less environmental impact on the airport environment. This is because of the IPA higher vapor pressure. This alcohol evaporates into the atmosphere where it is decomposed by ultra violet/air oxidation to carbon dioxide and water. Thus, the PG residue locally is reduced to less than one fifth initially, compared to an all glycol FPD fluid. Further, the IPA acts as an extender and a uniform distributor of the PG mix.

Improved Friction—Additionally, for roadways, walkways, bridges, etc. and certain portions of airport paving where improved friction would be deemed beneficial, applications of the composition includes added solids. The friction enhancing solids comprise sand sized (i.e. less than 2.5 mm in diameter) small grit, preferably biodegradable non-toxic or minimally toxic and non-soluble. A freezing point depressant (FPD) fluid composition, thickened as described herein, further includes friction enhancing agents(s) that are co-applied or sequentially applied to the surface where it is desired to provide both anti-ice/deicing protection and increased friction/traction. Such friction enhancing agent(s) are comprised of suitably dine pulverized solid(s) having the following desirable features: (a) the pulverized solid particles are essentially sharp cornered or edged, (b) are not soluble nor significantly softened by the FPD fluid mixture, (c) preferable biodegradable and non-toxic, and (d) non-corrosive in the FPD fluid mixture. Examples of these solids include, but are not limited to, pulverized organic nut shells, husks, kernels, seeds, bark, and wood fragments, and certain synthetic polymers, and for selected situations, sand. It should be noted that deliberate ingestion of certain nut shell fragments below a particular size is universally used by maintenance facilities to remove incrusted coke and deemed beneficial to jet aircraft engines.

### “Smart Fluids” for Use as Anti-Icing Fluids or Deicing Fluids

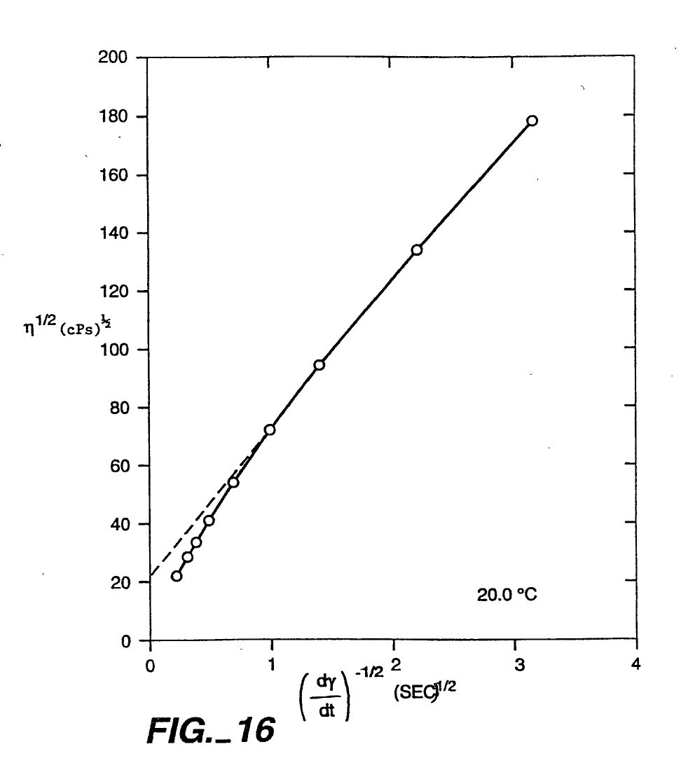

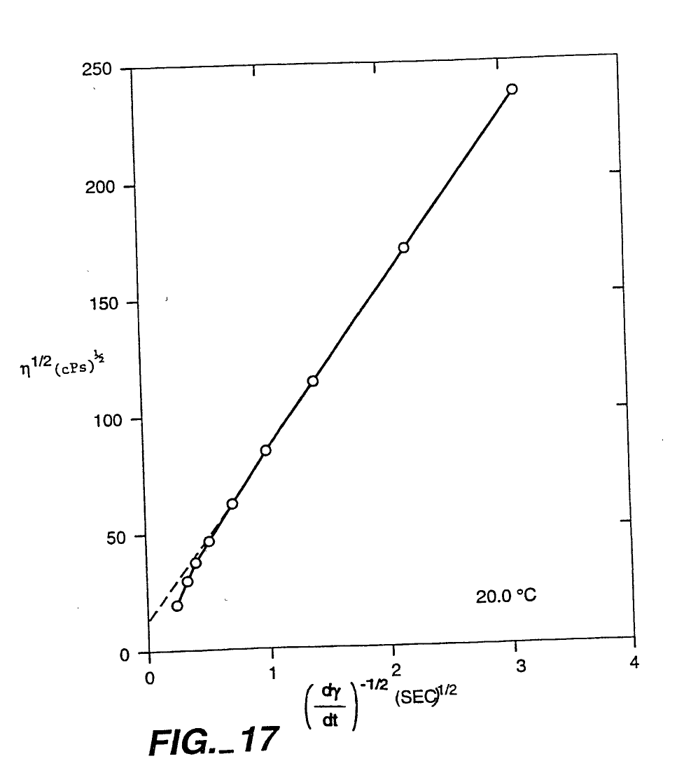

A “one-fits-all” Type II/IV (SAE 1428) deicing fluid has some drawbacks. Each size and type of aircraft has a characteristic rotational airspeed that itself is dependent on many in internal and external factors, not the lease of which include density altitude and loading factors. There exists a safety-motivated need for the deicing or anti-icing equipment operators on the takeoff airfield to be able to tailor the Type II/IV fluid in-situ to best fit the requirements of the specific aircraft at that specific application time and place. This tailored result is referred to herein as a “smart fluid”. With the teachings of the present invention, such a capability now becomes a practical reality. Xanthan thickened FPD fluids exhibit useful and desirable pseudoplastic flow (with little or no thixotropic time-dependent plasticity). Further, as shown in FIGS. 3, 4 and 5, the fluids have a yield value. That initial value of finite shear stress (also known as yield stress) resistance, which must be exceeded to initiate fluid flow, is determined for a given set of conditions such as fluid temperature and thickener concentration. The smart fluid is described herein with reference to FIGS. 16 and 17.

FIG. 16 graphically presents a plot of the square root of apparent viscosity (η) against the reciprocals of the square root of shear rate:

η^{½=η}_{∞}^{½}+τₒ^{½}\dot{γ}^{-½}

η=viscosity (cPs)

γ=shear rate (sec⁻¹)=d\dot{γ}/dt

τₒ=yield point (dyne/cm²)

τₒ=slope

η_{∞}=infinite shear rate viscosity, intercept with ordinate.

FIG. 16 describes and isopropyl alcohol-propylene glycol embodiment of this invention at 20° C.:

52.1 wt % isopropanol

5.2 wt % propylene glycol

0.4 wt % xanthan

42.3 wt % water

The following are obtained from the data of FIG. 16:

τₒ=25.5 dyne/cm²

η=404 cPs

FIG. 17 is a graph similar to FIG. 16, but using data characteristic of a different composition of this invention, as shown:

55.0 wt % propylene glycol

0.5 wt % xanthan

44.5 wt % water

The equation defining the relationships described above for FIG. 16 applies here as well. Thus:

τₒ=51.6 dyne/cm²

η_{∞}=169 cPs

The desired characteristics for a FPD fluid to function as a suitable Type II/IV ice protection fluid, include how its viscous and structural integrity properties are optimized to assure that, statically, an effective ice protective blanket covers a surface, e.g., an aircraft's critical flight surfaces. The structural (i.e. viscosity) integrity to this layer rapidly disintegrates to a low viscosity, easy flowing fluid under the aerodynamic airflow shear just prior to the aircraft attaining its liftoff airspeed. The fluid readily flows off the critical exterior surfaces, carrying away any ice that had accreted superficially, so that the aircraft then is essentially clean aerodynamically at or immediately before liftoff.

FIG. 20 shows a graphic representation of the rheological behavior of Newtonian fluid and a typical pseudoplastic Type II/IV anti-icing or deicing fluid (ADF). As indicated in textbook derived FIG. 20, the calculation of viscosity from viscometer readings assumes that the fluid has Newtonian flow and its viscosity is constant for all shear rates. That is what is meant by the “apparent viscosity” of a non-Newtonian fluid: it is the viscosity which would support the measured shear stress at a specific applied shear strain rate if the fluid has Newtonian flow properties. Of course, for non-Newtonian fluids the apparent viscosity is different for every different shear rate. Thus, to gain an accurate picture of the state of a non-Newtonian fluid, viscosities must be measured at several shear rates.

In the present invention, a composition is formed in-situ whose initial unsheared “static” viscosity corresponds to a pre-specified or required yield value, i.e. the yield value obtained for the composition by the incorporation of a given amount of xanthan, predetermined by a plot of the square root of viscosity versus shear rate (for the intended temperature) to obtain the provided slope. The slope squared provides the yield point, which then is correlated to the equivalent aerodynamic shear speed, representing the value where the applied fluid is essentially all shed due to shear thinning.

For pseudoplastic rheological behavior, a relationship exists in between apparent viscosity η, the limiting (lowest) high shear viscosity η_{∞}, the shear rate, and the yield point for xanthan thickened FPD fluid, τ. Using these notations, then, the following equation is obtained:

η^{½-η}_{∞}^{½}=(τₒ/\dot{γ})^{½} or (in familiar form of analytical geometry, y=mx+b;

η^{½}=τₒ^{½}\dot{γ}^{-½}+η_{∞}\dot{γ}^{½}, and the above equation suggests that plotting the square root of viscosity) the dependent variable) against the reciprocal of the square root of shear rate. Plotting of the data produces a graph having a straight line whose slope is the constant (for a given temperature and thickener concentration) τₒ^{½}, the square root of the yield point. The intercept with the ordinate corresponds to η_{∞}^{½}, At high shear rates, there is a tendency to diverge from the straight line, and extrapolation to intercept is required to derive the limiting or infinite shear rate viscosity, η_{∞}. FIGS. 16 and 17 show this type of plot at 20° C. for two different compositions of FPD thickened with different xanthan concentrations, which produce different viscosity responses to shear rate, and consequently individual slopes, τₒ^{½}. An example is given here that may be of particular interest for purposes of aircraft protection, note the η_{∞} and τ^{o} values (FIG. 17) for a FPD concentration of approximately 55 wt %, and xanthan thickener of 0.5 wt %. Even at 20° C., the low shear rate (nearly static) viscosity as shown in FIG. 13 is very high at 56,500 cPs and rapidly dropping to about 400 cPs at 20.5 reciprocal seconds, already close to limiting high shear viscosity, η_{∞}, of 169 cPs in FIG. 17. From FIG. 17, one is able to determine from the slope (τₒ^{½}) the yield stress value of 51.6 dyne/cm² (0.108 lbs/ft²⁾. In order now to correlate this yield strength (stress) to an airspeed, some simple but technically acceptable assumptions are made, to simplify the calculations:

Dynamic Pressure q=ρU²

Where ρ=0.002378 lb sec²/ft⁴

Drag D=0.5 ρU² C_{D}S=qC_{D}S

Wherein S is surface area,

U is the free stream air (wind) velocity,

ρ is density of the ambient air

C_{D} is the aerodynamic drag coefficient,

q is dynamic pressure.

Also assume, to simplify the calculations, that:

(1) Reynolds Rₑ=−0.5×10 (100 Kts)

(2) C_{D} flat plate tangential drag coefficient in between 0.01 and 0.007 (taken from aerodynamic tables)

(3) Viscosity profile at −20° C. gives a calculated yield stress of 71.8 dyne/cm² (0.1150) lbs/ft²)

Performing the math calculations produces the data for the following tabulations for the selected 55 wt % FPD with 0.5 wt % xanthan thickener:

| | | |
|---|---|---|
| 20° C. | | Yield stress equivalent airspeed |
| | C_{D} = 0.01 | 56.5 Knots (kts) |
| | C_{D} = 0.007 | 67.7 Knots (kts) |
| −20° C. | | Yield stress equivalent airspeed |
| | C_{D} = 0.01 | 66.6 Knots (kts) |
| | C_{D} = 0.007 | 79.5 Knots (kts) |

With knowledge of the viscosity dependence on temperature and as a function of xanthan concentration, the applications operator may use various thickener blending ratios (for a given temperature) in-situ with suitable blending nozzle apparatus to effect a new technique producing “smart fluid” icing protection tailored for each aircraft treated.

This suggests the possibility to select the components and produce an anti-icing freezing point depressant fluid composition having rheological properties which are specifically tailored to meet the specific aerodynamic requirements of the surface to be anti-iced. This process includes, but is not limited to selecting and producing an anti-icing composition whose rheological properties are specifically tailored to meet the aerodynamic requirements for the surface to be anti-iced, either that the freezing point depressant fluid composition be all removed, i.e. shed, peeled off; or that the fluid must be able to withstand without shedding, for cases such as nautical power lines, bridges, etc. Since xanthan's overall concentration affects on the fluid viscosity far exceeds the contribution of any other component, the composition determination for aerodynamic tailoring reduces to finding the xanthan concentration by:

(a) selecting the surface to be given icing protection;

(b) utilizing the design conditions of air velocity and ambient temperature, determine the drag affect experimentally, or from the following equation:

D/S=1/2pC_{D}U²

wherein:

D is the drag for unit area S,

D/S is the drag affect,

P is the density altitude of air,

C_{D} is the aerodynamic drag coefficient, and

U is the air velocity;

(c) correlating the yield stress, τₒ, to the drag affect, using the equation:

τₒ=D/S;

(d) having obtained from step © the τₒ value of yield strength (or stress), determine the near static viscosity )ηₒ), utilizing the date typical of the presented in FIG. 17, where the slope of that line is the square root of τₒ:

ηₒ^{½}=η_{∞}^{½}+τₒ^{½}\dot{γ}^{-½},

wherein:

\dot{γ} is the shear rate (sec⁻¹), dγ/dt,

η is any viscosity (cPs) from ηₒ to η_{∞},

ηₒ is near static viscosity, essentially zero shear rate,

η_{∞} is the limiting or infinite shear rate viscosity, and

τₒ is the yield strength or stress (dyne/cm²),

noting that η_{∞}, the limiting viscosity at infinite shear rate, is a very low value of about cPs=200 to 300 as compared to the 50,000 cPs or higher values for ηₒ, the near static viscosity, equating the η_{∞}^{½} term to zero and omitting it from the equation, and maintaining acceptable accuracy;

(d) squaring the remainder of the equation from (d) to obtain;

η=τₒ\dot{γ}⁻¹, and ηₒ=τₒ\dot{γ}⁻¹ₒ,

as a reasonable approximation, wherein \dot{γ} (the shear rate) used to measure the near static low shear rate viscosity is approximately 0.106 sec⁻¹, a constant, which allows the direct determination of ηₒ that correlates to τₒ;

(f) utilizing the data typical of that presented in FIG. 14, to determine the concentration (wt %) of xanthan.in solution needed to provide the desired viscosity (ηₒ);

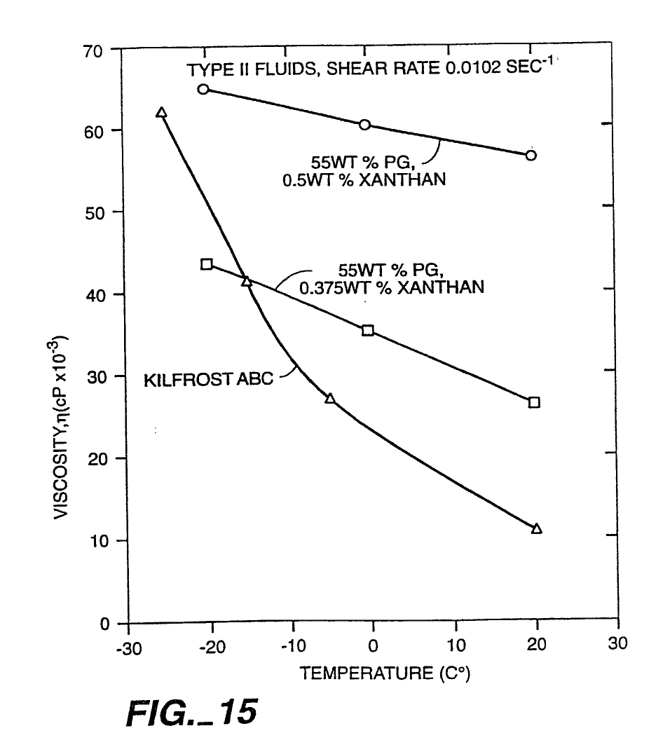

(g) adjusting the result of step (f) for any temperature corrections necessary by utilizing data from FIG. 15; and

(h) obtaining the anti-icing composition tailored to the specific application.

Thus, the composition determination for aerodynamic tailoring (e.g., smart fluid) reduces essentially to the determination of the appropriate thickener (e.g., xanthan) concentration.

One example of blending consists of mixing in-situ during aircraft application proper ratios of the same FPD concentrations but with differing thickener concentrations in order that the desired final viscosity is achieved.

While these discussions above concerning the technique taught relating to the so-called “smart fluid” used a particular fluid composition as an example, it is intended that this invention includes and applies equally to foamed versions of the FPPD embodiment compositions of this invention, especially considering their unusual long-term durability.

It is suggested above that various physical treatments of the FPD compositions of the embodiment of this invention result in enhanced properties. In the case of the foamed compositions, two alternative methods are present. One comprises prefoaming and then pumping to a suitable nozzle for spray application. The second alternative requires a modification of existing nozzles and/or adaptors that would froth/agitate with aeration the FPD solution during application. Nozzles designed for this “prefoamed” use are commercially available in the current state of the art. For the so-called “smart fluid” ratio blending in-situ to meet specific aircraft-rotation speeds, a simple throttling/ratioing precontrol dictated to by an appropriate computer preprogrammed is also well within today's technology.

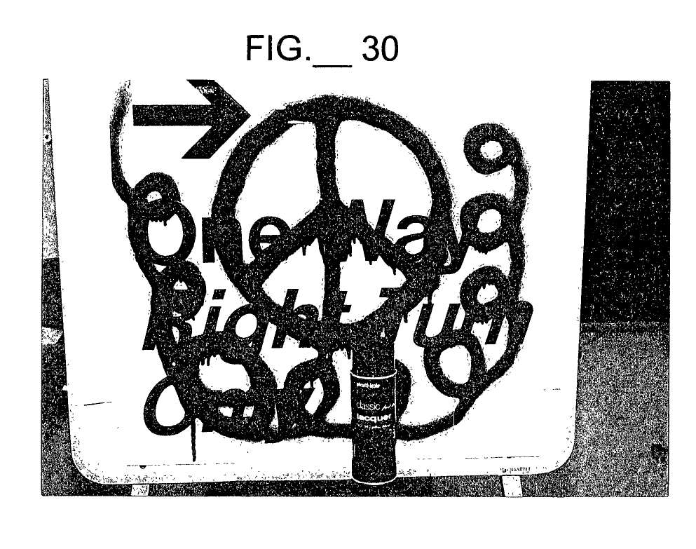

The fortuitous and unanticipated discovery that certain of the environmentally friendly ice protection fluid compositions described and claimed here and in the prior versions of applications for this patent which also incorporate glycerin for improved longevity (and where friction loss is not important) have outstanding and non-obvious anti-graffiti protection properties in addition to their inherent deice/anti-ice properties. The societal benefits imparted by these anti-graffiti properties that compliment the inherent life-saving features of the invention's icing protection fluids is deemed sufficient impetus to warrant incorporation into the specification herein these modified, additional compositions. GRAFFITI PROTECTION—A number of compositions are described herein specifically for use in anti-icing and deicing situations. Another surprising and beneficial feature of this invention is that many of these ice protections are also useful in providing a coating on a surface that also acts as an effective barrier to prevent graffiti (paints, inks, dyes, etc.) from adhering to the protected surface. Thus, in the compositions described herein, the addition of a triol to the FPD solution one uses a (e.g., isopropanol, propylene glycol, water, etc.), to produce the composition, then coats the surface of the object to be given ice or graffiti protection. Glycerin is the preferred triol for solving graffiti problems, usually present in the composition in amounts in between 10 and 45% by weight, more preferably in between about 27 and 35. This is because its hygroscopic nature counters any dry out tendency, and thus extends the useful anti-graffiti life well beyond that of glycols. The coating on the surface is essentially transparent, and is very durable. The ice protection glycerin version is very effective as an anti-graffiti coating, even as a thin residual layer. Thus, except for the most severe torrential driving rain, sufficient protection usually remains after exposure to normal rainfall to be effective in providing the desired protection. When the surface of the coated object (e.g. a sign, a concrete wall, a wooden wall, etc.) is subsequently contacted with graffiti, frequently called “tagging”, (in the form of paint, lacquer, enamel, inks, dyes, etc.). the coating protects the surface by drastically lowering the graffiti's adhesion. The tagged surface, with its underlying protective coating, is next contacted with water (hot or cold), usually under low or moderate pressure. As can be seen in the FIGS. 26-37, all of the graffiti is easily and quickly removed. A renewed application of the ice protection composition then creates a new coating barrier on the surface to protect against later applied graffiti.

The following examples are given here to further explain and described in greater detail the overall and the unique features of the compositions of this invention. They are not to be construed to be limiting of the invention in any manner.

GENERAL—All “apparent viscosity” measurements were made on a conventional Brookfield viscometer, using a SCA-31 spindle/cup set.

The xanthan is available from many commercial sources and in a variety of grades. The xanthan used in this invention was obtained from the Kelco Division of Merck, Inc. of San Diego, Calif., grade KELTROL T®. It was used directly without further purification.

The compositions of the various cited fluids of this invention, and especially of the examples given herein, are prepared in a conventional blending manner, using pre-fabricated, easily procured constituents. Although the order of addition or combination is generally not critical, following the suggested procedure in the paragraph supra (preceding the section “Brief Description of the Drawings”) makes for a more facile blending.

### EXAMPLE 1

### Isopropanol Compositions (Glass Surfaces, Automobile Windshields, Etc.)

(a) A composition was prepared containing 55.0% by weight isopropanol, 44.0% by weight water, 0.75% by weight xanthan, and 0.25% by weight 1-dodecanol. These components were combined, and applied to the windshield of an automobile. This composition formed a protective blanket to prevent subsequent ice accretion and adherence, and render ice on the glass to be soft and easily removed. The application of the composition occurs by using a mechanical “spritzer” type hand sprayer. However, other techniques include a pressurized can, or by the windshield washer system which has been suitable modified. Overnight windshield ice protection is possible by spraying prior to overnight ice or frost formation.

The fluid composition was applied in early evening to portions of the windshield of an automobile parked outdoors under freezing conditions in early March 1994. Upon returning to the automobile at 7:30 the next morning, the surfaces where the fluid composition was applied had no frost. On the other hand, all other external glass surfaces were frozen over with hoar-frost. Clearing the unprotected windshield required time and heat and/or considerable manual scraping. One revolution of the windshield wiper completely cleared the fluid from the windshield surface and the windshield was sufficiently clean and clear for immediate operation of the automobile.

(b) and (c) The compositions for FIGS. 7 and 8 were 52.1 and 45.0 wt % isopropanol; 5.2 and 10.0 wt % propylene glycol; 0.4 and 0.5 wt % xanthan; and 42.3 and 44.5 wt % water respectively. These components were combined mixed and applied to the surface to remove formed ice or to cause any ice formation to be soft and easily removed. 1-dodecanol is an optional added component included as a means of forming a monolayer and further has the advantage of being transparent and not obscuring vision. The ice was not formed at −40° C.

The shelf life of the present composition was in excess of 36 months; samples stored in sealed light-tight containers and subsequently evaluated exhibited little or no observed degradation in performance when compared to freshly prepared compositions.

(d) Similarly, when Example 1 (b) or 1 (c) are repeated except that the xanthan concentration was 5 percent by weight and the water was 40 percent by weight, similar anti-icing or deicing results were obtained; including no ice formed at −40° C.

(e) Similarly, when Example 1 (b) or 1 (c) were repeated except that the xanthan concentration is 0.01 percent by weight and the water is 40 percent by weight, similar anti-icing or deicing results were obtained; including no ice formed at −40° C.

### EXAMPLE 2

### Isopropanol Compositions (Aircraft, Runway, Roadway, etc.)

(a) and (b) The compositions containing 45.0 wt % isopropanol; 10 wt % propylene glycol; 0.1 or 5.0 wt % xanthan and the remainder being water were prepared. The amount of xanthan is dictated by the desired “static” unsheared viscosity as prescribed for the specific application. No ice formed at −40° C.

(c) Monolayer forming 1-dodecanol (1.0 wt %) to enhance durability, was added to the compositions of 2(a) or 2(b) (the remainder in water), combined and applied to the surface to provide icing protection. The ice protection results were similar to those of Example 2(a) (d) Similarly, when Example 2(a) or 2(b) are repeated with an addition of 0.1 wt % of 1-dodecanol, similar anti-icing and deicing results are obtained.

### EXAMPLE 3

### Propylene Glycol Compositions (for Aircraft)

(a) A composition containing 55.0 wt % propylene glycol, water 44.5 wt %, xanthan 0.5 wt %, based on the combined weights water, freezing point depressant, and thickener, and 1-dodecanol varying in quantity, from just a trace amount (sufficient to form an exterior thin coating, essentially a monolayer) less than about 0.1 wt %, to approximately 2 wt % of total fluid weight.

For applications to aircraft surfaces, the resultant Type II/IV layer formed for anti-ice protection ranges in thickness from about 25×10⁻³ mm to approximately 10.0 mm.

The “shelf-life” of this embodiment composition was in excess of 32 months at about 0° C. Samples stored in sealed light-tight containers and subsequently evaluated exhibited no observed degradation in anti-icing or deicing performance when compared to freshly prepared versions.

(b) Similarly, when the Example 3(a) embodiment was reconstituted, except that the 1-dodecanol concentration in the composition was increased from the trace monolayer about, to in between 0.01 wt % to 5 wt %, depending an the aircraft application, this enables the forming of a stable, firm, long lived, homogenized foam with the hydrated xanthan thickener, upon fluid application, utilizing there with mechanical agitation and aeration (a process similar to making whipped cream).

The beneficial results of foaming the Type II/IV fluids of this invention upon application also includes producing a protective “blanket” layer that is far thicker for a given amount (or weight) of fluid applied, and results in a better barrier to ice accretion, than if applied unfoamed.

### EXAMPLE 4

### Higher Thickener Concentration Propylene Glycol Composition (Nautical Application)

(a) and (b) An aqueous composition is proposed containing propylene glycol (as FPD) in an amount comprising 55.0 wt % (of the combined glycol and water weight), xanthan of 0.5 wt % to 20 wt % can be prepared. The remainder is water. The amount of xanthan is dictated by the required “static” unsheared viscosity as prescribed for those various specific nautical (shipboard) applications (such as above deck mesh crab traps, rigging, weather decks, etc.) where tenacity, resistance to wind shear and mist dilution are very desirable features. Referring to the graphic data of FIG. 14, an extrapolation of the line may be used to predict the approximate xanthan concentration necessary to obtain the desired “static” viscosity. Thus, for a given anticipated application, data from FIGS. 10, 11 and 13 predict that, while “static” viscosity is significantly increased with increase in the xanthan concentration, the dynamic viscosity drop due to shear rate increase results in about equally low values. This embodiment composition further contains 1-dodecanol varying in quantity from a trace (less than about 0.01 wt %), (sufficient to form an exterior coating, essentially a monolayer), to about 2 wt %. The remainder of the composition is water.

(c) Similarly, Example 4(a) or 4(b) composition blending is repeated, except that the 1-dodecanol concentration is increased from the trace monolayer forming amount to a concentration ranging in between 0.01 wt % to 5 wt %, depending on the intended nautical application. This increase in dodecanol content enables forming a stable, firm, clinging, homogenized foam with the hydrated (i.e. water treated) xanthan thickener, when mechanical agitation and aeration accompanies the fluid application. The result of forming the foam is an increase both in tenacity and resistance to dilution of the composition.

For compositions of Example 4(a) and 4(b), ice generally will not form down to about −40° C.

### EXAMPLE 5

### Higher Thickener Concentration Isopropanol Compositions (Nautical Spplications)

(a) A composition is proposed containing 45.0 wt % isopropanol (as one FPD), 10 wt % propylene glycol (as a second FPD) based on the combined weight of FPDs and water, and xanthan of 0.5 wt % to 20 wt % and the remainder is water. The amount of xanthan is dictated by the required “static” unsheared viscosity as prescribed for those various specific nautical applications (such as mesh crab traps stored above deck, rigging, weather decks, etc.,) where the compositions tenacity, resistance to wind shear and mist dilution are very desirable features. Referring to the graphic data of FIG. 14, an extrapolation of the line is used to predict the approximate xanthan concentration necessary to obtain the desired “static” viscosity. Thus, for a given anticipated application, data from FIGS. 10, 11 and 13 confirm that, while “static” viscosity is significantly increased with increase in the xanthan concentration, the dynamic viscosity drop due to shear rate increase results in about equally low values. The result indicates a facility in spray application.

(b) The composition of Example 5(a) which further contains 1-dodecanol of about 0.01 wt % (sufficient to form an exterior coating, essentially a monolayer, to about 2 wt %. The remainder of the composition is water. For this composition ice will not form down to about −40° C.

### EXAMPLE 6

### Higher Thickener Concentration Isopropanol Compositions (Ice Protection of Powerlines, and Components)

(a) (a) A composition is proposed containing 45.0 wt % isopropanol (as one FPD), 10 wt % propylene glycol (as a second FPD) based on the combined weight of FPDs and water, and xanthan in an amount in between 0.5 wt % to about 2.0 wt %. The remainder of the composition is water. The amount of xanthan is dictated by the required “static” unsheared viscosity as prescribed typically in Example 5 for those various specific nautical applications (such as above deck mesh crab traps, rigging, weather decks, etc.) where tenacity, resistance to wind shear and mist dilution are desirable features. Referring to the graphic data of FIG. 14, an extrapolation of the line may be used to predict the approximate xanthan concentration necessary to obtain the desire “static” viscosity. Thus, for a given anticipated application, data from FIGS. 10, 11 and 13 confirm that, while “static” viscosity is significantly increased with increase in the xanthan concentration, the dynamic viscosity drop due to shear rate increase results in about equally low values. The shear rate viscosity drop result indicates an ease of spray application.

(b) The composition of Example 6(a) which further contains 1-dodecanol in an amount in between about 0.01 wt % (sufficient to form an exterior coating, essentially a monolayer) to approximately 2 wt %.

(c) Similarly, when Example 6(b) composition blending is repeated, except that an environmentally benign coloring agent, F.D.&C. food colorings (yellow #5 and blue #1), is included as a means of tracing visually the location and extent of applied fluid coverage.

For example, Examples 6(a) and 6(c), ice generally will not form at down to about −40° C.

### EXAMPLE 7

### Higher Thickener Concentration Propylene Glycol Composition (Ice Prtection of Powerlines, and Components

(a) and (b) A composition is proposed containing 45.0 wt % isopropanol (as one FPD), 10 wt % propylene glycol (as a second FPD) based on the combined weight of FPDs and water, and xanthan in an amount in between 0.5 wt % to about 5 wt %. The remainder is water. The amount of xanthan is dictated by the required “static” unsheared viscosity as prescribed typically in Example 5 for those various specific nautical applications (such as mesh crab traps stored above deck, rigging, weather decks, etc.) where the composition's tenacity, resistance to wind shear and mist dilution are very desirable features. Referring to the experimental graphic data of FIG. 14, an extrapolation of the line may be used to predict the approximate xanthan concentration necessary to obtain the desired “static” viscosity. Thus, for a given anticipated application, data from FIGS. 10, 11 and 13 confirm that, while “static” viscosity is significantly increased with increase in the xanthan concentration, the dynamic viscosity drop due to shear rate increase results in about equally low values. The result indicates a facility in spray application. The composition further contains 1-dodecanol varying in quantity from just a trace (sufficient to form an exterior monolayer to approximately 2 wt %. The remainder of the composition is water.

(c) Similarly, when Example 7(a) or 7(b) composition blending is repeated, except that an environmentally benign coloring agent, F.D.&C. food coloring (yellow #5 and blue #1, is included (0.1 wt %) as a means of tracing visually the location and extent of applied fluid coverage.

(d) Similarly, Example 7(a) or 7(b) composition blending is repeated, except that 1-dodecanol concentration is added in an amount ranging in between 0.01 wt % to 5 wt %, depending on the application. A stable, firm, clinging homogenized foam with the hydrated (water treated) xanthan thickener is formed when fluid application is accompanied simultaneously with aeration/mechanical agitation, this foam increases both the tenacity and resistance to dilution of the composition.

(e) Similarly, when Example 7(d) composition blending is repeated, except that an environmentally benign coloring agent, F.D.& C. food colorings (yellow #5 and blue #1), is included (0.5 wt %) as a means of tracing visually the location and extent of applied fluid coverage.

For compositions of Examples 7(a) to 7(e), ice does not form at down to about −40° C.

### EXAMPLE 8

### Holdover Time and Aerodynamic Shedding Tests

An anti-icing composition was prepared according to Example 3(a):

| | |
|---|---|
| propylene glycol | 54.9 wt % |
| water | 43.7 wt % |
| Keltrol T (xanthan | 0.7 wt % |
| 1-dodecanol | 0.5 wt % |
| Schilling green (color) | 0.2 wt % |

In December 1995 and January 1996 this fluid composition was tested for holdover time and aerodynamic shedding performance according to SAE AMS 1428 specifications (1995). These tests were conducted at the University of Quebec at Chicoutimi whose facilities are the only facilities in North America certified to perform holdover time and aerodynamic shedding performance tests. The composition passed the Type II requirements for both aerodynamic shedding performance and set a record for holdover time of 113 minutes. (Type II requires 30 minutes minimum.)

During the same time period, corrosion testing with respect to SAE AMS 1428 (1995) specifications were conducted at Scientific Material International, Inc., Miami, Fla. The fluid composition conformed to specification on all tests completed thus far; sandwich corrosion, total immersion corrosion, and hydrogen embrittlement.

### EXAMPLE 9

### Holdover Time and Aerocynamic Shedding Tests

An anti-icing composition was prepared according to Example 3(a):

| | |
|---|---|
| propylene glycol | 54.9 wt % |
| water | 43.9 wt % |
| Keltrol T (xanthan) | 0.5 wt % |
| 1-dodecanol | 0.5 wt % |
| Schilling green | 0.2 wt % |

This fluid composition was tested for holdover time and aerodynamic shedding performance according to SAE AMS 1428 (1995) at the same location and under the same test conditions as in Example 8. The composition passed all of the specification requirements, and performed equally as well as, according to the reported test results, as did Example 8.

### EXAMPLE 10

### Isopropanol Compositions

These compositions are used for coating glass surfaces, automotive windshields, etc. A composition was prepared consisting of 30.0% by weight isopropanol, 25.0% by weight propylene glycol, 0.10% by weight xanthan, 0.20% by weight 1-dodecanol, and 44.7% by weight water.

In Detroit, Mich., a window of a passenger car parked outdoors overnight was treated with this composition to evaluate its use as an effective anti-icing or deicing agent. Ambient conditions during the test period consisted of approximately −4° C. and about 70% relative humidity. On the central side window of the car, one half the window was treated with approximately 0.01 to 0.1 inch uniformly continuous coating of the composition and the other half was left untreated as the control. The treatment application was accomplished using a mechanical “spritzer” type hand sprayer. The composition was applied in the evening at 7:30 pm and evaluated the next morning at 8.30 am. Approximately 0.005 to 0.01 inches of solid ice sheeting had accumulated over the untreated portion of the test window. In contrast, the treated portion of the window prevented ice accretion and adherence which rendered any remaining ice to be soft and easily removed. This composition is also useful in graffiti protection.

This procedure was repeated by simulation in the laboratory. A composition was prepared consisting of 30.0% by weight isopropanol, 15.0% by weight 1-2 propylene glycol, 10% by weight glycerin, 0.01% by weight xanthan, 0.20% by weight 1-dodecanol, and 44.7% by weight water. A car side window was similarly treated except that the concentration of xanthan and water were changed and the window was placed in a laboratory freezer at −40° C. In one application, the xanthan concentration was 0.5% by weight and the water was 39.8% by weight. In the other application, the xanthan concentration was 0.01% by weight and the water was 44.8% by weight. In still other laboratory tests, the composition consisting of 0.15% by weight xanthan, 0.20% by weight 1-dodecanol, 41.3% by weight 1-2 propylene glycol, 13.7% by weight isopropanol and 44.6% by weight water; and also the composition consisting of 0.1125% by weight xanthan, 0.15% by weight 1-dodecanol, 31.0% by weight 1-2 propylene glycol, 35.3% by weight isopropanol and 33.4375% by weight water were applied separately on the car window and tested in the laboratory freezer. These later two compositions proved particularly suitable for pump sprayer or aerosol can application use, especially for applying the anti-ice protective shield onto automotive glazings. Similar anti-icing and deicing results occurred for the above tests. Further tests yielded results showing that no ice formed on any of the treated surface to −40° C.

Other techniques for the application of the fluid compositions include a pressurized can or by a windshield washer system which has been suitably modified. Windshield protection from ice formation, overnight or longer, is possible by spraying in anticipation of ice or frost conditions.

### EXAMPLE 11

### Higher Thickener Concentrations of Glycerin

This composition could be utilized for ice protection of power lines and components, railroad switches, road and highway signs and other vertical surfaces, and microwave tower components.

A composition was prepared containing 45.0% by weight glycerin, 10.0% by weight isopropanol, 0.5 to 5% by weight xanthan, 0.1% by weight water soluble oil and the remainder is water. The amount of xanthan is dictated by the required “static” viscosity as prescribed by those various specific nautical applications (such as mesh crab traps stored above deck, rigging, weather decks, etc.) where the composition's tenacity, resistance to wind shear and mist dilution are very desirable features. Referring to the experimental graphic data of FIG. 14, and extrapolation of the line may be used to predict the approximate xanthan concentration necessary to obtain the desired “static” viscosity. Thus, for a given anticipated application, data from FIGS. 10, 11 and 13 confirm that, while “static” viscosity is significantly increased with increase in the xanthan concentration, the dynamic viscosity drop due to shear rate increase results in comparatively low values (e.g., below 2000 cPs). This result facilitates spray applications. Further, the composition contains 1-dodecanol varying in quantity from a trace, sufficient to form a monolayer of dodecanol on the exterior surface of the coating, to approximately 2% by weight. The remainder of the composition was water. This composition is also useful in graffiti protection.

Similarly, the composition blending was repeated using an environmentally benign coloring agent, F.D. & C. food coloring (yellow #5 and blue #1, 0.1% by weight), included as a means of visually tracing the location and extent of applied fluid coverage.

Similarly, composition blending was repeated adding an environmentally benign coloring agent. F.D. & C food colorings (yellow #5 and blue #1), was included at 0.5% by weight as a means of tracing visually the location and extent of applied fluid coverage. For the above compositions, ice does not form at down to about −40° C.

For the above compositions which contain glycerin, which is hygroscopic, fluid dry out did not occur after 60 days of vertical exposure to direct (diurnal) summer sun at ambient conditions.

For the above compositions, it was observed that improved lubricity was imparted by the glycerin as compared to non-glycerin containing samples. This is deemed a desirable feature, in addition to the environmentally benign icing protection, for applications such as railroad switches and monorail switches, or any conceivable place where bearing motion is enhanced by improved lubricity. However, this fluid, with its inherent reduction in coefficient of friction, should not be used where friction loss poses a safety hazard.

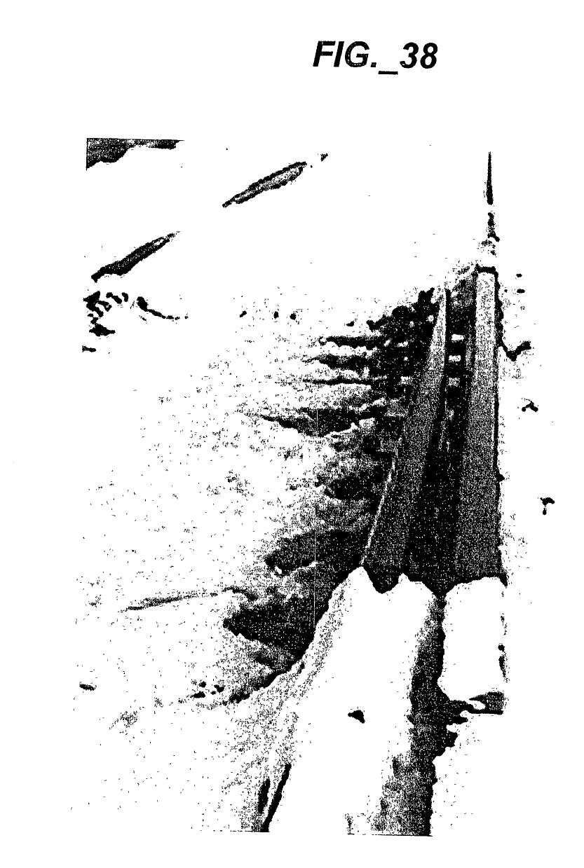

In the 2001-2002 winter, samples representative of the compositions of Example 11 were prepared and supplied for “field testing” on railroad switches to verify the fluid's efficacy in providing ice protection and insuring functionality of these vital rail components (refer to FIG. 38). Ice frozen switches are locked in position and thus “unswitchable”. Application of this environmentally friendly biodegradable fluid during wintry conditions has now proven its capability as an icing protection over a broad range of low temperatures (as low as −70° F.), and promises to make railroads safer and certainly more reliable during icing conditions.

The fluid was shown to be non-corrosive, providing lubricity where applied (to keep rails and switches smoothly operating), and does not damage the rails. It was also shown to be safe to use with electrical wiring associated with the system, because it is not conductive. The fluid demonstrated its capability to form a protective-coating (anti-ice) barrier that prevents the buildup on the switch of ice and snow. In the testing, the fluid was applied to the railway components prior to ice or snowstorms and proved effective working as an anti-icing fluid, remaining in place to melt (or block) precipitation as it hits the critical surface. Additional benefits were observed, the fluid's ability to cling to vertical portions of the rail and to resist the affects of rain and wind. The fluid composition was also shown as an effective deicer. When applied to an already frozen switch or rail, it quickly melted the ice, freeing the frozen parts and then the fluid remained in place to prevent refreezing.

The evaluation demonstrated the economic advantage use of the fluid provided: manually freeing a frozen switch can take an entire crew several hours, whereas it took typically only five minutes to free the switch by simply applying the fluid; spraying, brushing, or pouring, and typically in quantities as little as one gallon. Also, use of the fluid has an economical advantage over heaters. They are reported to have trouble functioning when temperatures are sub-zero, and they obviously have high rates of energy-consumption.

A parallel application for the fluid was also evaluated; use for anti-ice and deicing purposes applied to a third rail through a simple system easily installed onto mass transit cars and dispenses as the train runs it route.

It was demonstrated that, because of the numerous beneficial features of the invention's composition, the fluid can be left unattended for an extended length of time once it had been applied, which in itself constitutes a significant public safety and economic benefit for treating those rail components located in remote areas.

### EXAMPLE 12

### Preparation of Increased Thickener Concentrations of Glycerin and Isopropanol

These compositions are used for ice protection of power lines and components, microwave tower components, road and highway signs and other vertical surfaces where long duration ice protection and subsequent graffiti protection is desired.

A composition was prepared consisting of 27.5% by weight glycerin, 27.5% by weight isopropanol, 2.5% by weight xanthan, and the remainder water. The amount of thickener was selected-as the near ideal compromise in between that dictated by the desired “state” of unsheared viscosity to ensure the composition's protection tenacity, resistance to wind shear and mist dilution, and the desirable features for ease of application such as the dynamic viscosity drop due to shear to facilitate spray or brush/roller application. The composition further contains 1-dodecanol varying in quantity from a trace to approximately 2.0% by weight which is sufficient to form a monolayer on the exterior surface of the applied coating.

For compositions of Example 12, ice formation is inhibited from forming on surfaces to about −40° C.

For compositions of Example 12, applied to reflective roadway sign material, such as the well-known “SCOTCHLITE®”, off-angle reflectance of incident light was noticeably enhanced.

For compositions of Example 12, applied to roadway signs, and then vigorously wiped to replicate a “seasons” weathering (none of the fluid remained visually apparent) sufficient residue of the fluid composition remained to permit easy removal of simulated spray can graffiti (enamel or lacquer) using only a low pressure stream of water.

For compositions of this example which contains hygroscopic glycerin, fluid dryout did not occur after 45 days of vertical exposure to direct (diurnal) summer sun.

FIG. 26 is a photograph of a 3M “SCOTCHLITE®” coated stop sign in colors of red and white. A portion of the area below the “O” of the word “STOP” was coated with the composition of Example 12. The thickness of this added coating was about 1 to 10 mil (0.025-0.25 mm). The coating remained at ambient conditions from 48 to 72 hours. The coated sign was then spray painted with a layer of commercial black lacquer which extended beyond the composition coated area, to simulate graffiti. The lacquer coating dried very quickly in a matter of minutes. The lacquer was further dried for about 24 hours at ambient conditions.

FIG. 27 is a photograph which shows the eliminating effect of contact with a low pressure water stream upon the lacquer (graffiti) coating. The area where the lacquer is removed is the area originally coated with the composition. The lacquer is completely removed from this area. The lacquer was not removed from the uncoated areas and remained tenaciously bonded to the surface.

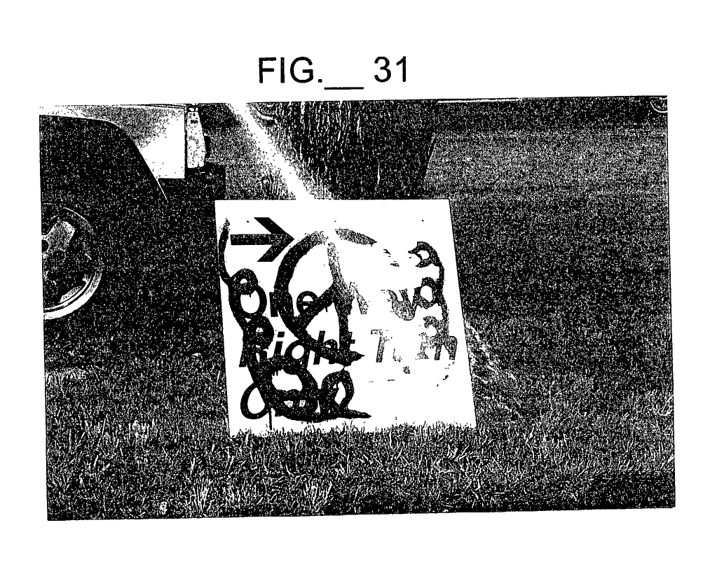

A similar experiment was performed on a new 3M “SCOTCHLITE®” surface. The results were essentially the same as with the aged surface. See FIG. 28.

### EXAMPLE 13

### Preparation of Glycerin and Isopropyl Aqueous Solutions with Higher Thickener Concentrations and with 1-Dodecanol for Long Durability Ice and Graffiti Protection

(a) This composition is used for imparting long term ice protection for power lines and components, railroad switches, road and highway signs and airport runway signs and lighting, and for other vertical surfaces where long duration protection is desired and it is believed to be achieved by the hygroscopic behavior of glycerin, which minimizes the dryout behavior typically observed for glycols.

A composition was prepared consisting of 35.0% by weight glycerin, 20.0% by weight isopropanol, 2.5% by weight xanthan, 0.1% by weight water soluble oil and the remainder is water. The composition further contained 0.45% 1-dodecanol by weight of the total composition. The thickness of the coating on the surface was in between about 1 to 10 mils (0.025-0.25 mm).

Similar to the behavior observed in Example 12 compositions, ice formation is inhibited from forming on surfaces by application of Example 13 to about −40° C.

In this example, the coated surfaces used for ice tests were warmed back to room temperature, vertically positioned on a roof for 60 days of outdoor ambient exposure, and then reevaluated for ice protection; ice formation was again inhibited from forming on the surface to about −40° C.

(b) Similar behavior to Example 12's performance on roadway sign material and especially the graffiti protection was observed, but this time achieved after over 60 days of direct (diurnal) summer sun.

(c) A portion of Example 13 fluid material was applied to a flat surface section of a gray concrete stepping stone block. The coating, in between about 5-10 mils (0.125-0.25 mm), was dried for a week. The surface coated and uncoated was then contacted (“tagged” with graffiti) with commercial black lacquer spray can paint. The surface area coated with the composition prevented permanent adhesion of the paint, whereas the paint on the uncoated surface penetrated and bonded into the porous block. After one day, garden hose pressure water washing easily removed the paint from the Example 13 protected portions, but was unable to remove paint elsewhere.

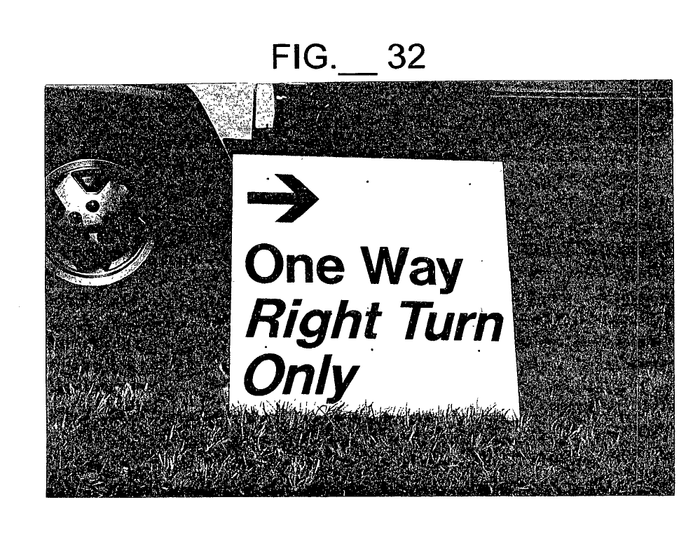

FIG. 29 is a photograph of a commercially painted road sign which was first completely coated with a layer (1 to 10 mils) of the composition of Example 13 and dried overnight (16 hours). The coating is essentially transparent to the eye. A common cellulosic sponge, used to wipe on the protective Example 13 coating, is shown atop the black lid of the coating fluid bottle.

FIG. 30 is a photograph of the coated sign of FIG. 29 which had been painted with commercial black spray can lacquer to simulate graffiti and dried for 24-48 hours.

FIG. 31 is a photograph of the coated sign of FIG. 30 wherein the coating is being washed with low pressure water (garden hose) and with removal of portions of the black lacquer shown.

FIG. 32 is a photograph of the coated sign of FIG. 31 wherein virtually all the black lacquer and the fluid coating has been removed within a few minutes using low pressure water. The sign has been restored to its original appearance. An easy reapplication of Example 13 can then provide renewed protection.

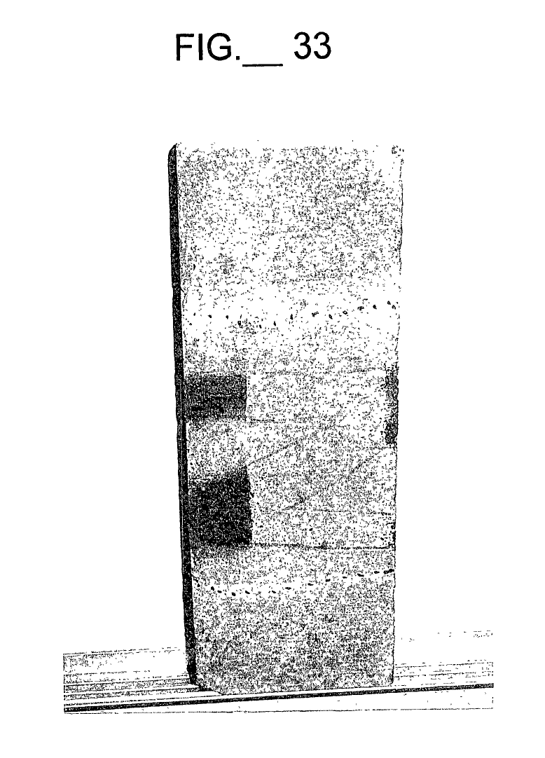

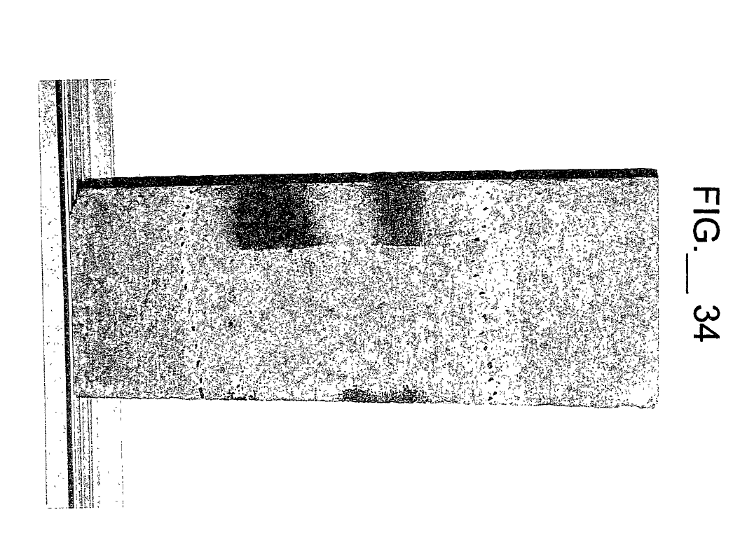

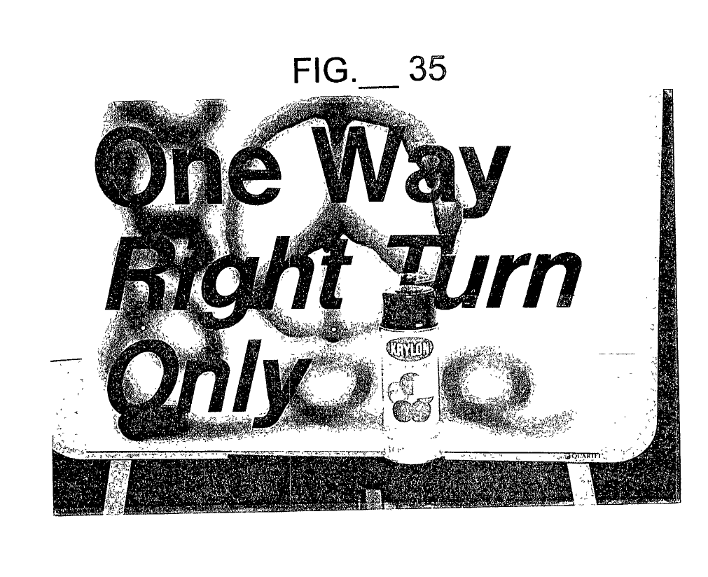

FIG. 33 is a photograph of a gray concrete stepping stone. First, a portion of the surface was contacted with the composition of Example 13, from about mid-vertical to near the right edge and allowed to dry. The coating is virtually transparent. The coated and uncoated portions were than sprayed with black spray can lacquer in the form of a capital “Z” (as shown by added outlines) and the paint dried. The surface was sprayed with low pressure water (garden hose) for a few minutes. The portion of the lacquer on the fluid composition protected area was essentially completely removed, the portion of the unprotected area having a layer of lacquer remains disfigured with the simulated graffiti. (See FIG. 34.)

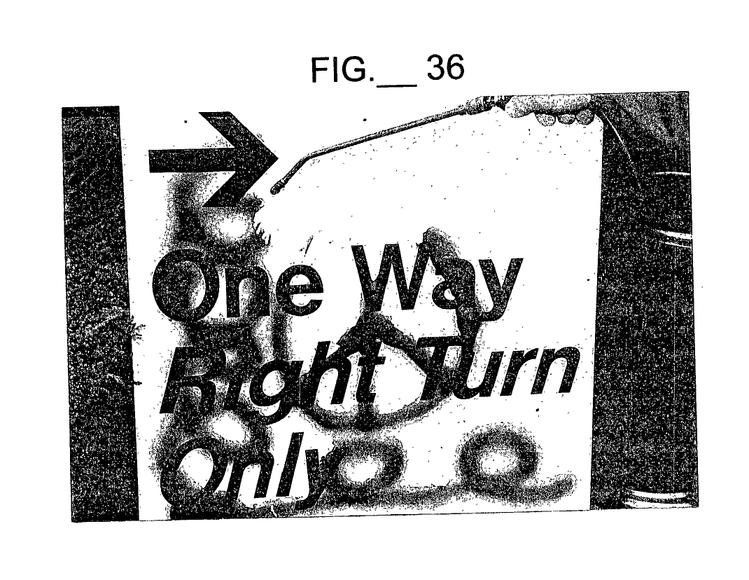

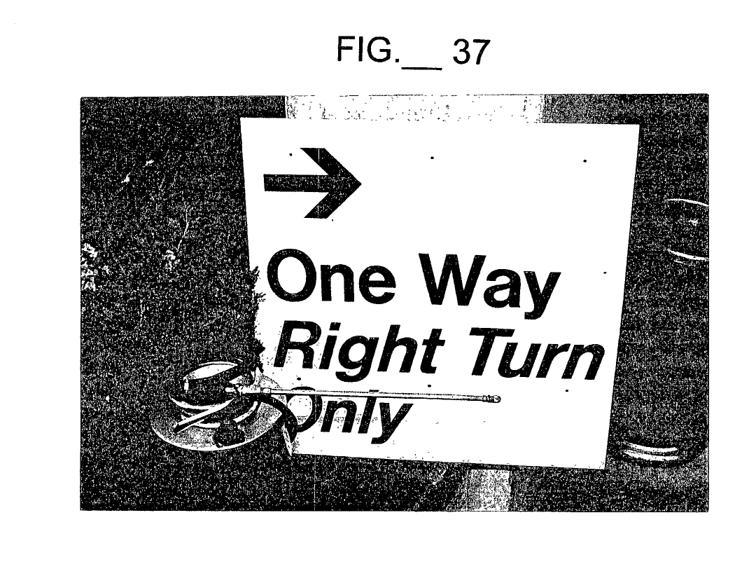

FIG. 35 is a photograph of the sign, previously used in FIG. 29 which was first coated with a layer of the composition of Example 13 (1-10 mils) (0.025-0.25 mm) and dried (at least 24 hours). Green commercial spray can enamel was then sprayed into the coated sign and dried (24-48 hours). Next, the coated surface was washed with low pressure water from a low pressure can (portable garden sprayer pump can). As can be seen in FIG. 36 the usually tenacious enamel was easily removed with a low pressure water stream.

FIG. 37 is a photograph of the resulting cleared, formerly coated, sign shown in FIG. 36, in the process of graffiti removal.

The profound benefit to crews who maintain road signs of the combined protection of anti-icing for safety reasons during the icing season, and anti-graffiti after and beyond the spring thaws is readily evident. Even for non-icing, more temperate regions, the benefit of an economical, environmentally friendly and long duration protection against the vandals' graffiti is of great merit.

For anti-icing and deicing fluid applications where reduction of surface friction would be deemed to be detrimental to safety, such as for aircraft, airport runway or taxiway, roadway, walkway and certain nautical usages, incorporation of glycerin into the composition, either singularly or in combination with other polyhydric or with monohydric freezing point depressants would be contra indicated. Thus, for these said applications, incorporation of glycerin is proscribed herein, and so annotated hereby to the following group of selected applicable claims, consisting of claim numbers: 27, 28, 29, 33, 34, 40, 41, 45, 51, and 52.

I claim:

1. An environmentally friendly anti-icing or deicing composition, said composition being essentially continuous, single-phase, non-Newtonian pseudoplastic, and said composition comprises:
(a) water in an amount in between about 30 and 86 percent by weight of the combined weight of water and freezing point depressant;
(b) at least one non-toxic, water soluble hydroxy-aliphatic freezing point depressant selected from a group consisting of monohydric alcohols having from 2 to 5 carbon atoms; polyhydric alcohols having from 3 to 12 carbon atoms, monomethyl or monomethyl ethers of polyhydric alcohols having from 3 to 12 carbon atoms, and mixtures thereof; wherein the amount of said freezing point depressant contained is in between about 14 and 70 percent by weight of said combined water and freezing point depressant weights; and
(c) a non-toxic hydrophilic exocellular heteropolysaccharide thickener, which is present in an amount in between 0.01 and 30 percent by weight of the total composition, and said thickener forms an aqueous colloid which when combined with components (a) and (b) provides a continuous liquid composition, wherein said liquid composition is a homogenous, single phase, and said liquid composition when formed has a high near-static initial viscosity above about 20,000 cPs when measured using a viscosity measuring devise, and the formed liquid after being subjected to at least one external dynamic strain at a rate of at least 20 sec⁻¹ for at least 1.0 minute, has a second, lower viscosity below about 1,000 cPs as measured using said measuring device under said specified conditions, and upon removal of said external dynamic strain rate, within 10 minutes, said liquid composition has a third viscosity value of within about 99.5% of said initial viscosity when said third viscosity is measured on said viscosity measuring device at said specified conditions, with the proviso that the composition does not include a water soluble liquid and with the proviso that the composition is not an emulsion.

2. The composition of claim 1, wherein said composition comprising the said polysaccharide thickener is a low electrolytic, essentially neutral pH, about 7, pseudoplastic fluid with the classical rheological behavior characteristic of so-called Ellis fluids; which posses finite rheological yield strengths that must be overcome prior to any shear induces fluid flow, but are not thixotropic.

3. The composition of claim 2 wherein:
in component (a) the water is present in between about 40 and 80 percent by weight of the combined weight of water and freezing point depressant weights;
in component (b) the freezing point depressant in between about 20 and 60 percent by weight of said combined water and freezing point depressant weights, and;
in component (c) the thickener is a xanthan which is present in an amount in between about 0.01 and 10.0 percent by weight of the composition, and the sum of components (a), (b), and (c) are at least about 90% by weight of the total composition.

4. The composition of claim 3, wherein the unshear-strained or near-static viscosity of said xanthan thickened fluid exceeds 20,000 cPs when measured at temperature ranges of in between about −30° C. and 0° C. and said viscosity rapidly decreases with moderate increase in shear rate to asymptotically approach a viscosity of below 600 cPs when a fluid sample of the composition is exposed to a dynamic shear at a rate in excess of 20 reciprocal seconds.

5. The composition of claim 3, wherein the total weight of said freezing point depressant is about 25-60% by weight of the combined weight of water and freezing point depressant weights.

6. The anti-icing or deicing composition of claim 2, wherein the fluid viscosity measurement is performed at between about −20° C. and +20° C.

7. The anti-icing or deicing composition of claim 6, wherein the fluid viscosity measurement is performed at −20° C. and at +20° C.

8. The composition of claim 3, wherein the amount of said freezing point depressant is about 55% by weight of the combined weight of water and freezing point depressant weights.

9. The composition of claim 3, wherein the xanthan thickener is a bacterium produced exocellular hydrophilic heteropolysaccharide colloid present in between 0.01% and 10% by weight of the total fluid composition.

10. The composition of claim 9, wherein the xanthan is selected from a group of bacterium progenated heteropolysaccharide hydrophilic colloids produced in-vitro by controlled aerobic fermentation using bacteria strains of a genus xanthomonas selected from the group consisting of Xanthomonas campestris, Xanthomonas incanae, Xanthomonas malracearum R2, and Xanthomanos begoniae S9

11. The composition of claim 2, wherein the said polysaccharide hydrophilic colloidal thickener is produced in-vitro by controlled aerobic fermentation using a bacterium progenator, selected from the group consisting of Welan from bacterium Alcaligenes, Rhamsan from bacterium Rhizobium melilote, Beijerinckia Indica from bacterium azolobacter indicus, and Gellan from bacterium Pseudomonas e iodea.

12. The anti-icing or deicing composition of claim 3, wherein said water soluble freezing point depressant is selected from the group consisting of aliphatic monohydric, dihydric glycolic, and polyhydric alcohols; selected from the group consisting of ethers and esters of said aliphatic monohydric, dihydric glycolic, and polyhydric alcohols; selected from the group consisting of aliphatic ketones; or selected from a group consisting of combinations of said freezing point depressants.

13. The composition of claim 12, wherein said freezing point depressant is an aliphatic alcohol is selected from the group consisting of a monohydric alcohol having from 2 to 5 carbon atoms; or a dihydric glycolic alcohol or polyhydric alcohol selected from the group consisting of alcohols having from 3 to 12 carbon atoms, or a monomethyl or monoethyl ether of the polyhydric alcohol is selected from the group consisting of alcohols having from 2 to 12 carbon atoms; or selected from a group consisting of combinations of said freezing point depressants.

14. The composition of claim 13, wherein said aliphatic monohydric alcohol is selected from the group consisting of ethanol, 1-propanol, 2-propanol, 1-butanol, 2-butanol, 2-methyl-1-propanol, and 2-methyl-2-propanol; wherein said aliphatic glycolic dihydric is selected from a group consisting of 1,2-propylene glycol, 1,3-propylene glycol, 1,4 butylene glycol, 1,3-butylene glycol, 2,3-butylene glycol; wherein said aliphatic polyhydric is glycerin, or wherein said alcoholic freezing point depressants are combinations of compounds selected from the said several groups.

15. The anti-icing or deicing composition of claim 3, said composition further includes a fluid-to-air hydrophobic boundary layer forming agent, in an amount in between 0.01% and 2.0% of the combined weight of water and freezing point depressant, said amount sufficient to retard or inhibit external water dilution.

16. The composition of claim 15, wherein said hydrophobic boundary layer forming agent is a monohydric primary aliphatic unbranched alcohol in an effective amount sufficient for forming a thin layer on an exterior surface of the composition applied to a structure to be ice protected, which alcohol is selected from a group consisting of primary aliphatic unbranched alcohols having between 8 to 24 carbon atoms, with the proviso that the composition does not include a water insoluble liquid and with the proviso that the composition is not an emulsion.

17. The anti-icing or deicing composition of claim 15, wherein said boundary layer forming agent is a liquid aliphatic wax ester in an effective amount sufficient for forming a thin hydrophobic layer on an exterior surface of the composition after application to an object to be ice protected, wherein the said wax ester comprises a C₁₆ to C₂₄ linear fatty saturated or unsaturated acid and C₁₈ to C₂₆ linear alcohol, having a total of about 40 to 44 carbon atoms, and is contained in the fluid composition in an amount in between about 0.01% and 1.0% weight of the weight of the total composition.

18. The composition of claim 16, wherein said alcohol is 1-dodecanol, present in an amount in between 0.01% and 2.0% of the combined weight of water and freezing point depressant.

19. The anti-icing and deicing composition of composition 18, wherein the xanthan thickener is present in an amount between 0.1% and 3.5% by weight of the combined weight of the total composition; and wherein the freezing point depressant is 1,2-propylene glycol, present in an amount between about 25% to 60% by weight of the combined weight of water and freezing point depressant weights.

20. The composition of claim 3, wherein the amount of the freezing point depressant is in between about 30% and 60% by weight of the combined weights of water and freezing point depressant.

21. The composition of claim 3, wherein said freezing point depressant is selected from the group consisting of propylene glycols, n-propanol, isopropanol, and glycerin; and combinations of the members comprising said group.

22. The composition of claim 3, wherein said freezing point depressant is a mixture of 1,2-propylene glycol, present in between about 5% and 15% by weight, and isopropanol, present in between about 9% and 45% by weight, of the combined weights of the water and freezing point depressants.

23. The composition of claim 22, wherein the amount of said thickener is in between 0.1% and 5.0% by weight of the total composition.

24. A method for anti-icing or deicing an exterior surface of an aircraft, wherein the anti-icing and deicing composition of claim 3 is applied to an exterior surface of an aircraft wherein:
in component (a) the water is present in an amount in between about 40% and 80% by weight of the combined weight of water and freezing point depressant weights;
in component (b) the freezing point depressant is present in an amount in between about 20% and 60-% by weight of said combined water and freezing point depressant weights;
in component (c) the thickener is present in an amount in between about 0.01% and 5.0% by weight of the total composition, and the sum of the amounts of components (a), (b) and (c) are at least about 90% by weight of the total composition; and
optionally, the composition further includes 1-dodecanol, present in an amount in between 0.01% and 2.0% of the combined weight of water and freezing point depressant.

25. A method for the deicing of an aircraft, wherein said process comprises:
contacting an exterior surface of an aircraft in need of deicing with an effective amount of the composition set forth in claim 24 to deice and anti-ice said aircraft surface.

26. An anti-icing or deicing composition of claim 3 comprising water, 2-propanol, xanthan, propylene glycol, and the composition further includes 1-dodecanol, present in an amount in between 0.01% and 2.0% of the combined weight of water and freezing point depressants.

27. A method for the anti-icing or deicing of an exterior surface of a motor vehicle, wherein the anti-icing and deicing composition of claim 3 is applied to an exterior surface of a motor vehicle, wherein:
in component (a) the water is present in an amount in between about 40% and 80% by weight of the combined weight of water and freezing point depressant weights;
in component (b) the freezing point depressant is a mixture of 1,2-propylene glycol, present in an amount between about 5% and 30% by weight, and isopropanol, present in an amount in between 9% and 45% by weight of the combined weight of the water and freeing point depressants weights;
in component (c) the thickener is present in an amount in between about 0.05% and 2.5% by weight of the total composition weight, and the sum of components (a), (b) and (c) are at least about 90% by weight of the total composition; and
optionally, the composition further includes 1-dodecanol, present in an amount in between 0.01% and 2.0% by weight of the said combined weight of water and freezing point depressant.

28. A method for the anti-icing or deicing of an exterior surface of a motor vehicle, said method comprises:
contacting an exterior surface of a motor vehicle with an effective amount of the composition of claim 27 to anti-ice or deice the surface.

29. A method for the anti-icing or deicing of glass window surfaces, such as those of fixed structures, nautical vessels, automotive windshields, and other automobile glazings wherein said method comprises contacting the exterior surface in need of ice protection with an effective amount of the composition of claim 27 to deice and anti-ice said glass surface.

30. The composition of claim 27, further comprising a non-toxic, non-water soluble hard, small particles, said particles having a major axis dimension less than about 2.5 mm, and present in the applied fluid composition is quantities sufficient to function effectively as a surface friction enhancer, typically in an amount less that 5.0% of the fluid weight; and to minimize surface traffic slippage due to icing, when applied to the surfaces of street, roads, bridges, sidewalks, walkways, steps, and entrances, as an ice protection.

31. The composition of claim 30, wherein said small particles are comprised of organic and/or inorganic particlulate matter or grit.

32. The composition of claim 31, comprising ground or pulverized nut shells, husks, kernels, seeds, bark, wood fragments, sand, crushed gravel, ash, synthetic polymers, or cat litter.

33. A method for anti-icing or deicing the surface of a street, road, bridge, sidewalk, steps, or entrance surface, which method comprises:
contacting said surface with an effective amount of the composition of claim 3 to anti-ice or deice the surface, wherein:
in component (a) the water is present in between about 40% and 80% by weight of the combined weight of water and freezing point depressant weights;
in component (b) the freezing point depressant is a mixture of 1,2-propylene glycol, present in an amount in between about 5% and 30% by weight, and isopropanol, present in an amount in between 9% and 45% by weight of the combined weight of water and freezing points depressants weights;
in component (c) the thickener is present in between about 0.05 and 2.5% by weight of the total composition weight, and the sum of components (a), (b) and (c) are at least about 90% by weight of the total composition; and
optionally, the composition further includes 1-dodecanol, present in an amount in between 0.01% and 2.0% of the combined weight of water and freezing point depressant.

34. A method for the anti-icing or deicing the surface of a street, road, bridge, sidewalk, walkway, steps, or entrance, said process comprises:
contacting said surface in need of anti-icing or deicing with an effective amount of the composition of claim 33 to anti-ice or deice said surface wherein said composition further includes an effective amount of pulverized solid particles to increase friction or the surface.

35. A method of anti-icing or deicing a nautical vessel or nautical equipment wherein the composition of claim 3 is applied to an exterior air exposed surface of a nautical vessel or to exterior nautical equipment to anti-ice or deice an exterior surface, wherein:
in component (a) the water is present in between about 40% and 80% by weight of the combined weight of water and freezing point depressant weights;
in component (b) the freezing point depressant is 1,2-propylene glycol and is present in an amount in between 20% and 60% by weight of said combined water and freezing point depressant weights;
in component (c), the xanthan thickener is present in as amount in between about 0.10% and 8.0% by weight of the total composition weight, and the sum of components (a). (b) and (c) are at least about 90% by weight of the total composition; and
optionally, the composition further includes 1-dodecanol, present in an amount in between about 0.01% and 2.0% by weight of the said combined weight of water and freezing point depressant.

36. The method of claim 35 for anti-icing or deicing a nautical vessel or nautical equipment wherein;
in component (b) the freezing point depressant is a mixture comprising 1,2-propylene glycol in an amount in between bout 9.0% and 11.0% by weight; and isopropanol in an amount in between about 44.0% and 46.0% by weight of said combined water and freezing point depressant weights.

37. A method for the anti-icing or deicing of a nautical vessel or nautical equipment, wherein said process comprises:
contacting an exterior air exposed surface of a nautical vessel or nautical equipment with an effective amount of the composition of claim 35 to anti-ice or deice said surface; and
optionally, contacting said air exposed surface of said nautical vessel or nautical equipment with an effective amount of the composition of claim 36 to anti-ice or deice said surface.

38. The anti-icing or deicing composition of claim 10 wherein:
in component (b) the freezing point depressant is 1,2-propylene glycol and present in an amount in between about 30% and 60% by weight of the combined weights of water and freezing point depressant; and
wherein, the composition further includes 1-dodecanol as a monohydric primary aliphatic unbranched alcohol present in an amount in between about 0.01% and 2.0% of the combined weights of water and freezing point depressant, said amount sufficient to form a thin hydrophobic layer on the external surface of the composition applied to a structure to be given ice protection; and also sufficient in quantity to serve as a means of forming a creamy homogenized fine consistency durable foam with the xanthan thickener; with the proviso that the composition does not include isopropyl alcohol.

39. A method of applying an anti-icing or deicing composition to a surface wherein the anti-icing or deicing fluid composition of claim 10 is foamed by conventional mechanical agitation with aeration, and immediately applied to the surface to be ice protected, wherein:
in component (b) the freezing point depressant is 1,2-propylene glycol and is present in an amount in between about 30% and 60% by weight of the combined weights of water and freezing point depressant; and
wherein, the composition further includes 1-dodecanol, present in an amount in between about 0.01% and 2.0% of the combined weights of water and freezing point depressant, said amount sufficient to form a thin hydrophobic layer on the external surface of the composition applied to a structure to be given ice protection; and also sufficient in quantity to serve as a means of forming a creamy homogenized fine consistency durable foam with the xanthan thickener; with the proviso that the composition does not include isopropyl alcohol.

40. An anti-icing or deicing composition of claim 18 wherein the composition is to be applied to aircraft surfaces, to the external exposed surfaces of nautical vessels and nautical equipment, and wherein the freezing point depressant in 1,2-propylene glycol, present in an amount in between 20% and 60% of the combined weight of water and freezing point depressant, said composition having a near-static viscosity at a shear rate of about 0.1 sec⁻¹ of 20,000 to 75,000 cPs and a shear thinned viscosity at a shear rate greater than 20 sec⁻¹, below 1000 cPs, at a temperature of between about 0° C. and −20° C.

41. The anti-icing or deicing composition of claim 40 having a near-static viscosity of between about 20,000 to 120,000 cPs at a temperature between about 0° C. and −20° C.

42. The anti-icing or deicing composition of claim 14, wherein:
the xanthan thickener is present in an amount in between about 0.1% and 5.0% by weight of the combined weight of the total composition; and
wherein the freezing point depressant is a mixture of glycerin, present in an amount in between about 20% and 50% by weight; and
isopropanol, present in an amount in between about 5% and 35% by weight of the combined weights of water and freezing point depressants, and the water, the freezing point depressants, and the thickener components are at least 90% by weight of the total composition; and
optionally the composition further includes 1-dodecanol, present in an amount in between about 0.01% and 2.0% of the combined weights of water and the freezing point depressants.

43. A method for anti-icing or deicing external surfaces of electrical power transmission lines and components, conventional double-rail railroad tracks, third rail components, mono-rail tracks, and railroad track switches whereupon added lubricity compliments the herein provided long duration icing protection; road and highway signs and other vertical surfaces in need of icing protection wherein said method comprises:
contacting the said surface with an effective amount of the composition of claim 42, to anti-ice or deice said surface.

44. The anti-icing or deicing composition of claim 3, wherein:
the thickener is a xanthan, present in an amount in between about 2.0% and 3.0% by weight of the combined weight of the fluid composition wherein;
the freezing point depressant is an equal mixture of glycerin, present in an amount between about 27% and 28% by weight; and
isopropanol, also present in an amount in between about 27% and 28% by weight of the combined weight of water and freezing point depressant; and
the remaining amount of the aqueous freezing point depressant fluid is water, and the sum of the weights of thickener, freezing point depressants, and water components are at least about 90% by weight of the total composition; and
optionally, the composition further includes 1-dodecanol, present in an amount in between 0.01% and 3.0% by weight of the said combined weight of water and freezing point depressants.

45. A method of providing anti-icing or deicing for external surfaces of road and highway signs and other external vertical surfaces where long duration ice protection and subsequent graffiti protection is required; wherein said method comprises:
contacting the said surface with an effective amount of the composition of claim 42, to anti-ice or deice, and additionally, to provide graffiti protection to said surface; and
recontacting said protected surface upon which graffiti had been subsequently applied and then removed with low pressure water stream, to reestablish the said graffiti protection provided by the initial contact of the surface with said claim 42 composition.

46. The anti-icing or deicing composition of claim 3, wherein:
the thickener is a xanthan, present in an amount in between about 1.5% and 3.0% by weight of the combined weights of freezing point depressant and water weights; and
the freezing point depressant is a mixture of glycerin, present in an amount in between about 30.0% and 40.0% by weight; and
isopropanol, present in an amount in between about 15.0% and 25% by weight of the combined weights of freezing point depressant and water; and
further, the composition contains a water soluble oil present in an amount about 0.1% by weight of the entire composition weight; and
in addition, the composition includes 1-dodecanol, present in an amount in between 0.10% and 3.0% by weight of the said combined weight of water and freezing point depressants; and
the remaining amount of the aqueous freezing point depressant fluid is water, and the sum of the weights of thickener, freezing point depressants, and water components are at least 90% by weight of the total composition.

47. A method for providing anti-icing or deicing protection for (a) the external surfaces of suspended stretched cables, wires, or electrical power transmission lines and their components, microwave towers and their components, railroad rails and switches; where the need exists for long duration ice protection, tenacity of the protective fluids to the surface, resistance of the fluid composition to wind force displacement and to dilution by mist, drizzle or rain, and for ease of application; and for providing desired graffiti protection, in addition to anti-icing and deicing protection for (b) the external surfaces of road and highway signs, and other external vertical surfaces; wherein said method comprises:
contacting the said surfaces in (a) with an effective amount of the composition of claim 46 to anti-ice or deice said surfaces;
or alternately contacting the said surfaces in (b) with an effective amount of composition of claim 46 to anti-ice or deice, and additionally, to provide graffiti protection to said surfaces.

48. A method as set forth in claim 47, wherein the composition of claim 46, is contacted onto the said external surfaces of (b) of claim 47, solely to provide graffiti protection, where concerns for ice protection is not a consideration.

49. The method of providing visually transparent fluid anti-graffiti protective films for external surfaces such as painted or unpainted concrete or brick walls; support structures for roadway and bridge components; painted steel components of buildings and bridges; and exterior surfaces of railroad cars and their equipment; where the need exists for long duration economical graffiti protection; wherein, said method comprises:
contacting the said surfaces with an effective amount of the composition of claim 42 to provide anti-graffiti protection; and
recontacting said protected surfaces upon which graffiti had been subsequently applied and then removed with low pressure water stream, to reestablish the said graffiti protection provided by the initial contact of the surface with said claim 42 composition.

50. A method of providing long duration anti-icing or deicing protection and anti-graffiti protection for the external surfaces of road and highway signs, and other vertical surfaces; wherein said method comprises:
applying the composition of claim 42 onto said surfaces by conventional application techniques including painting by brush, roller; foaming, wiping on, air pressure spraying, electrostatic spraying, and aerosol spraying.

51. A method to selectively blend, in-situ, an aircraft type specific version of the composition of the anti-icing or deicing fluid of the composition of claim 19; which, as with all the fluid compositions claimed in the instant invention is a pseudoplastic non-Newtonian fluid having those rheological behaviors characteristic of Ellis fluids, which possess finite rheological yield strengths that must be overcome prior to any shear stress induced fluid flow, and, noting that in general the heavier transport aircraft types have higher airspeeds of rotation and to takeoff than do the lighter commuter type aircraft, whose rheological properties are hereby specifically tailored to meet the specific aircraft-type's unique viscosity-airspeed shear thinning specification requirements that the applied high static viscosity fluid composition is sufficiently shear thinned by aerodynamic stress so as to be shed from the surfaces given the ice protection as the aircraft's takeoff acceleration increases its speed to where it reaches its rotational speed, with the concomitant higher aerodynamic shear stress, wherein the over all affects of the xanthan concentration on the viscosity of said fluid far exceeds the viscosity contribution of any other component, the determination of compositional viscosity to assure the proper shear thinning reduces to finding the proper xanthan concentration in the anti-icing and deicing fluid composition which method comprises:
(a) selecting the aircraft type whose surfaces are to be given icing protection, and obtaining the given aircraft published rotational and takeoff airspeeds for the given aircraft's loading;
(b) utilizing the rotational and takeoff airspeed data for the selected aircraft, and the ambient temperature, determine the drag per unit area, D/S referred to herein as drag effect, from the following equation:
D/S=½ ρC_{D} U²
wherein:
D is the aerodynamic drag for unit area S,
D/S is the so-called drag effect,
ρ is the density altitude of the ambient air,
C_{D} is the aerodynamic coefficient of drag of the surface, and
U is the air flow velocity over the surface
(c) correlating the yield stress τₒ, which must be equal to the Ellis fluid yield strength in order for fluid flow to commence, to the drag effect D/S, using the equation:
τₒ=D/S
(d) correlate this yield stress τₒ, obtained from step (c) to yield stress equivalent airspeed, where the following equation is used to simplify the calculations:
q=½ ρU²
where:
q is the dynamic air pressure,
ρ is the air mass density and is equal to 0.002378 lbs sec²/ft⁴, from standard published aerodynamic tables,
D is the induced drag and is equal to 0.5 ρ U² C_{D} S=q C_{D}S,
Wherein:
S is the surface area,
U is the free stream air velocity,
ρ is the ρ cited above,
C_{D} is the aerodynamic coefficient of drag,
Q is the air mass density cited above,
And assuming for an educating example that, for calculations for an aircraft applications whose rotation speed is approximately 100 knots, that:
(1) Rₑ is the Reynolds number, obtained from published tables, is equal to 0.5×10⁵ for 100 knots,
(2) C_{D} is the surface flat plate tangential coefficient of drag, which value is between 0.01 and 0.007, as reported in published aerodynamic tables,
(3) τₒ is the yield stress which is to be correlated to the airspeed, and obtained from step (b),
and performing the simple math utilizing the equation and noting that the induced drag D at airspeed velocity U must equal the yield stress τₒ in order for fluid shear thinning to occur, the correlation of yield stress to airspeed is thus readily calculated, with the proviso that the calculation use values used for C_{D} at both extremes of 0.01 and 0.007 and the calculated airspeeds are judiciously confirmed by test flights,
(e) having also thus obtained from step (c) the τₒ value of yield stress, determine the near static viscosity ηₒ from data preferably obtained for samples of composition of the fluid of intended use, or as a reasonable approximation, using the data obtained from rheological measurements of a fluid sample of claim 19, wherein the said composition comprised 55.0 wt % 1,2-propylene glycol, 0.5 wt % xanthan, and 44.5 wt % water, and from said 20° C. data a plot of the square root of the apparent viscosity against the reciprocal of the square root of the shear rate gives a slope of 71.8, the square of which provides a τₒ value for the fluid of 51.6 dynes/cm², using the equation:
ηₒ^{½}=η_{∞}^{½}+τₒ\dot{γ}^{-½}
wherein:
\dot{γ} is the shear rate, dγ/dt, in reciprocal seconds,
η is any viscosity, cPs, in centiPoise seconds,
ηₒ is the near static viscosity, at essentially zero shear rate or 0.0102 sec⁻¹,
η_{∞}is the limiting or infinite shear rate viscosity, and
τₒis the yield stress, in dynes/cm²,
noting that η_{∞}, the limiting viscosity at infinite shear rate, is a very low value of about 200 to 300 cPs as compared to the 50,000 cPs or higher values for ηₒ, the near static viscosity, and thus equating the η_{∞}^{½} term to zero and omitting it from the equation, and still maintaining acceptable accuracy;
(f) squaring the resulting equation, wherein the term η_{∞}^{1/2} is omitted; from step (d) to obtain:
ηₒ=τₒ\dot{γ}⁻¹,
as a reasonable approximation, wherein the applied rate of used to measure the near static low shear rate viscosity is approximately 0.106 sec⁻¹, a constant which allows the direct determination of ηₒ that correlates to τₒ;
(g) using data of viscosity versus thickener concentration, at the appropriate temperatures 20° C., 0° C., and −40° C., obtained preferably for the fluid of intended use to generate a useful plot, determine the concentration, wt %, of the thickener xanthan in solution needed to provide the viscosity, ηₒ, required for the intended fluid applications: or as a reasonable approximation, using the data obtained from rheological measurements of a series of fluid samples of claim 19, wherein said compositions comprise a group consisting of 0.25 wt %, 0.375 wt % and 0.50 wt % xanthan thickened fluids, each further containing 55.0 wt %1,2-propylene glycol and 44.5 wt % water, and from said 20° C. data a plot of near static viscosity, ηₒ, with thickener concentration, gives a slope of 26.04×10⁴ which, by using the equation:
y=mx+b,
wherein:
m is the slope, of the viscosity versus thickener concentration curve
y and b are near static viscosities at two different thickener concentrations and,
x is the difference in thickener concentration along the plot's abscissa;
(h) repeating the data acquisition of step (f) at 0° C. and −40° C., interpolate the results to approximate the ambient temperature of intended fluid application, and adjusting for temperature corrections by using the said data;
(i) obtaining the anti-icing fluid composition tailored to meet the specific aircraft application; and
(j) preparing the liquid anti-icing fluid having the composition obtained in step (h), by blending in-situ through controllably variable proportioning mixing valves, conjoined or upstream of the pressure nozzle, fluids whose combination herein results in the proper final fluid composition.

52. A method of providing aircraft the anti-icing fluid of the composition of claim 19, specifically tailored to match the rotational and takeoff airspeeds of the individual aircraft version, at its immediate gross weight, with the rheological properties of fluid composition, produced by the method of claim 51;
wherein said method comprises:
applying said composition onto the surfaces to be anti-iced of said aircraft using the system of variable proportioning valve and nozzle as set forth in said claim 51.
